(19) United States
(12) Patent Application Publication
(10) Pub. No.: US 2025/0378653 A1
(43) Pub. Date: Dec. 11, 2025

(54) CONFIGURING SPATIAL TEMPLATES IN MULTI-USER COMMUNICATION SESSIONS

(71) Applicant: Apple Inc., Cupertino, CA (US)

(72) Inventors: Kevin LEE, San Jose, CA (US); Connor A. SMITH, San Jose, CA (US); Willem MATTELAER, San Jose, CA (US); Ethan N. KUSTERS, San Jose, CA (US); Anish KANNAN, Sunnyvale, CA (US); Joseph P. CERRA, San Francisco, CA (US)

(21) Appl. No.: 19/201,345

(22) Filed: May 7, 2025

Related U.S. Application Data
(60) Provisional application No. 63/656,887, filed on Jun. 6, 2024.
(60) Provisional application No. 63/671,484, filed on Jul. 15, 2024.
(60) Provisional application No. 63/800,272, filed on May 5, 2025.

(51) Int. Cl. G06T 19/00; H04L 67/104

(52) U.S. Cl. CPC G06T 19/006; H04L 67/1044

(57) ABSTRACT

Some examples of the disclosure are directed to systems and methods for facilitating display, based on data provided by a respective application associated with content, of the content and avatars corresponding to respective users according to a respective spatial arrangement within a multi-user communication session. Some examples of the disclosure are directed to systems and methods for displaying content and avatars according to a respective spatial arrangement in a three-dimensional environment within a multi-user communication session. Some examples of the disclosure are directed to systems and methods for facilitating display, based on data provided by a respective application associated with content, of the content and avatars corresponding to remote users according to a respective spatial arrangement that is adapted to physical locations of local users within a hybrid multi-user communication session.

### CROSS-REFERENCE TO RELATED APPLICATIONS

This application claims the benefit of U.S. Provisional Application No. 63/800,272, filed May 5, 2025, U.S. Provisional Application No. 63/671,484, filed Jul. 15, 2024, and U.S. Provisional Application No. 63/656,887, filed Jun. 6, 2024, the contents of which are herein incorporated by reference in their entireties for all purposes.

### FIELD OF THE DISCLOSURE

This relates generally to systems and methods of managing and/or configuring spatial templates according to which participants are arranged within multi-user communication sessions.

### BACKGROUND OF THE DISCLOSURE

Some computer graphical environments provide two-dimensional and/or three-dimensional environments where at least some objects displayed for a user's viewing are virtual and generated by a computer. In some examples, the three-dimensional environments are presented by multiple devices communicating in a multi-user communication session. In some examples, an avatar (e.g., a representation) of each user participating in the multi-user communication session (e.g., via the computing devices) is displayed in the three-dimensional environment of the multi-user communication session. In some examples, content can be shared in the three-dimensional environment for viewing and interaction by multiple users participating in the multi-user communication session.

### SUMMARY OF THE DISCLOSURE

Some examples of the disclosure are directed to systems and methods for facilitating display of content and avatars according to a respective spatial arrangement within a multi-user communication session. In some examples, a method is performed at a first electronic device in communication with one or more displays and one or more input devices. In some examples, the first electronic device detects an indication of a request to engage in a shared activity with a second electronic device, different from the first electronic device. In some examples, in response to detecting the indication, the first electronic device enters the communication session with the second electronic device, including operating a communication session framework (or communication session application or communication session application programming interface) that is configured to receive, from a respective application associated with the shared activity, application data. In some examples, the application data includes first data indicating a location at which a first object corresponding to the shared activity is to be displayed in a respective three-dimensional environment, second data indicating a plurality of placement locations relative to the first object in the respective three-dimensional environment, and third data indicating one or more orientations associated with the plurality of placement locations relative to the first object in the respective three-dimensional environment. In some examples, the communication session application is further configured to output, based on the application data, display data indicating a first spatial arrangement according to which at least a viewpoint of the first electronic device, a representation of a user of the second electronic device, and the first object are presented in a three-dimensional environment of the first electronic device.

Some examples of the disclosure are directed to systems and methods for displaying content and avatars according to a respective spatial arrangement within a multi-user communication session. In some examples, a method is performed at a first electronic device in communication with one or more displays and one or more input devices. In some examples, while in a communication session with the second electronic device, the first electronic device presents, via the one or more displays, a representation of a user of the second electronic device in a three-dimensional environment. In some examples, while presenting the representation of the user of the second electronic device in the three-dimensional environment, the first electronic device detects an indication of a request to present shared content in the three-dimensional environment. In some examples, in response to detecting the indication, the first electronic device presents, via the one or more displays, a first object corresponding to the shared content in the three-dimensional environment, wherein a viewpoint of the first electronic device, the representation of the user of the second electronic device, and the first object have a first spatial arrangement in the three-dimensional environment based on data provided by a respective framework associated with the communication session. In some examples, the data indicates a location of the first object relative to a respective three-dimensional environment, a location of the representation of the user of the second electronic device relative to the location of the first object in the respective three-dimensional environment, and an orientation of the representation of the user of the second electronic device relative to the location of the first object in the respective three-dimensional environment.

Some examples of the disclosure are directed to systems and methods for facilitating display of content and avatars according to a respective spatial arrangement within a multi-user communication session that includes collocated users and based on the physical locations of the collocated users relative to the respective spatial arrangement. In some examples, a method is performed at a first electronic device in communication with one or more displays and one or more input devices, wherein the first electronic device is collocated with a second electronic device in a physical environment. In some examples, the first electronic device detects an indication of a request to engage in a shared activity with the second electronic device and a third electronic device, different from the first electronic device and the second electronic device, wherein the third electronic device is non-collocated with the first electronic device and the second electronic device in the physical environment. In some examples, in response to detecting the indication, the first electronic device enters a communication session with the second electronic device and the third electronic device, including operating a communication session framework that is configured to: receive, from a respective application associated with the shared activity, application data that includes first data indicating a first object corresponding to the shared activity that is to be displayed in a respective three-dimensional environment, and second data indicating a plurality of placement locations relative to the first object in the respective three-dimensional environment; and output, based on the application data, display data indicating a first spatial arrangement according to which a representation of a user of the third electronic device and the first object are to be presented in a three-dimensional environment of the first electronic device relative to a viewpoint of the first electronic device and a respective location of the second electronic device.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an exemplary architecture for a system according to some examples of the disclosure.

FIG. 3 illustrates an example of a multi-user communication session that includes a first electronic device and a second electronic device according to some examples of the disclosure.

FIGS. 4A-4F illustrate the use of Application Programming Interfaces (APIs) to perform operations according to some examples of the disclosure.

FIG. 4G illustrates a block diagram of an exemplary architecture for a communication session application configured to facilitate a multi-user communication session according to some examples of the disclosure.

FIGS. 5A-5I illustrate example interactions within a multi-user communication session according to some examples of the disclosure.

FIG. 6 illustrates a flow diagram illustrating an example process for facilitating a multi-user communication session in response to detecting a request to share content in the multi-user communication session based on data received from a respective application associated with the content according to some examples of the disclosure.

FIG. 7 illustrates a flow diagram illustrating an example process for displaying virtual content in a respective spatial arrangement within a multi-user communication session based on data received from a respective application associated with the content according to some examples of the disclosure.

FIGS. 8A-8D illustrate examples of custom spatial templates within a multi-user communication session according to some examples of the disclosure.

FIGS. 9A-9S illustrate examples of custom spatial templates within hybrid multi-user communication sessions according to some examples of the disclosure.

FIG. 10 illustrates a flow diagram illustrating an example process for displaying virtual content in a respective spatial arrangement within a hybrid multi-user communication session based on data received from a respective application associated with the content according to some examples of the disclosure.

### DETAILED DESCRIPTION

Some examples of the disclosure are directed to systems and methods for facilitating display of content and avatars according to a respective spatial arrangement within a multi-user communication session. In some examples, a method is performed at a first electronic device in communication with one or more displays and one or more input devices. In some examples, the first electronic device detects an indication of a request to engage in a shared activity with a second electronic device, different from the first electronic device. In some examples, in response to detecting the indication, the first electronic device enters the communication session with the second electronic device, including operating a communication session framework that is configured to receive, from a respective application associated with the shared activity, application data. In some examples, the application data includes first data indicating a first object corresponding to the shared activity that is to be displayed in a respective three-dimensional environment, second data indicating a plurality of placement locations relative to the first object in the respective three-dimensional environment, and third data indicating one or more orientations associated with the plurality of placement locations relative to the first object in the respective three-dimensional environment. In some examples, the communication session application is further configured to output, based on the application data, display data indicating a first spatial arrangement according to which at least a viewpoint of the first electronic device, a representation of a user of the second electronic device, and the first object are presented in a three-dimensional environment of the first electronic device.

Some examples of the disclosure are directed to systems and methods for displaying content and avatars according to a respective spatial arrangement within a multi-user communication session. In some examples, a method is performed at a first electronic device in communication with one or more displays and one or more input devices. In some examples, while in a communication session with the second electronic device, the first electronic device presents, via the one or more displays, a representation of a user of the second electronic device in a three-dimensional environment. In some examples, while presenting the representation of the user of the second electronic device in the three-dimensional environment, the first electronic device detects an indication of a request to present shared content in the three-dimensional environment. In some examples, in response to detecting the indication, the first electronic device presents, via the one or more displays, a first object corresponding to the shared content in the three-dimensional environment, wherein a viewpoint of the first electronic device, the representation of the user of the second electronic device, and the first object have a first spatial arrangement in the three-dimensional environment based on data provided by a respective framework associated with the communication session. In some examples, the data indicates a location of the first object relative to a respective three-dimensional environment, a location of the representation of the user of the second electronic device relative to the location of the first object in the respective three-dimensional environment, and an orientation of the representation of the user of the second electronic device relative to the location of the first object in the respective three-dimensional environment.

Some examples of the disclosure are directed to systems and methods for facilitating display of content and avatars according to a respective spatial arrangement within a multi-user communication session that includes collocated users and based on the physical locations of the collocated users relative to the respective spatial arrangement. In some examples, a method is performed at a first electronic device in communication with one or more displays and one or more input devices, wherein the first electronic device is collocated with a second electronic device in a physical environment. In some examples, the first electronic device detects an indication of a request to engage in a shared activity with the second electronic device and a third electronic device, different from the first electronic device and the second electronic device, wherein the third electronic device is non-collocated with the first electronic device and the second electronic device in the physical environment. In some examples, in response to detecting the indication, the first electronic device enters a communication session with the second electronic device and the third electronic device, including operating a communication session framework that is configured to: receive, from a respective application associated with the shared activity, application data that includes first data indicating a first object corresponding to the shared activity that is to be displayed in a respective three-dimensional environment, and second data indicating a plurality of placement locations relative to the first object in the respective three-dimensional environment; and output, based on the application data, display data indicating a first spatial arrangement according to which a representation of a user of the third electronic device and the first object are to be presented in a three-dimensional environment of the first electronic device relative to a viewpoint of the first electronic device and a respective location of the second electronic device.

In some examples, a spatial group or state in the multi-user communication session denotes a spatial arrangement or template that dictates locations of users and content that are located in the spatial group. In some examples, users in the same spatial group within the multi-user communication session experience spatial truth according to the spatial arrangement of the spatial group. In some examples, when the user of the first electronic device is in a first spatial group and the user of the second electronic device is in a second spatial group in the multi-user communication session, the users experience spatial truth that is localized to their respective spatial groups. In some examples, while the user of the first electronic device and the user of the second electronic device are grouped into separate spatial groups or states within the multi-user communication session, if the first electronic device and the second electronic device return to the same operating state, the user of the first electronic device and the user of the second electronic device are regrouped into the same spatial group within the multi-user communication session.

As used herein, a hybrid spatial group corresponds to a group or number of participants (e.g., users) in a multi-user communication session (e.g., a hybrid multi-user communication session) in which at least a subset of the participants is non-collocated in a physical environment. For example, as described via one or more examples in this disclosure, a hybrid spatial group (e.g., within a hybrid multi-user communication session) includes at least two participants who are collocated in a first physical environment and at least one participant who is non-collocated with the at least two participants in the first physical environment (e.g., the at least one participant is located in a second physical environment, different from the first physical environment). In some examples, a hybrid spatial group in the multi-user communication session has a spatial arrangement that dictates locations of users and content that are located in the spatial group. In some examples, users in the same hybrid spatial group within the multi-user communication session experience spatial truth according to the spatial arrangement of the spatial group, as similarly discussed above.

In some examples, initiating a multi-user communication session may include interaction with one or more user interface elements. In some examples, a user's gaze may be tracked by an electronic device as an input for targeting a selectable option/affordance within a respective user interface element that is displayed in the three-dimensional environment. For example, gaze can be used to identify one or more options/affordances targeted for selection using another selection input. In some examples, a respective option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

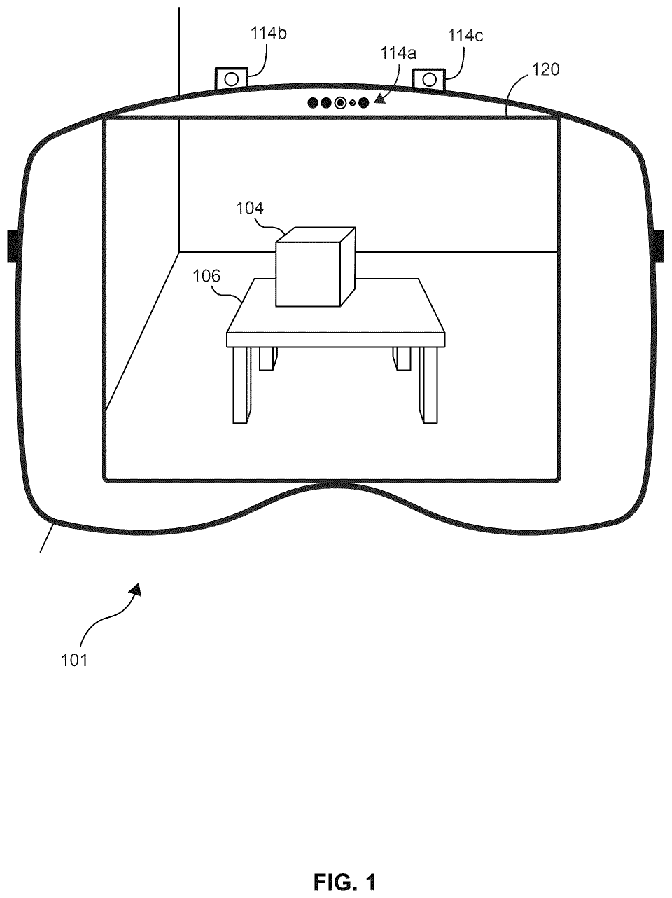

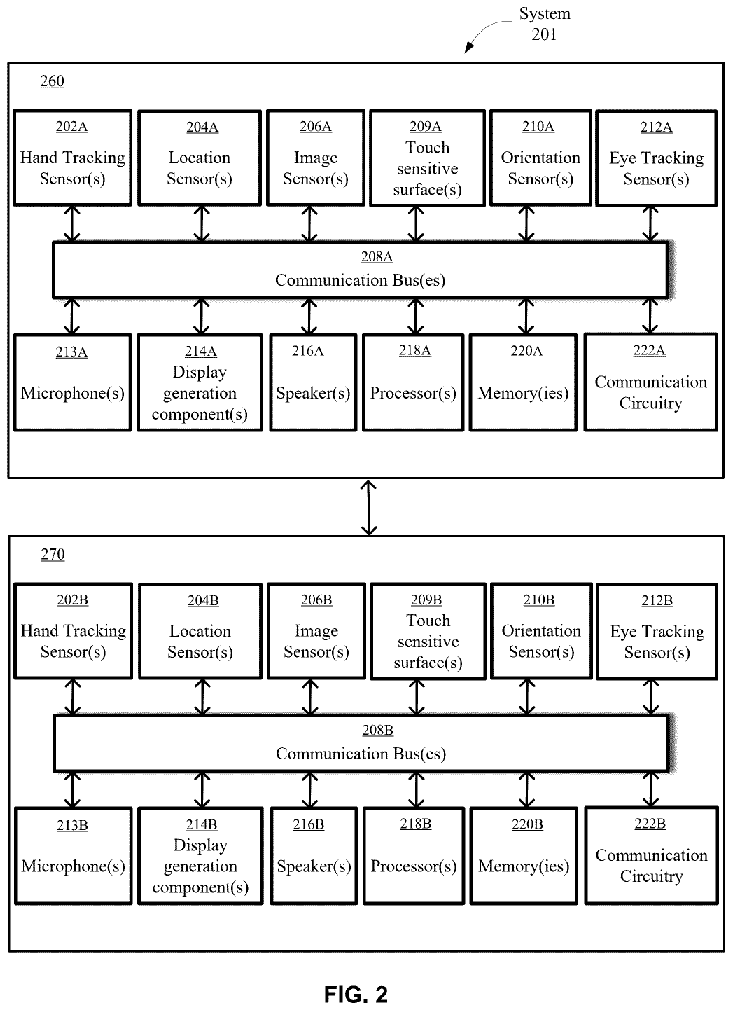

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to afield of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the electronic device 101 may be configured to display a virtual object 104 in the X R environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the X R environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for a system 201 according to some examples of the disclosure. In some examples, system 201 includes multiple devices. For example, the system 201 includes a first electronic device 260 and a second electronic device 270, wherein the first electronic device 260 and the second electronic device 270 are in communication with each other. In some examples, the first electronic device 260 and the second electronic device 270 are a portable device, such as a mobile phone, smart phone, a tablet computer, a laptop computer, an auxiliary device in communication with another device, a head-mounted display, etc., respectively. In some examples, the first electronic device 260 and the second electronic device 270 correspond to electronic device 101 described above with reference to FIG. 1.

As illustrated in FIG. 2, the first electronic device 260 optionally includes various sensors (e.g., one or more hand tracking sensors 202A, one or more location sensors 204A, one or more image sensors 206A, one or more touch-sensitive surfaces 209A, one or more motion and/or orientation sensors 210A, one or more eye tracking sensors 212A, one or more microphones 213A or other audio sensors, one or more body tracking sensors (e.g., torso and/or head tracking sensors), one or more display generation components 214A, one or more speakers 216A, one or more processors 218A, one or more memories 220A, and/or communication circuitry 222A. In some examples, the second electronic device 270 optionally includes various sensors (e.g., one or more hand tracking sensors 202B, one or more location sensors 204B, one or more image sensors 206B, one or more touch-sensitive surfaces 209B, one or more motion and/or orientation sensors 210B, one or more eye tracking sensors 212B, one or more microphones 213B or other audio sensors, one or more body tracking sensors (e.g., torso and/or head tracking sensors), one or more display generation components 214B, one or more speakers 216, one or more processors 218B, one or more memories 220B, and/or communication circuitry 222B. In some examples, the one or more display generation components 214A, 214B correspond to display 120 in FIG. 1. One or more communication buses 208A and 208B are optionally used for communication between the above-mentioned components of electronic devices 260 and 270, respectively. First electronic device 260 and second electronic device 270 optionally communicate via a wired or wireless connection (e.g., via communication circuitry 222A, 222B) between the two devices.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®.

Processor(s) 218A, 218B include one or more general processors, one or more graphics processors, and/or one or more digital signal processors. In some examples, memory 220A, 220B is a non-transitory computer-readable storage medium (e.g., flash memory, random access memory, or other volatile or non-volatile memory or storage) that stores computer-readable instructions configured to be executed by processor(s) 218A, 218B to perform the techniques, processes, and/or methods described below. In some examples, memory 220A, 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DV D), or Blu-ray technologies, as well as persistent solid-state memory such as flash, solid-state drives, and the like.

In some examples, display generation component(s) 214A, 214B include a single display (e.g., a liquid-crystal display (LCD), organic light-emitting diode (OLED), or other types of display). In some examples, display generation component(s) 214A, 214B includes multiple displays. In some examples, display generation component(s) 214A, 214B can include a display with touch capability (e.g., a touch screen), a projector, a holographic projector, a retinal projector, a transparent or translucent display, etc. In some examples, electronic devices 260 and 270 include touch-sensitive surface(s) 209A and 209B, respectively, for receiving user inputs, such as tap inputs and swipe inputs or other gestures. In some examples, display generation component(s) 214A, 214B and touch-sensitive surface(s) 209A, 209B form touch-sensitive display(s) (e.g., a touch screen integrated with electronic devices 260 and 270, respectively, or external to electronic devices 260 and 270, respectively, that is in communication with electronic devices 260 and 270).

Electronic devices 260 and 270 optionally include image sensor(s) 206A and 206B, respectively. Image sensors(s) 206A/206B optionally include one or more visible light image sensors, such as charged coupled device (CCD) sensors, and/or complementary metal-oxide-semiconductor (CM OS) sensors operable to obtain images of physical objects from the real-world environment. Image sensor(s) 206A/206B also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206A/206B also optionally include one or more cameras configured to capture movement of physical objects in the real-world environment. Image sensor(s) 206A/206B also optionally include one or more depth sensors configured to detect the distance of physical objects from electronic device 260/270. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic devices 260 and 270 use CCD sensors, event cameras, and depth sensors in combination to detect the physical environment around electronic devices 260 and 270. In some examples, image sensor(s) 206A/206B include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 260/270 uses image sensor(s) 206A/206B to detect the position and orientation of electronic device 260/270 and/or display generation component(s) 214A/214B in the real-world environment. For example, electronic device 260/270 uses image sensor(s) 206A/206B to track the position and orientation of display generation component(s) 214A/214B relative to one or more fixed objects in the real-world environment.

In some examples, electronic device 260/270 includes microphone(s) 213A/213B or other audio sensors. Device 260/270 uses microphone(s) 213A/213B to detect sound from the user and/or the real-world environment of the user. In some examples, microphone(s) 213A/213B includes an array of microphones (a plurality of microphones) that optionally operate in tandem, such as to identify ambient noise or to locate the source of sound in space of the real-world environment.

In some examples, device 260/270 includes location sensor(s) 204A/204B for detecting a location of device 260/270 and/or display generation component(s) 214A/214B. For example, location sensor(s) 204A/204B can include a global positioning system (GPS) receiver that receives data from one or more satellites and allows electronic device 260/270 to determine the device's absolute position in the physical world.

In some examples, electronic device 260/270 includes orientation sensor(s) 210A/210B for detecting orientation and/or movement of electronic device 260/270 and/or display generation component(s) 214A/214B. For example, electronic device 260/270 uses orientation sensor(s) 210A/210B to track changes in the position and/or orientation of electronic device 260/270 and/or display generation component(s) 214A/214B, such as with respect to physical objects in the real-world environment. Orientation sensor(s) 210A/210B optionally include one or more gyroscopes and/or one or more accelerometers.

Electronic device 260/270 includes hand tracking sensor(s) 202A/202B and/or eye tracking sensor(s) 212A/212B (and/or other body tracking sensor(s), such as leg, torso, and/or head tracking sensor(s)), in some examples. Hand tracking sensor(s) 202A/202B are configured to track the position/location of one or more portions of the user's hands, and/or motions of one or more portions of the user's hands with respect to the extended reality environment, relative to the display generation component(s) 214A/214B, and/or relative to another defined coordinate system. Eye tracking sensor(s) 212A/212B are configured to track the position and movement of a user's gaze (eyes, face, or head, more generally) with respect to the real-world or extended reality environment and/or relative to the display generation component(s) 214A/214B. In some examples, hand tracking sensor(s) 202A/202B and/or eye tracking sensor(s) 212A/212B are implemented together with the display generation component(s) 214A/214B. In some examples, the hand tracking sensor(s) 202A/202B and/or eye tracking sensor(s) 212A/212B are implemented separate from the display generation component(s) 214A/214B.

In some examples, the hand tracking sensor(s) 202A/202B (and/or other body tracking sensor(s), such as leg, torso, and/or head tracking sensor(s)) can use image sensor(s) 206A/206B (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206A/206B are positioned relative to the user to define a field of view of the image sensor(s) 206A/206B and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212A/212B includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 260/270 and system 201 are not limited to the components and configuration of FIG. 2, but can include fewer, other, or additional components in multiple configurations. In some examples, system 201 can be implemented in a single device. A person or persons using system 201, is optionally referred to herein as a user or users of the device(s). Attention is now directed towards exemplary concurrent displays of a three-dimensional environment on a first electronic device (e.g., corresponding to electronic device 260) and a second electronic device (e.g., corresponding to electronic device 270). As discussed below, the first electronic device may be in communication with the second electronic device in a multi-user communication session. In some examples, an avatar (e.g., a representation of) a user of the first electronic device may be displayed in the three-dimensional environment at the second electronic device, and an avatar of a user of the second electronic device may be displayed in the three-dimensional environment at the first electronic device. In some examples, the user of the first electronic device and the user of the second electronic device may be associated with a spatial group in the multi-user communication session.

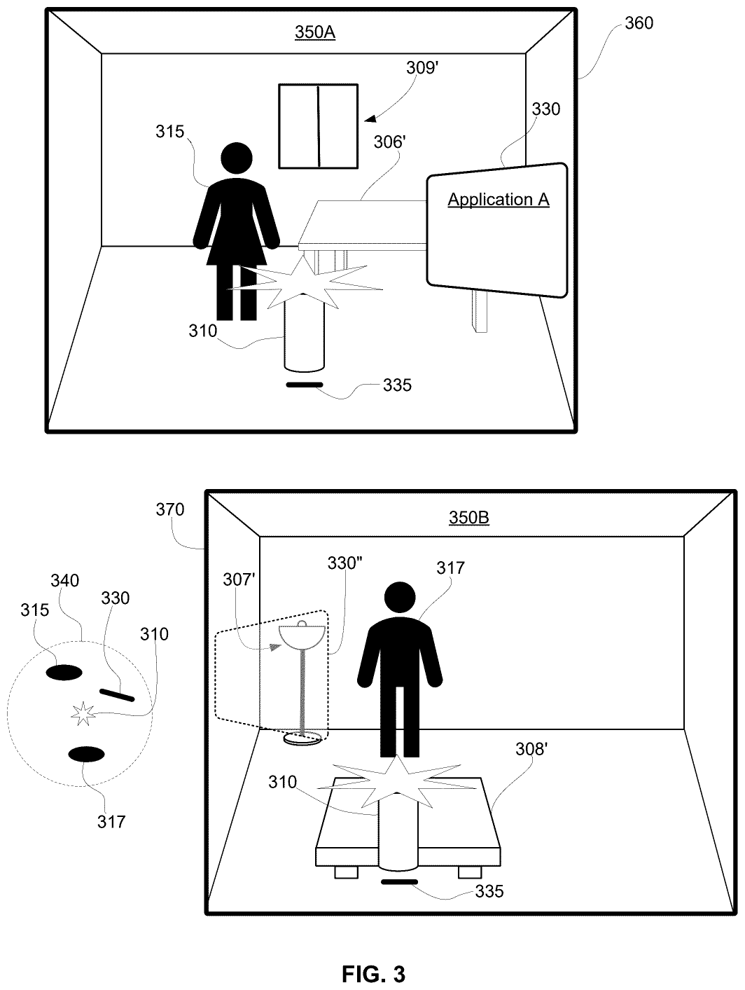

FIG. 3 illustrates an example of a multi-user communication session that includes a first electronic device 360 and a second electronic device 370 according to some examples of the disclosure. In some examples, the first electronic device 360 may present a three-dimensional environment 350A, and the second electronic device 370 may present a three-dimensional environment 350B. The first electronic device 360 and the second electronic device 370 may be similar to device 101 or 260/270, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, displays formed as lenses designed to be placed on a person's eyes (e.g., similar to contact lenses), respectively. In the example of FIG. 3, a first user is optionally wearing the first electronic device 360 and a second user is optionally wearing the second electronic device 370, such that the three-dimensional environment 350A/350B can be defined by X, Y and Z axes as viewed from a perspective of the electronic devices (e.g., a viewpoint associated with the electronic device 360/370, which may be a head-mounted display, for example).

As shown in FIG. 3, the first electronic device 360 may be in a first physical environment that includes a table 306 and a window 309. Thus, the three-dimensional environment 350A presented using the first electronic device 360 optionally includes captured portions of the physical environment surrounding the first electronic device 360, such as a representation of the table 306′ and a representation of the window 309′. Similarly, the second electronic device 370 may be in a second physical environment, different from the first physical environment (e.g., separate from the first physical environment), that includes a floor lamp 307 and a coffee table 308. Thus, the three-dimensional environment 350B presented using the second electronic device 370 optionally includes captured portions of the physical environment surrounding the second electronic device 370, such as a representation of the floor lamp 307′ and a representation of the coffee table 308′. Additionally, the three-dimensional environments 350A and 350B may include representations of the floor, ceiling, and walls of the room in which the first electronic device 360 and the second electronic device 370, respectively, are located.

As mentioned above, in some examples, the first electronic device 360 is optionally in a multi-user communication session with the second electronic device 370. For example, the first electronic device 360 and the second electronic device 370 (e.g., via communication circuitry 222A/222B) are configured to present a shared three-dimensional environment 350A/350B that includes one or more shared virtual objects (e.g., content such as images, video, audio and the like, representations of user interfaces of applications, etc.). As used herein, the term “shared three-dimensional environment” refers to a three-dimensional environment that is independently presented, displayed, and/or visible at two or more electronic devices via which content, applications, data, and the like may be shared and/or presented to users of the two or more electronic devices. In some examples, while the first electronic device 360 is in the multi-user communication session with the second electronic device 370, an avatar corresponding to the user of one electronic device is optionally displayed in the three-dimensional environment that is displayed via the other electronic device. For example, as shown in FIG. 3, at the first electronic device 360, an avatar 315 corresponding to the user of the second electronic device 370 is displayed in the three-dimensional environment 350A. Similarly, at the second electronic device 370, an avatar 317 corresponding to the user of the first electronic device 360 is displayed in the three-dimensional environment 350B.

In some examples, the presentation of avatars 315/317 as part of a shared three-dimensional environment is optionally accompanied by an audio effect corresponding to a voice of the users of the electronic devices 370/360. For example, the avatar 315 displayed in the three-dimensional environment 350A using the first electronic device 360 is optionally accompanied by an audio effect corresponding to the voice of the user of the second electronic device 370. In some such examples, when the user of the second electronic device 370 speaks, the voice of the user may be detected by the second electronic device 370 (e.g., via the microphone(s) 213B) and transmitted to the first electronic device 360 (e.g., via the communication circuitry 222B/222A), such that the detected voice of the user of the second electronic device 370 may be presented as audio (e.g., using speaker(s) 216A) to the user of the first electronic device 360 in three-dimensional environment 350A. In some examples, the audio effect corresponding to the voice of the user of the second electronic device 370 may be spatialized such that it appears to the user of the first electronic device 360 to emanate from the location of avatar 315 in the shared three-dimensional environment 350A (e.g., despite being outputted from the speakers of the first electronic device 360). Similarly, the avatar 317 displayed in the three-dimensional environment 350B using the second electronic device 370 is optionally accompanied by an audio effect corresponding to the voice of the user of the first electronic device 360. In some such examples, when the user of the first electronic device 360 speaks, the voice of the user may be detected by the first electronic device 360 (e.g., via the microphone(s) 213A) and transmitted to the second electronic device 370 (e.g., via the communication circuitry 222A/222B), such that the detected voice of the user of the first electronic device 360 may be presented as audio (e.g., using speaker(s) 216B) to the user of the second electronic device 370 in three-dimensional environment 350B. In some examples, the audio effect corresponding to the voice of the user of the first electronic device 360 may be spatialized such that it appears to the user of the second electronic device 370 to emanate from the location of avatar 317 in the shared three-dimensional environment 350B (e.g., despite being outputted from the speakers of the first electronic device 360).

In some examples, while in the multi-user communication session, the avatars 315/317 are displayed in the three-dimensional environments 350A/350B with respective orientations that correspond to and/or are based on orientations of the electronic devices 360/370 (and/or the users of electronic devices 360/370) in the physical environments surrounding the electronic devices 360/370. For example, as shown in FIG. 3, in the three-dimensional environment 350A, the avatar 315 is optionally facing toward the viewpoint of the user of the first electronic device 360, and in the three-dimensional environment 350B, the avatar 317 is optionally facing toward the viewpoint of the user of the second electronic device 370. As a particular user moves the electronic device (and/or themself) in the physical environment, the viewpoint of the user changes in accordance with the movement, which may thus also change an orientation of the user's avatar in the three-dimensional environment. For example, with reference to FIG. 3, if the user of the first electronic device 360 were to look leftward in the three-dimensional environment 350A such that the first electronic device 360 is rotated (e.g., a corresponding amount) to the left (e.g., counterclockwise), the user of the second electronic device 370 would see the avatar 317 corresponding to the user of the first electronic device 360 rotate to the right (e.g., clockwise) relative to the viewpoint of the user of the second electronic device 370 in accordance with the movement of the first electronic device 360.

Additionally, in some examples, while in the multi-user communication session, a viewpoint of the three-dimensional environments 350A/350B and/or a location of the viewpoint of the three-dimensional environments 350A/350B optionally changes in accordance with movement of the electronic devices 360/370 (e.g., by the users of the electronic devices 360/370). For example, while in the communication session, if the first electronic device 360 is moved closer toward the representation of the table 306′ and/or the avatar 315 (e.g., because the user of the first electronic device 360 moved forward in the physical environment surrounding the first electronic device 360), the viewpoint of the three-dimensional environment 350A would change accordingly, such that the representation of the table 306′, the representation of the window 309′ and the avatar 315 appear larger in the field of view. In some examples, each user may independently interact with the three-dimensional environment 350A/350B, such that changes in viewpoints of the three-dimensional environment 350A and/or interactions with virtual objects in the three-dimensional environment 350A by the first electronic device 360 optionally do not affect what is shown in the three-dimensional environment 350B at the second electronic device 370, and vice versa.

In some examples, the avatars 315/317 are a representation (e.g., a full-body rendering) of the users of the electronic devices 370/360. In some examples, the avatar 315/317 is a representation of a portion (e.g., a rendering of a head, face, head and torso, etc.) of the users of the electronic devices 370/360. In some examples, the avatars 315/317 are a user-personalized, user-selected, and/or user-created representation displayed in the three-dimensional environments 350A/350B that is representative of the users of the electronic devices 370/360. It should be understood that, while the avatars 315/317 illustrated in FIG. 3 correspond to full-body representations of the users of the electronic devices 370/360, respectively, alternative avatars may be provided, such as those described above.

As mentioned above, while the first electronic device 360 and the second electronic device 370 are in the multi-user communication session, the three-dimensional environments 350A/350B may be a shared three-dimensional environment that is presented using the electronic devices 360/370. In some examples, content that is viewed by one user at one electronic device may be shared with another user at another electronic device in the multi-user communication session. In some such examples, the content may be experienced (e.g., viewed and/or interacted with) by both users (e.g., via their respective electronic devices) in the shared three-dimensional environment (e.g., the content is shared content in the three-dimensional environment). For example, as shown in FIG. 3, the three-dimensional environments 350A/350B include a shared virtual object 310 (e.g., which is optionally a three-dimensional virtual sculpture) associated with a respective application (e.g., a content creation application) and that is viewable by and interactive to both users. As shown in FIG. 3, the shared virtual object 310 may be displayed with a grabber affordance (e.g., a handlebar) 335 that is selectable to initiate movement of the shared virtual object 310 within the three-dimensional environments 350A/350B.

In some examples, the three-dimensional environments 350A/350B include unshared content that is private to one user in the multi-user communication session. For example, in FIG. 3, the first electronic device 360 is displaying a private application window 330 in the three-dimensional environment 350A, which is optionally an object that is not shared between the first electronic device 360 and the second electronic device 370 in the multi-user communication session. In some examples, the private application window 330 may be associated with a respective application that is operating on the first electronic device 360 (e.g., such as a media player application, a web browsing application, a messaging application, etc.). Because the private application window 330 is not shared with the second electronic device 370, the second electronic device 370 optionally displays a representation of the private application window 330″ in three-dimensional environment 350B. As shown in FIG. 3, in some examples, the representation of the private application window 330″ may be a faded, occluded, discolored, and/or translucent representation of the private application window 330 that prevents the user of the second electronic device 370 from viewing contents of the private application window 330.

Additionally, in some examples, the virtual object 310 corresponds to a first type of object and the private application window 330 corresponds to a second type of object, different from the first type of object. In some examples, the object type is determined based on an orientation of the shared object in the shared three-dimensional environment. For example, an object of the first type is an object that has a horizontal orientation in the shared three-dimensional environment relative to the viewpoint of the user of the electronic device. As shown in FIG. 3, the shared virtual object 310, as similarly discussed above, is optionally a virtual sculpture having a volume and/or horizontal orientation in the three-dimensional environment 350A/350B relative to the viewpoints of the users of the first electronic device 360 and the second electronic device 370. Accordingly, as discussed above, the shared virtual object 310 is an object of the first type. On the other hand, an object of the second type is an object that has a vertical orientation in the shared three-dimensional environment relative to the viewpoint of the user of the electronic device. For example, in FIG. 3D, the shared virtual object 310 (e.g., private application window), as similarly discussed above, is a two-dimensional object having a vertical orientation in the three-dimensional environment 350A/350B relative to the viewpoints of the users of the first electronic device 360 and the second electronic device 370. Accordingly, as outlined above, the private application window 330 (and thus the representation of the private application window 330″) is an object of the second type. In some examples, as described in more detail later, the object type dictates a spatial template for the users in the shared three-dimensional environment that determines where the avatars 315/317 are positioned spatially relative to the object in the shared three-dimensional environment.

In some examples, the user of the first electronic device 360 and the user of the second electronic device 370 share a same spatial state 340 within the multi-user communication session. In some examples, the spatial state 340 may be a baseline (e.g., a first or default) spatial state within the multi-user communication session. For example, when the user of the first electronic device 360 and the user of the second electronic device 370 initially join the multi-user communication session, the user of the first electronic device 360 and the user of the second electronic device 370 are automatically (and initially, as discussed in more detail below) associated with (e.g., grouped into) the spatial state 340 within the multi-user communication session. In some examples, while the users are in the spatial state 340 as shown in FIG. 3, the user of the first electronic device 360 and the user of the second electronic device 370 have a first spatial arrangement (e.g., first spatial template) within the shared three-dimensional environment, as represented by locations of ovals 315A (e.g., corresponding to the user of the second electronic device 370) and 317A (e.g., corresponding to the user of the first electronic device 360). For example, the user of the first electronic device 360 and the user of the second electronic device 370, including objects that are displayed in the shared three-dimensional environment, have spatial truth within the spatial state 340. In some examples, spatial truth requires a consistent spatial arrangement between users (or representations thereof) and virtual objects. For example, a distance between the viewpoint of the user of the first electronic device 360 and the avatar 315 corresponding to the user of the second electronic device 370 may be the same as a distance between the viewpoint of the user of the second electronic device 370 and the avatar 317 corresponding to the user of the first electronic device 360. As described herein, if the location of the viewpoint of the user of the first electronic device 360 moves, the avatar 317 corresponding to the user of the first electronic device 360 moves in the three-dimensional environment 350B in accordance with the movement of the location of the viewpoint of the user relative to the viewpoint of the user of the second electronic device 370. Additionally, if the user of the first electronic device 360 performs an interaction on the shared virtual object 310 (e.g., moves the virtual object 310 in the three-dimensional environment 350A), the second electronic device 370 alters display of the shared virtual object 310 in the three-dimensional environment 350B in accordance with the interaction (e.g., moves the virtual object 310 in the three-dimensional environment 350B).

It should be understood that, in some examples, more than two electronic devices may be communicatively linked in a multi-user communication session. For example, in a situation in which three electronic devices are communicatively linked in a multi-user communication session, a first electronic device would display two avatars, rather than just one avatar, corresponding to the users of the other two electronic devices. It should therefore be understood that the various processes and exemplary interactions described herein with reference to the first electronic device 360 and the second electronic device 370 in the multi-user communication session optionally apply to situations in which more than two electronic devices are communicatively linked in a multi-user communication session.

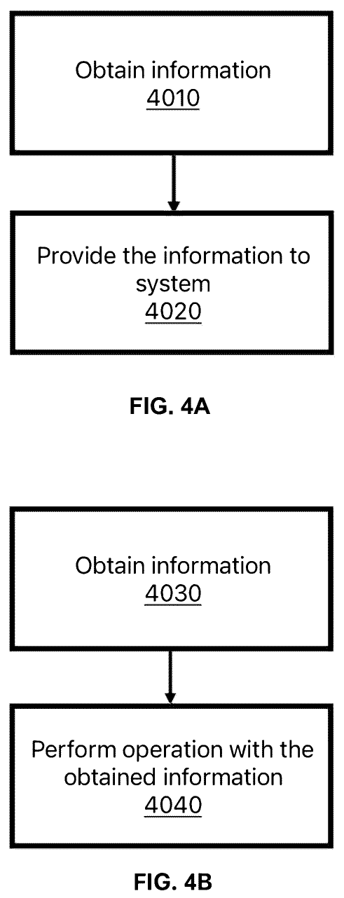

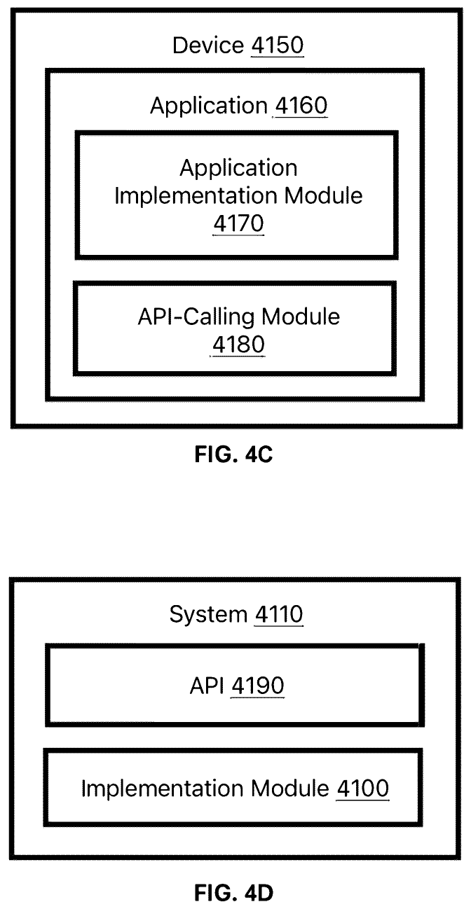

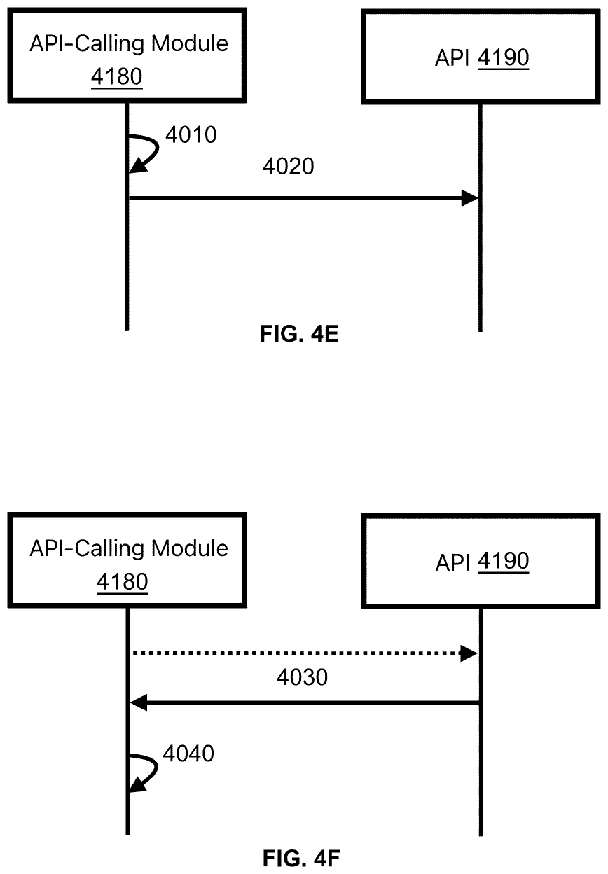

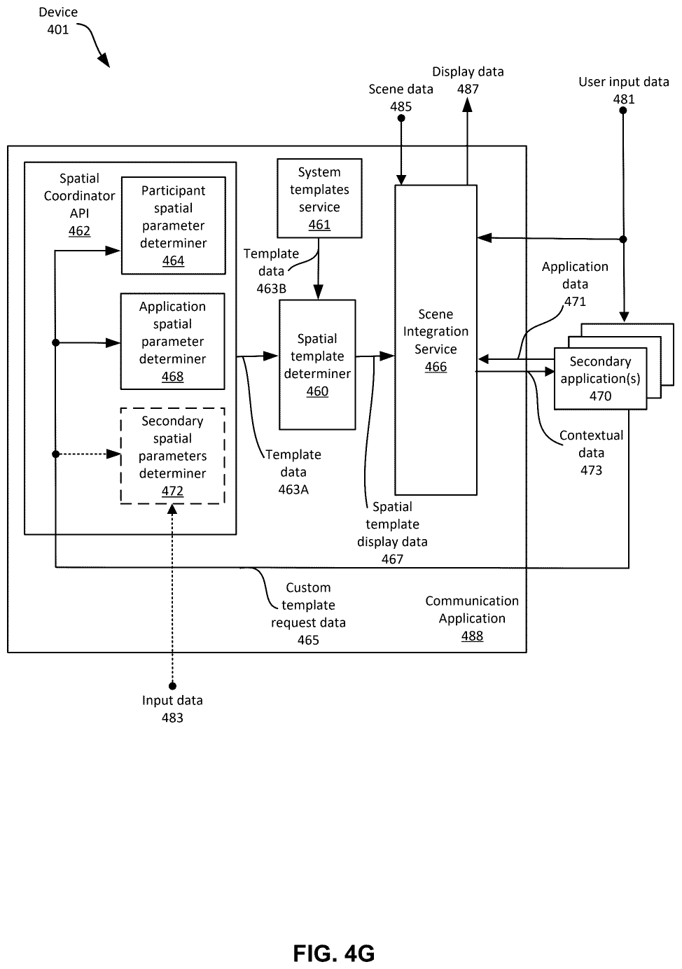

In some examples, it may be advantageous to selectively control the display of content and avatars corresponding to the users of electronic devices that are communicatively linked in a multi-user communication session. As mentioned above, content that is displayed and/or shared in the three-dimensional environment while multiple users are in a multi-user communication session may be associated with respective applications that provide data for displaying the content in the three-dimensional environment. In some examples, a communication application may be provided (e.g., locally on each electronic device or remotely via a server (e.g., wireless communications terminal) in communication with each electronic device) for facilitating the multi-user communication session. In some such examples, the communication application receives the data from the respective applications and based on the data, selects/defines one or more spatial templates (e.g., spatial arrangements) according to which the avatars and the content are displayed in the three-dimensional environment. For example, the data provided by the respective applications includes indications and/or designations of positional offsets and/or orientations of the avatars relative to the content that is to be displayed in the shared three-dimensional environment within the multi-user communication session, as discussed herein. Example architecture for the communication session application is provided in FIG. 4G, as discussed in more detail below.

FIGS. 4A-4F illustrate the use of Application Programming Interfaces (APIs) to perform operations according to some examples of the disclosure.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application (e.g., application 4160) that, when executed by one or more processing units, control an electronic device (e.g., device 4150) to perform the method of FIG. 4A, the method of FIG. 4B, and/or one or more other processes and/or methods described herein.

It should be recognized that application 4160 (shown in FIG. 4C) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some examples, application 4160 is an application that is pre-installed on device 4150 at purchase (e.g., a first party application). In other examples, application 4160 is an application that is provided to device 4150 via an operating system update file (e.g., a first party application or a second party application). In other examples, application 4160 is an application that is provided via an application store. In some examples, the application store can be an application store that is pre-installed on device 4150 at purchase (e.g., a first party application store). In other examples, the application store is a third-party application store (e.g., an application store that is provided by another application store, downloaded via a network, and/or read from a storage device).

Referring to FIG. 4A and FIG. 4E, application 4160 obtains information (e.g., 4010). In some examples, at 4010, information is obtained from at least one hardware component of the device 4150. In some examples, at 4010, information is obtained from at least one software module of the device 4150. In some examples, at 4010, information is obtained from at least one hardware component external to the device 4150 (e.g., a peripheral device, an accessory device, a server, etc.). In some examples, the information obtained at 4010 includes positional information, time information, notification information, user information, environment information, electronic device state information, weather information, media information, historical information, event information, hardware information, and/or motion information. In some examples, in response to and/or after obtaining the information at 4010, application 4160 provides the information to a system (e.g., 4020).

In some examples, the system (e.g., 4110 shown in FIG. 4D) is an operating system hosted on the device 4150. In some examples, the system (e.g., 4110 shown in FIG. 4D) is an external device (e.g., a server, a peripheral device, an accessory, a personal computing device, etc.) that includes an operating system.

Referring to FIG. 4B and FIG. 4F, application 4160 obtains information (e.g., 4030). In some examples, the information obtained at 4030 includes positional information, time information, notification information, user information, environment information electronic device state information, weather information, media information, historical information, event information, hardware information and/or motion information. In response to and/or after obtaining the information at 4030, application 4160 performs an operation with the information (e.g., 4040). In some examples, the operation performed at 4040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 4110 based on the information.

In some examples, one or more steps of the method of FIG. 4A and/or the method of FIG. 4B is performed in response to a trigger. In some examples, the trigger includes detection of an event, a notification received from system 4110, a user input, and/or a response to a call to an API provided by system 4110.

In some examples, the instructions of application 4160, when executed, control device 4150 to perform the method of FIG. 4A and/or the method of FIG. 4B by calling an application programming interface (API) (e.g., API 4190) provided by system 4110. In some examples, application 4160 performs at least a portion of the method of FIG. 4A and/or the method of FIG. 4B without calling API 4190.

In some examples, one or more steps of the method of FIG. 4A and/or the method of FIG. 4B includes calling an API (e.g., API 4190) using one or more parameters defined by the API. In some examples, the one or more parameters include a constant, a key, a data structure, an object, an object class, a variable, a data type, a pointer, an array, a list or a pointer to a function or method, and/or another way to reference a data or other item to be passed via the API.

Referring to FIG. 4C, device 4150 is illustrated. In some examples, device 4150 is a personal computing device, a smart phone, a smart watch, a fitness tracker, a head mounted display (H M D) device, a media device, a communal device, a speaker, a television, and/or a tablet. As illustrated in FIG. 4C, device 4150 includes application 4160 and operating system (e.g., system 4110 shown in FIG. 4D). Application 4160 includes application implementation module 4170 and API-calling module 4180. System 4110 includes API 4190 and implementation module 4100. It should be recognized that device 4150, application 4160, and/or system 4110 can include more, fewer, and/or different components than illustrated in FIGS. 4C and 4D.

In some examples, application implementation module 4170 includes a set of one or more instructions corresponding to one or more operations performed by application 4160. For example, when application 4160 is a messaging application, application implementation module 4170 can include operations to receive and send messages. In some examples, application implementation module 4170 communicates with API calling module to communicate with system 4110 via API 4190 (shown in FIG. 4D).

In some examples, API 4190 is a software module (e.g., a collection of computer-readable instructions) that provides an interface that allows a different module (e.g., API calling module 4180) to access and/or use one or more functions, methods, procedures, data structures, classes, and/or other services provided by implementation module 4100 of system 4110. For example, API-calling module 4180 can access a feature of implementation module 4100 through one or more API calls or invocations (e.g., embodied by a function or a method call) exposed by API 4190 (e.g., a software and/or hardware module that can receive API calls, respond to API calls, and/or send API calls) and can pass data and/or control information using one or more parameters via the API calls or invocations. In some examples, API 4190 allows application 4160 to use a service provided by a Software Development Kit (SDK) library. In other examples, application 4160 incorporates a call to a function or method provided by the SDK library and provided by API 4190 or uses data types or objects defined in the SDK library and provided by API 4190. In some examples, API-calling module 4180 makes an API call via API 4190 to access and use a feature of implementation module 4100 that is specified by API 4190. In such examples, implementation module 4100 can return a value via API 4190 to API-calling module 4180 in response to the API call. The value can report to application 4160 the capabilities or state of a hardware component of device 4150, including those related to aspects such as input capabilities and state, output capabilities and state, processing capability, power state, storage capacity and state, and/or communications capability. In some examples, API 4190 is implemented in part by firmware, microcode, or other low-level logic that executes in part on the hardware component.

In some examples, API 4190 allows a developer of API-calling module 4180 (which can be a third-party developer) to leverage a feature provided by implementation module 4100. In such examples, there can be one or more API-calling modules (e.g., including API-calling module 4180) that communicate with implementation module 4100. In some examples, API 4190 allows multiple API-calling modules written in different programming languages to communicate with implementation module 4100 (e.g., API 4190 can include features for translating calls and returns between implementation module 4100 and API-calling module 4180) while API 4190 is implemented in terms of a specific programming language. In some examples, API-calling module 4180 calls A Pls from different providers such as a set of A Pls from an OS provider, another set of APIs from a plug-in provider, and/or another set of APIs from another provider (e.g., the provider of a software library) or creator of the another set of APIs.

Examples of API 4190 can include one or more of: a pairing API (e.g., for establishing secure connection, e.g., with an accessory), a device detection API (e.g., for locating nearby devices, e.g., media devices and/or smartphone), a payment API, a UIK it API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some examples, the sensor API is an API for accessing data associated with a sensor of device 4150. For example, the sensor API can provide access to raw sensor data. For another example, the sensor API can provide data derived (and/or generated) from the raw sensor data. In some examples, the sensor data includes temperature data, image data, video data, audio data, heart rate data, IM U (inertial measurement unit) data, lidar data, location data, GPS data, and/or camera data. In some examples, the sensor includes one or more of an accelerometer, temperature sensor, infrared sensor, optical sensor, heartrate sensor, barometer, gyroscope, proximity sensor, temperature sensor and/or biometric sensor.

In some examples, implementation module 4100 is a system (e.g., operating system, server system) software module (e.g., a collection of computer-readable instructions) that is constructed to perform an operation in response to receiving an API call via API 4190. In some examples, implementation module 4100 is constructed to provide an API response (via API 4190) as a result of processing an API call. By way of example, implementation module 4100 and API-calling module 4180 can each be any one of an operating system, a library, a device driver, an API, an application program, or other module. It should be understood that implementation module 4100 and API-calling module 4180 can be the same or different type of module from each other. In some examples, implementation module 4100 is embodied at least in part in firmware, microcode, or other hardware logic.

In some examples, implementation module 4100 returns a value through API 4190 in response to an API call from API-calling module 4180. While API 4190 defines the syntax and result of an API call (e.g., how to invoke the API call and what the API call does), API 4190 might not reveal how implementation module 4100 accomplishes the function specified by the API call. Various API calls are transferred via the one or more application programming interfaces between API-calling module 4180 and implementation module 4100. Transferring the API calls can include issuing, initiating, invoking, calling, receiving, returning, and/or responding to the function calls or messages. In other words, transferring can describe actions by either of API-calling module 4180 or implementation module 4100. In some examples, a function call or other invocation of API 4190 sends and/or receives one or more parameters through a parameter list or other structure.

In some examples, implementation module 4100 provides more than one API, each providing a different view of or with different aspects of functionality implemented by implementation module 4100. For example, one API of implementation module 4100 can provide a first set of functions and can be exposed to third party developers, and another API of implementation module 4100 can be hidden (e.g., not exposed) and provide a subset of the first set of functions and also provide another set of functions, such as testing or debugging functions which are not in the first set of functions. In some examples, implementation module 4100 calls one or more other components via an underlying API and thus be both an API calling module and an implementation module. It should be recognized that implementation module 4100 can include additional functions, methods, classes, data structures, and/or other features that are not specified through API 4190 and are not available to API-calling module 4180. It should also be recognized that API-calling module 4180 can be on the same system as implementation module 4100 or can be located remotely and access implementation module 4100 using API 4190 over a network. In some examples, implementation module 4100, API 4190, and/or API-calling module 4180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, or used by a software process (e.g., generating outputs for use by a software process based on input from the software process). Some APIs enable content from a software process to be inserted into a template and displayed in a user interface that has a layout and/or behaviors that are specified by the template.

M any software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. M any of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected the direct sensor data is frequently processes into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some examples, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

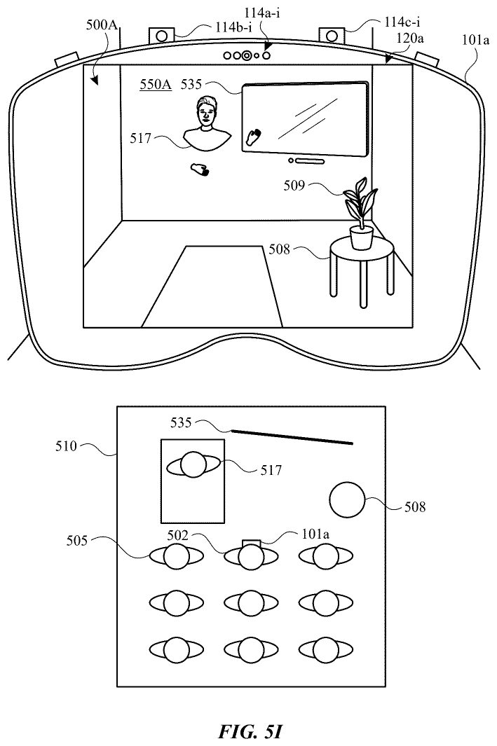

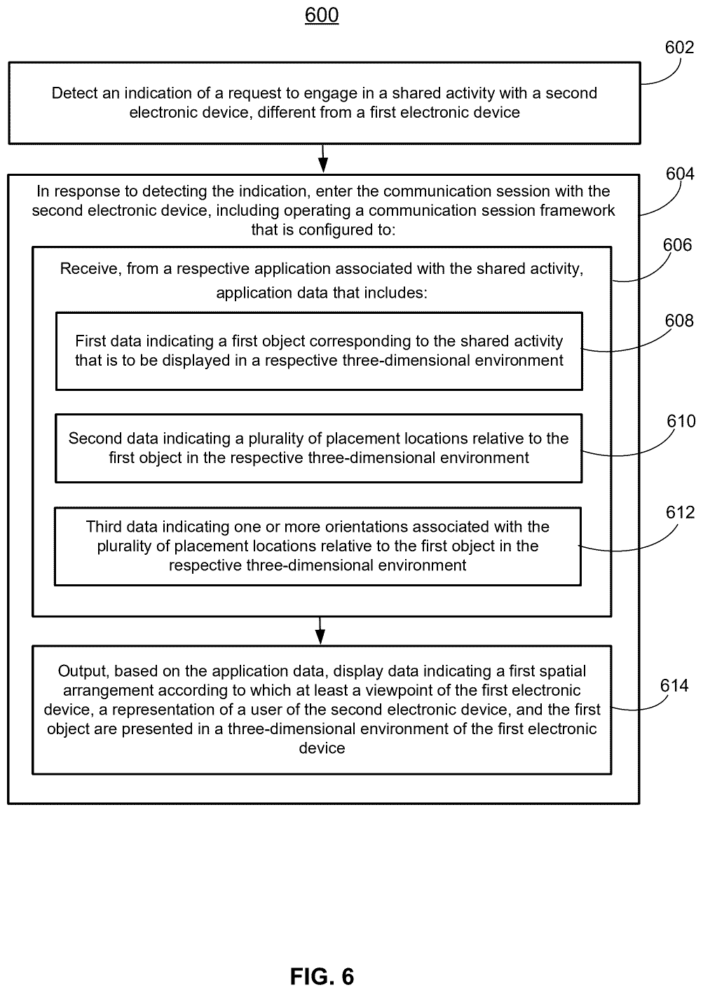

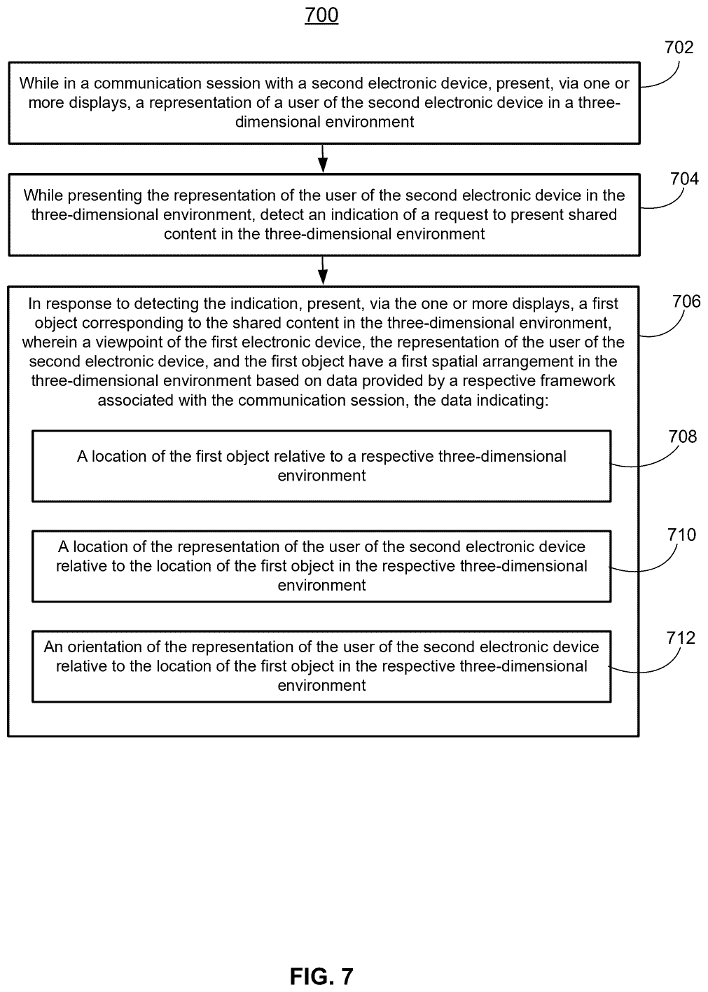

In some examples, the application is an application that is pre-installed on the first computer system at purchase (e.g., a first party application). In other examples, the application is an application that is provided to the first computer system via an operating system update file (e.g., a first party application). In other examples, the application is an application that is provided via an application store. In some implementations, the application store is pre-installed on the first computer system at purchase (e.g., a first party application store) and allows download of one or more applications. In some examples, the application store is a third party application store (e.g., an application store that is provided by another device, downloaded via a network, and/or read from a storage device). In some examples, the application is a third party application (e.g., an app that is provided by an application store, downloaded via a network, and/or read from a storage device). In some examples, the application controls the first computer system to perform processes 600, 700 and/or 1000 (FIGS. 6, 7 and/or 10) by calling an application programming interface (API) provided by the system process using one or more parameters.

In some examples, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIK it API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API.

In some examples, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some examples, the API 4190 defines a first API call that can be provided by API-calling module 4180. The implementation module is a system software module (e.g., a collection of computer-readable instructions) that is constructed to perform an operation in response to receiving an API call via the API. In some examples, the implementation module is constructed to provide an API response (via the API) as a result of processing an API call. In some examples, the implementation module is included in the device (e.g., 4150) that runs the application. In some examples, the implementation module is included in an electronic device that is separate from the device that runs the application.

FIG. 4G illustrates a block diagram of an exemplary architecture for a communication session application configured to facilitate a multi-user communication session according to some examples of the disclosure. In some examples, as shown in FIG. 4G, a communication application or framework 488 may be configured to operate on electronic device 401 (e.g., corresponding to electronic device 101 in FIG. 1). In some examples, the communication application 488 may be configured to operate at a server (e.g., a wireless communications terminal) in communication with the electronic device 401. In some examples, as discussed below, the communication application 488 may facilitate a multi-user communication session that includes a plurality of electronic devices (e.g., including the electronic device 401) associated with a plurality of users/participants, such as the first electronic device 360 and the second electronic device 370 described above with reference to FIG. 3.

In some examples, as shown in FIG. 4G, the communication application 488 is configured to communicate with one or more secondary applications 470. In some examples, as discussed in more detail below, the communication application 488 and the one or more secondary applications 470 transmit and exchange data and other high-level information via a spatial coordinator Application Program Interface (API) 462. An API, as used herein, can define one or more parameters that are passed between a calling application and other software code (e.g., an operating system, library routine, function) that provides a service, which provides data, or which performs an operation or a computation. The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API. In some examples, an API call can report to an application the capabilities of a device running the application, such as input capability, output capability, processing capability, power capability, communications capability, etc. In some examples, the spatial coordinator API 462 has one or more characteristics of the API 4190 discussed above.

In some examples, as shown in FIG. 4G, scene integration service 466 is configured to receive application data 471 from the one or more secondary applications 470. For example, as discussed previously with reference to FIG. 3, virtual objects (e.g., including content) may be displayed in a shared three-dimensional environment within a multi-user communication session. In some examples, the virtual objects may be associated with one or more respective applications, such as the one or more secondary applications 470. In some examples, the application data 471 includes information corresponding to an appearance of a virtual object, interactive features of the virtual object (e.g., whether the object can be moved, selected, etc.), a size of the virtual object (e.g., including a dimensionality of the virtual object), etc. In some examples, as discussed in more detail below, the application data 471 is utilized by the scene integration service 466 to generate and define one or more display parameters for one or more virtual objects that are associated with the one or more secondary applications 470, wherein the one or more display parameters control the display of the one or more virtual objects in the shared three-dimensional environment. In some examples, as shown in FIG. 4G, the application data 471 is received via scene integration service 466.

Additionally, in some examples, as shown in FIG. 4G, the scene integration service 466 is configured to utilize scene data 485. In some examples, the scene data 485 includes information corresponding to a physical environment (e.g., a real-world environment), such as the real-world environment discussed above with reference to FIG. 3, that is captured via one or more sensors of the electronic device 401 (e.g., via image sensors 206A/206B in FIG. 2). For example, the scene data 485 includes information corresponding to one or more features of the physical environment, such as an appearance of the physical environment, including locations of objects within the physical environment (e.g., objects that form a part of the physical environment, optionally non-inclusive of virtual objects), a size of the physical environment, behaviors of objects within the computer-generated environment (e.g., background objects, such as background users, pets, vehicles, etc.), etc. In some examples, the scene integration service 466 receives the scene data 485 externally (e.g., from an operating system of the electronic device 401). In some examples, the scene data 485 may be provided to the one or more secondary applications in the form of contextual data 473. For example, the contextual data 473 enables the one or more secondary applications 470 to interpret the physical environment surrounding the virtual objects described above, which is optionally included in the shared three-dimensional environment as passthrough (e.g., optical passthrough or true passthrough).

In some examples, the communication application 488 and/or the one or more secondary applications 470 are configured to receive user input data 481 (e.g., from an operating system of the electronic device 401). For example, the user input data 481 may correspond to user input detected via one or more input devices in communication with the electronic device 401, such as contact-based input detected via a physical input device (e.g., touch sensitive surfaces 209A/209B in FIG. 2) or hand gesture-based and/or gaze-based input detected via sensor devices (e.g., hand tracking sensors 202A/202B, orientation sensors 210A/210B, and/or eye tracking sensors 212A/212B). In some examples, the user input data 481 includes information corresponding to input that is directed to one or more virtual objects that are displayed in the shared three-dimensional environment and that are associated with the one or more secondary applications 470. For example, the user input data 481 includes information corresponding to input to directly interact with a virtual object, such as moving the virtual object in the shared three-dimensional environment, or information corresponding to input for causing display of a virtual object (e.g., launching the one or more secondary applications 470 and/or sharing the virtual object within the shared three-dimensional environment). In some examples, the user input data 481 includes information corresponding to input that is directed to the shared three-dimensional environment that is displayed at the electronic device 401. For example, the user input data 481 includes information corresponding to input for moving (e.g., rotating and/or shifting) a viewpoint of a user of the electronic device 401 in the shared three-dimensional environment.

In some examples, as mentioned above, the spatial coordinator API 462 is configured to define a spatial template (e.g., a spatial template customized by the one or more secondary applications 470) according to which the virtual elements (e.g., virtual objects, including content, and avatars) are displayed (e.g., positioned and/or oriented) in the shared three-dimensional environment at the electronic device 401. In some examples, as shown in FIG. 4G, the spatial coordinator API 462 includes a participant spatial parameter determiner 464 (e.g., optionally a sub-API and/or a first function, such as a participant spatial parameter API/function) that provides (e.g., defines) a spatial parameter for the participants in the multi-user communication session. In some examples, as indicated in FIG. 4G, the participant spatial parameter is provided via custom template request data 465 provided from the one or more secondary applications 470, as discussed in more detail below. In some examples, the participant spatial parameter is utilized to define one or more “seats” (e.g., positions/locations assigned to the users) within a spatial template. As used herein, the positions of seats within a given spatial template determines the specific spatial arrangement of the participants in the multi-user communication session, optionally relative to the content that is being displayed/shared in the multi-user communication session. In some examples, each participant/user in the multi-user communication session is assigned to (e.g., occupies) a seat within the spatial template in the shared three-dimensional environment. In some examples, seats within a given spatial template are not visually indicated/delineated by the electronic device 401. In some examples, seats within a given spatial template are visually indicated/delineated by the electronic device 401.

In some examples, the participant spatial parameter therefore defines a spatial arrangement of one or more participants in the multi-user communication session relative to a virtual object (e.g., such as virtual object 310 or private application window 330 in FIG. 3) that is displayed in the shared three-dimensional environment, as discussed in more detail below. In some examples, as shown in FIG. 4G, the participant spatial parameter determiner 464 defines the participant spatial parameter for the one or more participants in the multi-user communication session based on custom template request data 465 received from the one or more secondary applications 470. In some examples, the custom template request data 465 includes information and/or data indicating a position offset relative to a virtual object (e.g., shared content) that is associated with the one or more secondary applications 470. For example, the position offset relative to the virtual object corresponds to the distance and/or location at which a respective participant (e.g., represented by their respective avatar and/or viewpoint) is positioned relative to the virtual object in the shared three-dimensional environment. Additionally, in some examples, the position offset determines a spatial separation between one or more virtual objects associated with the one or more secondary applications 470 and one or more participants in the multi-user communication session. For example, the seats defined by the participant spatial parameter determiner 464 according to and/or based on the custom template request data 465 are distributed (e.g., separated) by a particular distance, which controls the distance between adjacent avatars corresponding to users in the multi-user communication session within a respective spatial template (e.g., where such distances may be different values or the same value). In some examples, the custom template request data 465 includes information and/or data indicating an orientation offset relative to the virtual object that is associated with the one or more secondary applications 470. For example, the orientation offset relative to the virtual object corresponds to the orientation with which a respective participant (e.g., represented by their respective avatar and/or viewpoint) is displayed relative to the virtual object in the shared three-dimensional environment. In some examples, the orientation of the respective participant determines a forward-facing direction of the respective participant (e.g., and thus their viewpoint) within the spatial template. For example, the orientation of the respective participant, as defined by the orientation offset of the custom template request data 465, controls which portions of the shared three-dimensional environment, including the particular portions of the virtual object and/or other participants (e.g., represented by their respective avatars) are visible/displayed from the unique viewpoint of the respective participant.

In some examples, as shown in FIG. 4G, the spatial coordinator API 462 includes an application spatial parameter determiner 468 (e.g., optionally a sub-API and/or a second function, such as an application spatial parameter API/function) that provides (e.g., defines) a spatial parameter for one or more virtual objects associated with the one or more secondary applications 470 (e.g., corresponding to or including content that is shared within the multi-user communication session) displayed by the electronic device 401. In some examples, as shown in FIG. 4G, the application spatial parameter is provided via and/or is determined using the custom template request data 465, as discussed in more detail below. In some examples, the application spatial parameter defines a location (or more generally an area or region, such as on, in, or above a physical object) at which a virtual object associated with the one or more secondary applications 470 is displayed in a shared three-dimensional environment within a multi-user communication session. For example, the application spatial parameter for (e.g., initially) anchors and/or fixes the virtual object to a respective location in the shared three-dimensional environment, which therefore determines the particular locations of the seats of the participants in the multi-user communication session, as discussed above with reference to the participant spatial parameter determiner 464. Specifically, as similarly discussed above, the seats of the participants in the multi-user communication session have a position and/or orientation offset relative to a particular portion of and/or reference associated with the virtual object in the shared three-dimensional environment. For example, the seats are determined relative to and/or are anchored to a center of the virtual object (e.g., a geometric center, a center point within a mesh or point cloud of the virtual object, etc.) or to a particular side/surface of the virtual object (e.g., a front-facing surface of the virtual objector a top or bottom edge of the virtual object). In some examples, the custom template request data 465 includes information and/or data indicating the center or other reference point associated with the virtual object (e.g., which is provided to the participant spatial parameter determiner 464 for defining the seats discussed above). Additionally, in some examples, the application spatial parameter defines an orientation of the virtual object in the shared three-dimensional environment within the multi-user communication session. For example, the orientation of the virtual object controls the portions (e.g., surfaces, segments, edges, etc.) of the virtual object (e.g., and therefore the content of the virtual object) that is visible to/displayed for the participants in the multi-user communication session from the unique viewpoints associated with their assigned seats in the respective spatial template.

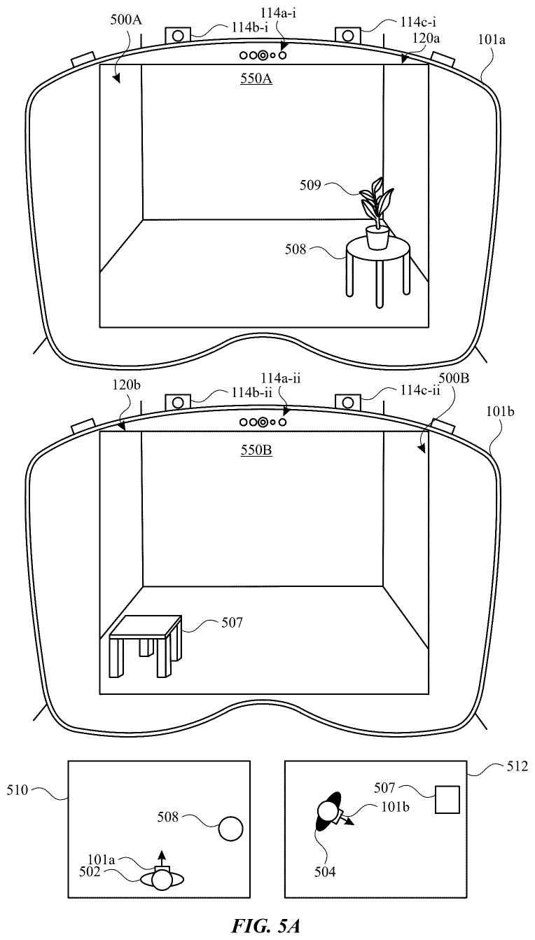

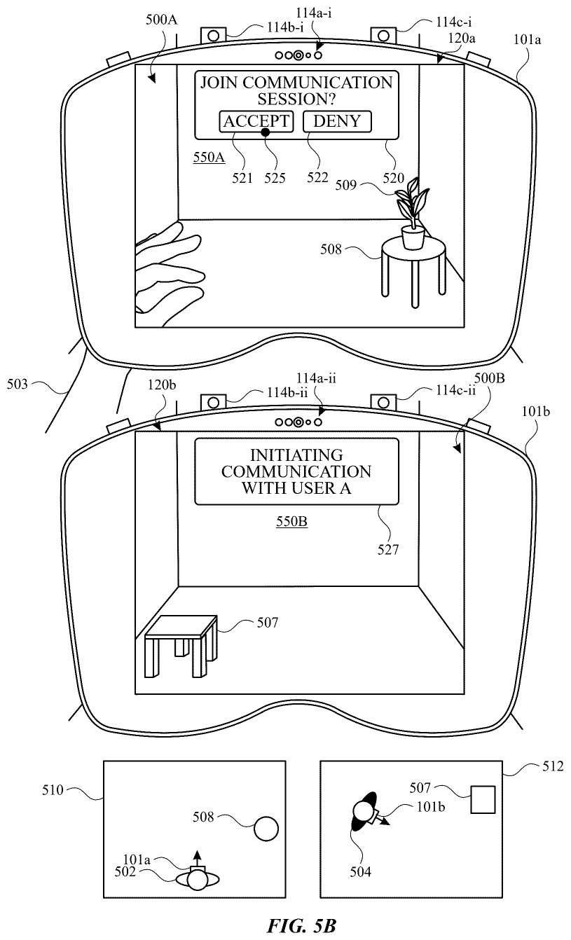

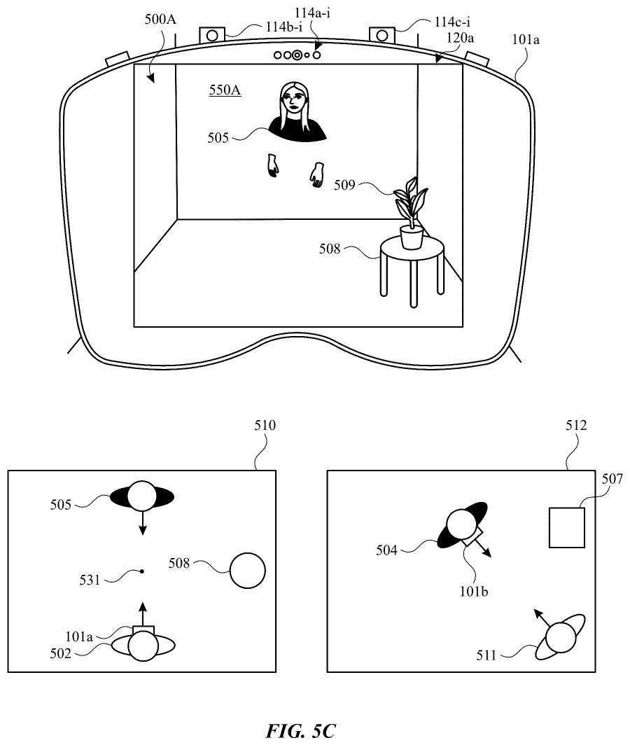

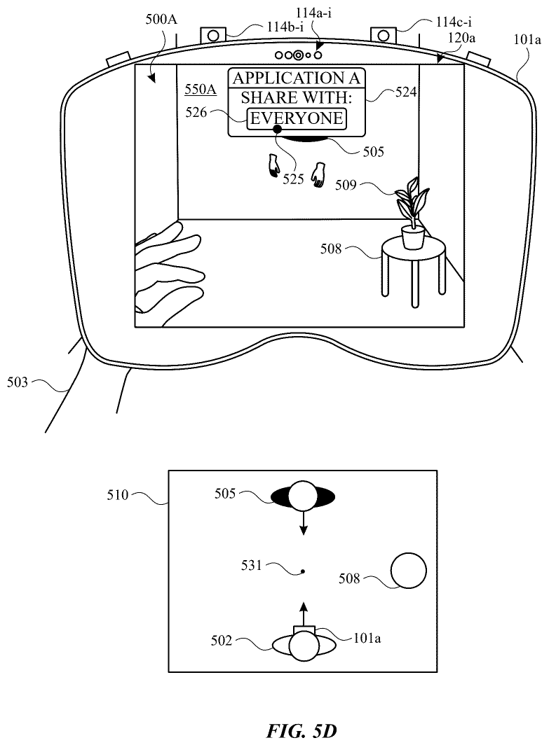

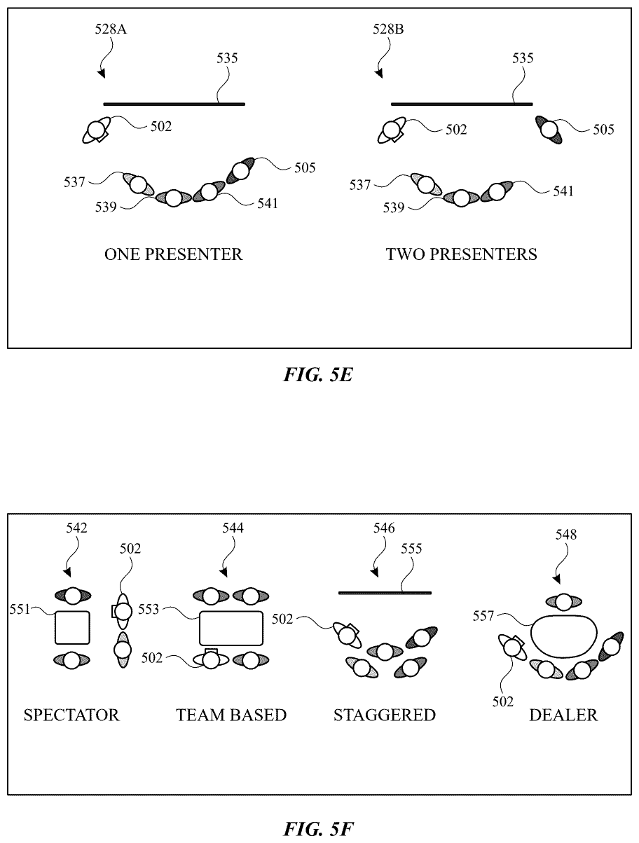

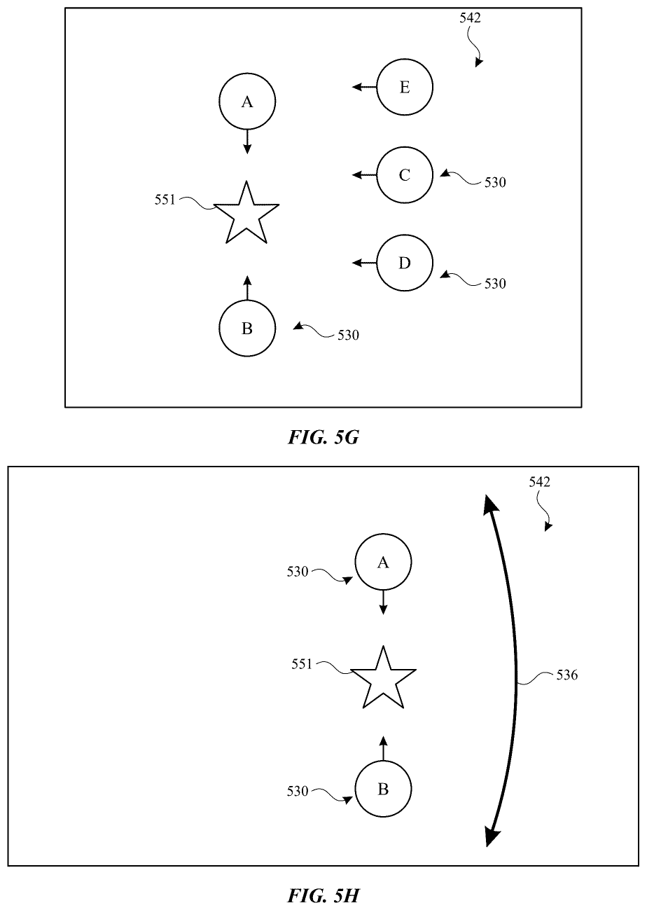

Additionally or alternatively, in some examples, the actual location at which the virtual object that is associated with the one or more secondary applications 470 may not be defined by the one or more secondary applications 470 (e.g., via the custom template request data 465). Rather, in some examples, the communication application 488 may selecta placement location for the virtual object based on a location of a user interface element (e.g., a platter or other launch screen) associated with the virtual object, such as a user interface via which the virtual object is caused to be displayed via input provided by the user (e.g., user interface element 524 in FIG. 5D discussed below), a direction in which the user of the electronic device 401 is facing when the one or more secondary applications 470 are opened, physical characteristics of the physical environment of the user, etc. For example, the custom template request data 465 may include an instruction or request to display the virtual object on a particular surface and/or object in a field of view of the user (e.g., a flat surface of a desk or table) and the communication application 488 identifies such a surface and/or object in the user's physical environment.

In some examples, as shown in FIG. 4G, the spatial coordinator API 462 includes a secondary spatial parameters determiner 472 (e.g., optionally a sub-API and/or a third function, such as a roles parameter API/function and/or a height parameter API/function) that provides (e.g., defines) one or more secondary spatial parameters for a respective spatial template. In some examples, as shown in FIG. 4G, the one or more secondary parameters are provided via and/or determined using the custom template request data 465, as discussed in more detail below. In some examples, the one or more secondary parameters include a roles parameter associated with content being shared/displayed within the multi-user communication session. In some examples, a role is assigned to each participant in the multi-user communication session. Additionally or alternatively, in some examples, a role is assigned to each seat within a respective spatial template in the multi-user communication session. In some examples, the role controls/determines the manner in which a particular participant/user interacts with and/or views the content that is being displayed in the shared three-dimensional environment. For example, as described in more detail later, the role assigned to a particular participant controls whether the participant is going to be (e.g., immediately) directly interacting with a virtual object (e.g., such as direct interaction with virtual elements of a virtual game board or virtual drawing/presentation board) or viewing the virtual object (e.g., such as from an audience/spectator position). Accordingly, in some examples, the role assigned to a respective participant controls the seat the participant occupies, and therefore the particular location and/or orientation of the participant (e.g., the avatar corresponding to the participant and/or the viewpoint of the participant) relative to the shared content in the three-dimensional environment, as discussed below. In some examples, a plurality of participants in the multi-user communication session is each assigned a different role, as discussed in more detail below. In some examples, a subset of the plurality of participants in the multi-user communication session may be assigned a same role, as discussed in more detail below. In some examples, as shown in FIG. 4G, the secondary spatial parameters determiner 472 may define the one or more secondary spatial parameters based on input data 483. In some examples, the input data 483 includes information corresponding to user input corresponding to a request to change a role assigned to a particular participant in the multi-user communication session. For example, as described in more detail below, the input data 483 may include information indicating that the user has provided input for vacating a particular seat assigned to a particular role and/or has left the multi-user communication session, thereby vacating the seat previously occupied by that user and the role previously assigned to that user, which optionally causes the secondary spatial parameters determiner 472 to reassign the vacated role and/or seat. It should be understood that the provision/inclusion of the secondary spatial parameters determiner 472 is optional and that, in some examples, the spatial coordinator API 462 does not include and/or does not operate/utilize the secondary spatial parameters determiner 472.

Additionally or alternatively, in some examples, the one or more secondary spatial parameters provided by the secondary spatial parameters determiner 472 discussed above may include a height offset parameter associated with one or more participants in the multi-user communication session. For example, the custom template request data 465 discussed above may include an indication of a particular height offset at which a particular participant (e.g., an avatar corresponding to the participant and/or the viewpoint of an electronic device associated with the participant) is relative to the content (e.g., a respective virtual object) in the shared three-dimensional environment. As an example, as discussed in more detail below, the height offset provided by the secondary spatial parameters determiner 472 causes an avatar corresponding to a respective participant to appear elevated (optionally atop a virtual surface or object, such as a virtual stage) relative to a surface (e.g., a ground of the three-dimensional environment, such as a physical or virtual ground in the three-dimensional environment, or other physical or virtual surface) in the shared three-dimensional environment relative to the viewpoint of the electronic device 401 while in the multi-user communication session. In some examples, a height offset may be assigned and/or attributed to particular participants in the multi-user communication session based on the particular role(s) assigned to the participants, as similarly discussed above. In some examples, as described in more detail below, the height offset is assigned and/or attributed to participants in the multi-user communication session based on whether the content includes and/or is associated with an immersive environment (e.g., a virtual environment or scene) in the shared three-dimensional environment. Additionally or alternatively, in some examples, the one or more secondary spatial parameters provided by the secondary spatial parameters determiner 472 discussed above may include a seat priority parameter associated with the content being shared in the multi-user communication session (e.g., the content associated with the one or more secondary applications 470 in FIG. 4G). For example, the custom template request data 465 discussed above may include an indication of a particular order in which participants (e.g., an avatar corresponding to the participant and/or the viewpoint of an electronic device associated with the participant) are assigned to and/or positioned within seats (e.g., such as the seats described above) associated with the content (e.g., a respective virtual object) in the shared three-dimensional environment. As an example, as discussed in more detail below, the seat priority parameter provided by the secondary spatial parameters determiner 472 causes an avatar corresponding to a respective participant to be displayed at a first position/location (e.g., corresponding to a first seat having a first priority) in the shared three-dimensional environment relative to the shared virtual object associated with the one or more secondary application 470 rather than at a second position/location (e.g., corresponding to a second seat having a lower priority than the first seat) in the shared three-dimensional environment relative to the shared virtual object while in the multi-user communication session. In some examples, a seat priority parameter may be assigned and/or attributed to the participants in the multi-user communication session based on the particular role(s) assigned to the participants, as similarly discussed above, and/or based on an order in which the participants join and/or have joined the multi-user communication session.

In some examples, as shown in FIG. 4G, the spatial coordinator API 462 outputs (e.g., transmits) template data 463A to spatial template determiner 460. In some examples, the template data 463A includes information and/or data indicating a respective custom spatial template formulated according to the custom template request data 465 provided by the one or more secondary applications 470. In some examples, as outlined above, a spatial template controls and/or determines a spatial arrangement of the participants in the multi-user communication session (optionally positioned according to a plurality of seats) relative to shared content (e.g., one or more virtual objects) in a shared three-dimensional environment. For example, as described in more detail below, when a shared activity that includes one or more virtual objects is launched in a three-dimensional environment within a multi-user communication session, a viewpoint of a user of the electronic device 401 and avatars corresponding to the other participants/users in the multi-user communication session are positioned at unique locations and/or with unique orientations relative to the one or more virtual objects in the three-dimensional environment according to the spatial template. In some examples, as discussed below, each application of the one or more secondary applications 470 and/or each virtual object associated with the one or more secondary applications 470 includes and/or is associated with a set of one or more custom spatial templates formulated by the spatial coordinator API 462 according to the custom template request data 465 as discussed above. Additionally, in some examples, the template data 463A is stored (e.g., in memory at the electronic device 401 and/or in cloud storage of a server) after being generated by the spatial coordinator API 462, such that a respective custom spatial template defined by the template data 463A may be easily accessed by the electronic device 401 for future use, such as within system templates service 461 discussed below.

In some examples, as shown in FIG. 4G, the communication application 488 includes the system templates service 461 mentioned above. In some examples, the system templates service 461 corresponds to a sub-application or a sub-function configured to access a memory of the electronic device 401 and/or a cloud storage of a server (e.g., a wireless communications terminal in communication with the electronic device 401) storing a set of system (e.g., default or predefined) spatial templates. In some examples, as shown in FIG. 4G, the system templates service 461 is configured to output (e.g., transmit) template data 463B to the spatial template determiner 460. In some examples, the template data 463B includes information and/or data indicating a respective system spatial template formulated or otherwise stored by the electronic device 401 (e.g., by an application running on the electronic device, such as the communication application 488) or a respective custom spatial template previously formulated by the spatial coordinator API 462 (e.g., according to the custom template request data 465), as previously discussed above. In some examples, as previously discussed above, a spatial template controls and/or determines a spatial arrangement of the participants in the multi-user communication session (optionally positioned according to a plurality of seats) relative to shared content (e.g., one or more virtual objects) in a shared three-dimensional environment.

In some examples, the spatial template determiner 460 utilizes the template data 463A (e.g., provided by the spatial coordinator API 462) and/or the template data 463B (e.g., provided by the system templates service 461) to generate spatial template display data 467. In some examples, the spatial template determiner 460 corresponds to a sub-application or a sub-function of the communication application 488. In some examples, the spatial template display data 467 includes information identifying the selected spatial template (e.g., a custom spatial template or a system spatial template) according to which the virtual elements of the shared three-dimensional environment are to be arranged within the multi-user communication session. For example, the spatial template determiner 460 is configured to select the particular spatial template based on input data (e.g., user input data 481), application data provided by the one or more secondary applications 470 (e.g., via custom template request data 465), and/or other signal or directive provided by the communication application 488. As an example, as discussed in more detail below, the user input data 481, which is provided for launching the one or more secondary applications 470 and/or for causing display of (e.g., sharing) content associated with the one or more secondary applications 470 in a multi-user communication session, directly or indirectly triggers the one or more secondary applications 470 to transmit the custom template request data 465 to the communication application 488 (e.g., which is received by the spatial coordinator API 462 as discussed above). In such an instance, upon receiving the template data 463A from the spatial coordinator API 462, the spatial template determiner 460 selects the custom spatial template encoded in the template data 463A for transmitting the spatial template display data 467 to the scene integration service 466, rather than a system spatial template encoded in the template data 463B (e.g., received from the system templates service 461). As an alternative example, if an application, such as an application of the one or more secondary applications 470, is launched (e.g., in response to the user input data 481) that does not transmit the custom template request data 465 (e.g., because the content of the application is not associated with a custom spatial template) or if the multi-user communication session is initiated without launching an application of the one or more secondary applications 470, the spatial template determiner 460 selects a system spatial template encoded in the template data 463B for transmitting the spatial template display data 467 to the scene integration service 466.

In some examples, as shown in FIG. 4G and as mentioned above, the spatial template display data 467 may be received by the scene integration service 466 of the communication application 488. In some examples, the scene integration service 466 generates display data 487 in accordance with the formulated spatial template discussed above included in the spatial template display data 467. In some examples, the display data 487 that is generated by the scene integration service 466 includes commands/instructions for displaying one or more virtual objects and/or avatars in the shared three-dimensional environment within the multi-user communication session. For example, the display data 487 includes information regarding an appearance of virtual objects displayed by the electronic device 401 in the shared three-dimensional environment (e.g., generated based on the application data 471), locations at which virtual objects are displayed by the electronic device 401 in the shared three-dimensional environment, locations at which avatars (or two-dimensional representations of users) are displayed by the electronic device 401 in the shared three-dimensional environment (e.g., according to the selected spatial template), and/or other features/characteristics of the shared three-dimensional environment. In some examples, the display data 487 is transmitted from the communication application 488 to the operating system of the electronic device 401 for display at one or more displays in communication with the electronic device 401, as similarly shown in FIG. 3.

In some examples, as illustrated in the examples described below, the spatial template display data 467 is configured to be updated by the spatial template determiner 460, which optionally thus causes the spatial template in which the content and/or participants in the multi-user communication session are arranged. For example, as discussed above, when the multi-user communication session is first initialized, content associated with an application has not (e.g., yet) been shared in the multi-user communication session and/or the content of the application is not associated with a custom spatial template, which causes the spatial template determiner 460 to assign a particular system spatial template using the template data 463B. However, in some examples, while the user of the electronic device 401 and one or more participants/users are in the multi-user communication session, content from an application of the one or more secondary applications 470 may be launched (e.g., an application that is different from an application currently displaying content at the electronic device 401) as discussed above, causing the spatial coordinator API 462 to receive the custom template request data 465 from the one or more secondary applications 470. In this instance, the spatial template determiner 460 updates the spatial template display data 467 to include information corresponding to a custom spatial template defined by the template data 463A (e.g., which is formulated by the spatial coordinator API 462, as discussed above). In some examples, when the spatial template display data 467 is updated and transmitted to the scene integration service 466, the display data 487 is optionally updated by the scene integration service 466, which causes the viewpoint of the electronic device 401 and the avatars corresponding to the participants in the multi-user communication session and/or virtual objects associated with the one or more secondary applications 470 to be arranged according to an updated spatial arrangement (e.g., the custom spatial template above) in the shared three-dimensional environment.

Communication application 488 is not limited to the components and configuration of FIG. 4G, but can include fewer, other, or additional components in multiple configurations. Additionally, the processes described above are exemplary and it should therefore be understood that more, fewer, or different operations can be performed using the above components and/or using fewer, other, or additional components in multiple configurations. Attention is now directed to exemplary interactions illustrating the above-described operations of the communication application 488 within a multi-user communication session.

FIGS. 5A-5I illustrate example interactions within a multi-user communication session according to some examples of the disclosure. In some examples, as shown in FIG. 5A, three-dimensional environment 550A is presented using a first electronic device 101a (e.g., via display 120a) and three-dimensional environment 550B is presented using a second electronic device 101b (e.g., via display 120b). In some examples, the electronic devices 101a/101b optionally correspond to or are similar to electronic device 401 discussed above, electronic devices 360/370 in FIG. 3, and/or electronic devices 260/270 in FIG. 2. In some examples, as shown in FIG. 5A, the first electronic device 101a is being used by (e.g., worn on a head of) a first user 502 as illustrated in overhead view 510, and the second electronic device 101b is being used by (e.g., worn on a head of) a second user 504 as illustrated in overhead view 512.

In FIG. 5A, as indicated in the overhead views 510 and 512, the first electronic device 101a and the second electronic device 101b are located in different physical environments, such as physical environment 500A and physical environment 500B, respectively. For example, as shown in FIG. 5A, the first electronic device 101a is located in a first room that includes stand 508 and houseplant 509, and the second electronic device 101b is located in a second room, different from the first room, which includes coffee table 507.

In some examples, the three-dimensional environments 550A/550B include captured portions of the physical environments 500A/500B in which the electronic devices 101a/101b are located. For example, as shown in FIG. 5A, the three-dimensional environment 550A includes the stand 508 and the houseplant 509 (e.g., a representation of the stand and a representation of the houseplant), and the three-dimensional environments 550B includes the coffee table 507 (e.g., a representation of the coffee table) from the viewpoints of the first electronic device 101a and the second electronic device 101b, respectively. In some examples, the representations can include portions of the physical environments 500A/500B viewed through a transparent or translucent display of the electronic devices 101a and 101b. In some examples, the three-dimensional environments 550A/550B have one or more characteristics of the three-dimensional environments 350A/350B described above with reference to FIG. 3.

From FIG. 5A to FIG. 5B, the first electronic device 101a detects an indication of a request to enter a multi-user communication session with the second electronic device 101b. For example, as shown in FIG. 5B, the first electronic device 101a receives an invitation to join a multi-user communication session from the second electronic device 101b (e.g., or from a server in communication with the first electronic device 101a and the second electronic device 101b), causing the first electronic device 101a to display message element 520 (e.g., a notification) corresponding to the request to join the multi-user communication session with the second electronic device 101b. In some examples, as shown in FIG. 5B, the message element 520 includes a first option 521 that is selectable to accept the request (e.g., and join the multi-user communication session with the second electronic device 101b) and a second option 522 that is selectable to deny the request (e.g., and forgo joining the multi-user communication session with the second electronic device 101b). In some examples, the second electronic device 101b transmits the invitation to the first electronic device 101a in response to detecting input provided by the second user 504 for initiating the multi-user communication session with the first electronic device 101a (e.g., and thus the first user 502). For example, the second electronic device 101b detects the second user 504 initiate a real-time communication session (e.g., a call) with the first user 502 via a communications application running on the second electronic device 101b (e.g., a phone or video calling or conferencing application), as indicated by message element 527 displayed in the three-dimensional environment 550B.

In FIG. 5B, the first electronic device 101a detects one or more inputs accepting the request to join the multi-user communication session with the second electronic device 101b. For example, as shown in FIG. 5B, the first electronic device 101a detects a selection of the first option 521 in the message element 520 in the three-dimensional environment 550A. As an example, the first electronic device 101a detects an air pinch gesture provided by hand 503 of the first user 502 directed to the first option 521. For example, as shown in FIG. 5B, the first electronic device 101a detects a pinch performed by the hand 503 of the first user 502, optionally while a gaze of the first user 502 (e.g., gaze point 525) is directed to the first option 521. It should be understood that additional or alternative inputs are possible, such as air tap gestures, gaze and dwell inputs, verbal commands, etc.

In some examples, as shown in FIG. 5C, in response to detecting the input accepting the request to join the multi-user communication session with the second electronic device 101b, the first electronic device 101a and the second electronic device 101b present an avatar (or other virtual (e.g., three-dimensional) representation) corresponding to the users of the first electronic device 101a and the second electronic device 101b in the three-dimensional environments 550A and 550B, indicative of entering the multi-user communication session. For example, as shown in FIG. 5C, the first electronic device 101a displays an avatar 505 corresponding to the second user 504 in the three-dimensional environment 550A, as shown in the overhead view 510. Similarly, as shown in the overhead view 512 in FIG. 5C, the second electronic device 101b displays an avatar 511 corresponding to the first user 502 in the three-dimensional environment 550B. In some examples, the avatars 505/511 have one or more characteristics of the avatars 315/317 described above with reference to FIG. 3. In some examples, as discussed herein, the multi-user communication session that includes the first electronic device 101a and the second electronic device 101b is facilitated by the communication application 488 of FIG. 4G.

In some examples, as similarly discussed above with reference to FIG. 4G, when the avatar 505 corresponding to the second user 504 is displayed in the three-dimensional environment 550A (and when the avatar 511 corresponding to the first user 502 is displayed in the three-dimensional environment 550B), the avatar 505 is positioned at a location in the three-dimensional environment 550A relative to the viewpoint of the first electronic device 101a according to a respective spatial template. Particularly, in some examples, as shown in the overhead view 510 (and the overhead view 512), the viewpoint of the first electronic device 101a (e.g., the first user 502) and the avatar 505 are arranged in a first spatial arrangement in the three-dimensional environment 550A. For example, as indicated in the overhead view 510 in FIG. 5C, the first electronic device 101a occupies a first location (e.g., a first seat w ithin the spatial template) and/or has a first orientation relative to shared origin 531 (e.g., a reference point according to which content and other virtual object are displayed in the multi-user communication session) and the avatar 505 is positioned at a second location (e.g., a second seat within the spatial template) and/or with a second orientation relative to the shared origin 531. In some examples, the first spatial arrangement of the viewpoint of the first electronic device 101a and the avatar 505 (e.g., and of the viewpoint of the second electronic device 101b and the avatar 511) corresponds to a default (e.g., computer-selected) arrangement defined by a system spatial template (e.g., a conversation spatial template). For example, as previously discussed above with reference to FIG. 4G, the first spatial arrangement of the viewpoint of the first electronic device 101a and the avatar 505 (e.g., and of the viewpoint of the second electronic device 101b and the avatar 511) is defined by (e.g., encoded in the spatial template display data 467 output by) the spatial template determiner 460 using the template data 463B (e.g., from the system templates service 461). In some examples, as previously mentioned above with reference to FIG. 4G, the first electronic device 101a and the second electronic device 101b utilize the system spatial template (e.g., the conversation spatial template) illustrated in the overhead views 510 and 512 because content (e.g., shared content) is not currently and/or has not yet been displayed in the three-dimensional environments 550A/550B within the multi-user communication session.

In FIG. 5D, while the first electronic device 101a is in the multi-user communication session with the second electronic device 101b, the first electronic device 101a (e.g., or the second electronic device 101b) detects an input corresponding to a request to display shared content in the shared three-dimensional environment. For example, as shown in FIG. 5D, the first electronic device 101a is optionally displaying user interface element 524 that is associated with a respective application (e.g., application A) running on the first electronic device 101a. In some examples, the user interface element 524 includes one or more selectable options for sharing content (e.g., image or video-based content, a user interface, audio content, etc.) in the multi-user communication session. For example, as shown in FIG. 5D, the user interface element 524 includes selectable option 526 that is selectable to share respective content from application A with all participants in the multi-user communication session (e.g., Everyone), including the second user 504.

In some examples, as shown in FIG. 5D, while displaying the user interface element 524, the first electronic device 101a detects a selection of the selectable option 526 provided by the first user 502. For example, in FIG. 5D, the first electronic device 101a detects the hand 503 of the first user 502 perform an air pinch gesture, optionally while the gaze point 525 of the first user 502 is directed to the selectable option 526 in the three-dimensional environment 550A.

In some examples, when content is shared in the multi-user communication session, the spatial arrangement of the participants in the multi-user communication session is updated based on the content being shared (e.g., the particular content item and/or the type of content). For example, as similarly discussed above with reference to FIG. 4G, the spatial template currently assigned to the participants in the multi-user communication session is updated, such as updated to a custom spatial template or a different system spatial template (e.g., different from the spatial template illustrated in the overhead view 510 in FIG. 5D).

In some examples, in accordance with a determination that the content being shared in the multi-user communication session is or includes a presentation, the first electronic device 101a and the second electronic device 101b utilize a presenter spatial template, such as the presenter spatial templates 528A/528B in FIG. 5E. In some examples, as illustrated in FIG. 5E, arranging participants in the multi-user communication session according to one of the presenter spatial templates 528A/528B includes positioning the viewpoints and/or avatars corresponding to the participants at a plurality of seats relative to virtual object 535. For example, in the presenter spatial template 528A, the first user 502 (e.g., the viewpoint of the first electronic device 101a) is positioned at a first seat (e.g., a first spatial location) positioned in front of the virtual object 535 (e.g., a virtual window that includes or corresponds to a presentation (e.g., a slideshow that includes two-dimensional content)) and oriented away from the virtual object 535 (e.g., such that the viewpoint of the first electronic device 101a is directed away from the virtual object 535). Additionally, in the presenter spatial template 528A, the other participants in the multi-user communication session (e.g., including the second user 504 of the second electronic device 101b) are positioned at one or more second seats (e.g., one or more second spatial locations) positioned in front of the virtual object 535 and oriented toward the virtual object 535 (e.g., such that the participants are viewing the content of the virtual object 535). For example, the participants represented by avatars 537/539/541/505 are positioned at a plurality of seats forming an arc centered on and facing toward the front-facing surface of the virtual object 535, as shown in FIG. 5E.

As another example, in the presenter spatial template 528B in FIG. 5E, the first user 502 (e.g., the viewpoint of the first electronic device 101a) is positioned at a first seat (e.g., a first spatial location) positioned in front of the virtual object 535 and oriented away from the virtual object 535 (e.g., such that the viewpoint of the first electronic device 101a is directed away from the virtual object 535), and the second user (e.g., the avatar 505 corresponding to the second user 504) is positioned at a second seat (e.g., a second spatial location) positioned in front of the virtual object 535 (e.g., at an opposite end of the virtual object 535 from the first user 502) and oriented away from the virtual object 535. Additionally, in the presenter spatial template 528B, the other participants in the multi-user communication session are positioned at one or more third seats (e.g., one or more third spatial locations) positioned in front of the virtual object 535 and oriented toward the virtual object 535 (e.g., such that the participants are viewing the content of the virtual object 535). For example, the participants represented by the avatars 537/539/541 are positioned at a plurality of seats forming an arc centered on and facing toward the front-facing surface of the virtual object 535, as shown in FIG. 5E. In the example of FIG. 5E, the presenter spatial templates 528A/528B are illustrated from the perspective of the first user 502 (e.g., and thus the first electronic device 101a); however, it should be understood that, in some examples, the presenter spatial templates 528A/528B are similarly provided from the perspective of the second user 504 (e.g., and thus the second electronic device 101b), such as by substituting the avatar 505 with the second user 504 and substituting the first user 502 with the avatar 511 discussed previously above.

In some examples, the presenter spatial templates 528A/528B correspond to system spatial templates stored at the first electronic device 101a and the second electronic device 101b. For example, as similarly discussed above with reference to FIG. 4G, the presenter spatial templates 528A/528B are stored in memory or cloud storage and accessible by the system templates service 461. In some examples, with reference to FIG. 4G, when the first electronic device 101a detects the input provided by the first user 502 for sharing the presentation content in the multi-user communication session, the communication application 488 operates and/or directs the system templates service 461 to select one of the presenter spatial templates 528A/528B according to which to arrange (e.g., to position and/or orient) the presentation content (e.g., the virtual object 535) and the participants in the multi-user communication session (e.g., the first user 502 and the avatar 505 corresponding to the second user 504) in the shared three-dimensional environment. In some examples, as previously discussed above with reference to FIG. 4G, the scene integration service 466 receives updated spatial template display data 467 that is encoded with one of the presenter spatial templates 528A/528B from the spatial template determiner 460.

Alternatively, in some examples, the presenter spatial templates 528A/528B correspond to custom spatial templates formulated according to data provided by the application associated with the presentation content (e.g., application A in FIG. 5D). In some examples, as similarly discussed above with reference to FIG. 4G, when the presentation content is shared in the multi-user communication session, the application associated with the presentation content (e.g., one of the one or more secondary applications 470) transmits data (e.g., custom template request data 465) to the communication application 488 and the data is received by the spatial coordinator API 462. In some examples, with reference to FIG. 4G, one of the presenter spatial templates 528A/528B is formulated by the spatial coordinator API 462 (e.g., according to the specific parameters of the custom template request data 465) and provided to the spatial template determiner 460 (e.g., via the template data 463A), which is then encoded in the spatial template display data 467 and provided to the scene integration service 466 as similarly discussed above.

In some examples, in addition to the presenter spatial templates 528A/528B including a plurality of seats according to which the virtual object 535 and the participants in the multi-user communication session are arranged in the shared three-dimensional environment, the presenter spatial templates 528A/528B include an indication of one or more roles assigned to the plurality of seats. For example, as indicated in FIG. 5E, the presenter spatial template 528A includes a single presenter role and a plurality of audience roles. In some examples, the presenter role is associated with the first seat discussed above that is positioned in front of the virtual object 535, which is currently occupied by the first user 502 in the example of FIG. 5E. Additionally, as shown in FIG. 5E, in the presenter spatial template 528A, the plurality of audience roles is associated with the second seats that are arranged in an arc centered on and facing toward the virtual object 535, which are optionally occupied by the avatars 537/539/541/505. Accordingly, in the example of FIG. 5E, the first user 502 is assigned the presenter role (e.g., which causes the first user 502 to be positioned at the first seat) and the participants represented by the avatars 537/539/541/505 are assigned the audience roles (e.g., which causes those participants, including the second user 504, to be positioned at the second seats) in the presenter spatial template 528A.

Alternatively, as indicated in FIG. 5E, the presenter spatial template 528B includes two presenter roles and a plurality of audience roles. In some examples, a first presenter role is associated with the first seat and a second presenter role is associated with the second seat discussed above that are positioned in front of the virtual object 535, which are currently occupied by the first user 502 and the second user (e.g., via avatar 505), respectively, in the example of FIG. 5E. Additionally, as shown in FIG. 5E, in the presenter spatial template 528B, the plurality of audience roles is associated with the third seats that are arranged in an arc centered on and facing toward the virtual object 535, which are optionally occupied by the avatars 537/539/541. Accordingly, in the example of FIG. 5E, the first user 502 is assigned the first presenter role (e.g., which causes the first user 502 to be positioned at the first seat), the second user is assigned the second presenter role (e.g., which causes the avatar 505 to be positioned at the second seat), and the participants represented by the avatars 537/539/541 are assigned the audience roles (e.g., which causes those participants to be positioned at the third seats) in the presenter spatial template 528B.

In some examples, the particular role assigned to each participant in the multi-user communication session is determined according to the custom template request data 465 in FIG. 4G based on user input. For example, with reference to FIG. 4G, the spatial coordinator API 462 assigns (e.g., using the secondary spatial parameters determiner 472) the presenter role(s) and the audience role(s) in the presenter spatial templates 528A/528B based on the user input data 481 that is optionally received by the one or more secondary applications 470, including the application associated with the presentation content (e.g., the virtual object 535). In some examples, in FIG. 5D, because the first user 502 of the first electronic device 101a provides the input for sharing the presentation content with the other participants in the multi-user communication session, including the second user 504 of the second electronic device 101b, the first user 502 is assigned the presenter role within the presenter spatial template 528A or 528B. Accordingly, as discussed above and as illustrated in FIG. 5E, the first user 502 (e.g., the viewpoint of the first electronic device 101a) is positioned in the presenter seat (e.g., the first seat) in the presenter spatial template 528A or 528B that is spatially located in front of and oriented away from the virtual object 535. In some examples, by default and/or in accordance with the custom template request data 465 in FIG. 4G, the spatial coordinator API 462 assigns the other participants, including the second user 504 (e.g., represented by the avatar 505) in the multi-user communication session the audience roles, as previously discussed above and as illustrated in FIG. 5E, such that the other participants are positioned in the audience seats in the presenter spatial template 528A (or 528B). It should be understood that, in some examples, if the second user 504 alternatively provides the input for sharing the presentation content with the other participants in the multi-user communication session, the second user 504 (e.g., the viewpoint of the second user 504, optionally corresponding to the avatar 505) is positioned in the presenter seat (e.g., the first seat) in the presenter spatial template 528A or 528B.

As discussed above, in some examples, the presenter spatial template 528B includes two presenter seats. Accordingly, as illustrated in FIG. 5E, because the first user 502 and the second user 504 (e.g., represented by the avatar 505) are positioned in the presenter seats, the first user 502 and the second user 504 have both been assigned the same role in the presenter spatial template 528B (e.g., the presenter role). In some examples, as similarly discussed above, the first user 502 is assigned the first presenter role in the presenter spatial template 528B because the first user 502 provides the input in FIG. 5D for sharing the presentation content (e.g., the virtual object 535) with the other participants in the multi-user communication session. In some examples, the second user 504 is assigned the second presenter role in the presenter spatial template 528B based on the custom template request data 465 provided by the application associated with the presentation content (e.g., included in the one or more secondary applications 470) in FIG. 4G, which is performed by the secondary spatial parameters determiner 472 as previously discussed above. Attention is now directed to additional and/or alternative examples (e.g., illustrations) of custom spatial templates that are able to be used in multi-user communication sessions.

FIG. 5F illustrates a plurality of example custom spatial templates formulated by the spatial coordinator API 462 of FIG. 4G based on the custom template request data 465 provided by the one or more secondary applications 470. For example, as shown in FIG. 5F, a first custom spatial template 542 (e.g., spectator spatial template) includes a designation of a position and/or orientation of virtual object 551 and a plurality of seats of a plurality of participants relative to the position of the virtual object 551. In some examples, as shown in FIG. 5F, in the first custom spatial template 542, as discussed in more detail below with reference to FIG. 5G, a pair of player seats is defined on opposite sides of the virtual object 551 (e.g., corresponding to a virtual board game, such as a virtual game of chess or checkers) and a plurality of spectator seats is defined to a first side (e.g., right side) of the virtual object 551. For example, as shown in FIG. 5F, a first participant and a second participant are assigned the player roles in the first custom spatial template 542, causing the first participant and the second participant to be positioned in the player seats in the first custom spatial template 542 (e.g., facing toward the virtual object 551 and the other participant). Additionally, in some examples, as shown in FIG. 5F, the other participants in the multi-user communication session, including the first user 502, are assigned the spectator roles in the first custom spatial template 542, causing the other participants, including the first user 502, to be positioned in the spectator seats in the first custom spatial template 542 (e.g., facing toward the first side of the virtual object 551 and the first and second participants). In some examples, as alluded to above, the first custom spatial template 542 may be utilized when a virtual gaming application that includes two opposing player roles is launched in the multi-user communication session, such as a virtual game of chess, checkers, etc.

In some examples, as shown in FIG. 5F, a second custom spatial template 544 (e.g., team-based spatial template) includes a designation of a position and/or orientation of virtual object 553 and a plurality of seats of a plurality of participants relative to the position of the virtual object 553. In some examples, as shown in FIG. 5F, in the second custom spatial template 544, a set of player seats is defined on opposite sides of the virtual object 553 (e.g., corresponding to a virtual board game). Additionally, in some examples, the set of player seats may be organized into pairs of seats associated with opposing teams. For example, as shown in FIG. 5F, a first participant and a second participant are assigned player roles for a first team in the second custom spatial template 544, causing the first participant and the second participant to be positioned in the player seats along a first side (e.g., a top side) of the virtual object 553 in the second custom spatial template 544. Additionally, in some examples, as shown in FIG. 5F, the first user 502 and a third participant are assigned player roles for a second team in the second custom spatial template 544, causing the first user 502 (e.g., the viewpoint of the first electronic device 101a) and the third participant to be positioned in the player seats along a second side of the virtual object 553 (e.g., opposite the first participant and the second participant along the first side of the virtual object 553). In some examples, as alluded to above, the second custom spatial template 544 may be utilized when a virtual gaming application that includes two opposing teams consisting of a plurality of player roles is launched in the multi-user communication session.

As another example, as shown in FIG. 5F, a third custom spatial template 546 (e.g., staggered spatial template) includes a designation of a position and/or orientation of virtual object 555 and a plurality of seats of a plurality of participants relative to the position of the virtual object 555. In some examples, as shown in FIG. 5F, in the third custom spatial template 546, a plurality of audience seats is defined in front of and oriented toward a surface of the virtual object 555 (e.g., corresponding to a virtual window including content, such as image or video-based content or other user interface). For example, as shown in FIG. 5F, a plurality of participants, including the first user 502, are assigned audience roles in the third custom spatial template 546, causing the plurality of participants, including the first user 502 (e.g., the viewpoint of the first electronic device 101a), to be positioned in the plurality of audience seats facing toward the front surface of the virtual object 555 (e.g., the surface on which the content is displayed in the shared three-dimensional environment). In some examples, as alluded to above, the third custom spatial template 546 may be utilized when a virtual application window including content is launched in the multi-user communication session, such as a virtual media player window displaying a movie or episode of a television show, a user interface of a web-browser displaying video, image, or text-based content, a music player application including visual media, and the like.

In some examples, as shown in FIG. 5F, a fourth custom spatial template 548 (e.g., dealer spatial template) includes a designation of a position and/or orientation of virtual object 557 and a plurality of seats of a plurality of participants relative to the position of the virtual object 557. In some examples, as shown in FIG. 5F, in the fourth custom spatial template 548, a set of player seats is defined along a first side of the virtual object 557 (e.g., corresponding to a virtual card table) opposite a dealer seat that is defined at a second side of the virtual object 557. For example, as shown in FIG. 5F, a first participant is assigned a dealer role in the fourth custom spatial template 548, causing the first participant to be positioned in the dealer seat at the second side of the virtual object 557 (e.g., at the head of the virtual card table), and the other participants in the multi-user communication session, including the first user 502, are assigned player roles in the fourth custom spatial template 548, causing the other participants, including the first user 502 (e.g., the viewpoint of the first electronic device 101a), to be positioned in the player seats along the first side of the virtual object 557 in the fourth custom spatial template 548. In some examples, as alluded to above, the fourth custom spatial template 548 may be utilized when a virtual card game application that includes a card dealer is launched in the multi-user communication session, such as a virtual game of poker, blackjack, etc.

In some examples, as discussed above, a respective custom spatial template includes a plurality of seats that are defined relative to a position of the content being shared in the multi-user communication session. For example, as shown in FIG. 5G, in the first custom spatial template 542 discussed above (e.g., the spectator spatial template), a plurality of seats 530 is defined relative to a respective portion of the virtual object 551 (e.g., the virtual board game). For example, the plurality of seats 530 is defined relative to a center (e.g., a geometric center and/or a center point) of the virtual object 551. Particularly, as similarly discussed above with reference to FIG. 4G, each seat of the plurality of seats 530 has a position and an orientation offset that is defined relative to the center of the virtual object 551. As an example, in the first custom spatial template 542 in FIG. 5G, seats A and B are positioned at opposite sides/ends of the virtual object 551 (e.g., at a same distance from the center of the virtual object 551), and have opposing orientations, such that a participant positioned in seat A is oriented to face toward a second participant positioned in seat B relative to the center of the virtual object 551. Additionally, in some examples, as shown in FIG. 5G, in the first custom spatial template 542 in FIG. 5G, seats C, D, and E are positioned along a side of the virtual object 551 (e.g., offset from a right side of the virtual object 551) and have the same orientation, such that participants positioned in seats C, D, and E are oriented to face toward the side of the virtual object 551 and/or the participants positioned in seats A and B. Alternatively, in some examples, the respective portion of the virtual object 551 according to which the position and/or orientation offsets of the plurality of seats 530 are defined corresponds to an edge/side of the virtual object 551, such as the right edge/side of the virtual object 551 in FIG. 5G.

Additionally or alternatively, in some examples, a respective custom spatial template includes a seat pattern according to which one or more participants in the multi-user communication session are arranged. For example, as shown in FIG. 5H, in the first custom spatial template 542 discussed above, the seats C, D, and E that are positioned to the right side of the virtual object 551 are replaced with seat pattern 536. In some examples, as shown in FIG. 5H, the seat pattern 536 corresponds to a region or zone having a particular shape, such as the arc shape illustrated in the first custom spatial template 542, though other shapes are possible, such as a linear shape or a zig-zag shape. In the example of FIG. 5H, rather than participants being positioned and/or oriented according to individual seats in the first custom spatial template 542, such as the seats C, D, and E in FIG. 5G, the participants are positioned and/or oriented according to the seat pattern 536. For example, in FIG. 5H, the participants are positioned along the arc defined by the seat pattern 536 and are oriented in a direction orthogonal to the arc defined by the seat pattern 536 (e.g., such that, as similarly discussed above with reference to FIG. 5G, the participants are oriented to face toward the side of the virtual object 551 and/or the participants positioned in seats A and B) in the first custom spatial template 542. It should be understood that the discussion of the plurality of seats 530 and/or the seat pattern 536 in the first custom spatial template 542 similarly applies to any and/or all other custom spatial templates, such as the custom spatial templates 544-548 in FIG. 5F and/or the presenter spatial templates 528A/528B in FIG. 5E.

In some examples, after and/or when a particular spatial template is selected/determined (e.g., by the spatial template determiner 460 of the communication application 488 in FIG. 4G), the first electronic device 101a (e.g., and the second electronic device 101b) updates display of the three-dimensional environment 550A (e.g., and the three-dimensional environment 550B) according to the selected/determined spatial template (e.g., a system spatial template or a custom spatial template as discussed above). For example, as shown in FIG. 5I, the presenter spatial template 528A of FIG. 5E has been selected/determined (e.g., by the spatial template determiner 460 in FIG. 4G), causing the first electronic device 101a to update display of the three-dimensional environment 550A according to the presenter spatial template 528A. As an example, in FIG. 5I, an avatar 517 corresponding to a third user (not shown) of a third electronic device (not shown) in the multi-user communication session is positioned in the presenter seat within the presenter spatial template 528A, indicating that the third user has been assigned the presenter role as previously discussed above with reference to FIG. 5E. Additionally, as shown in FIG. 5I, the first electronic device 101a displays virtual object 535 in the three-dimensional environment 550A. In some examples, as similarly discussed above, the virtual object 535 corresponds to and/or includes content associated with a respective application, such as a presentation application or other content provider application (e.g., a video player application, web-browsing application, text editing application, etc.)). In some examples, as shown in FIG. 5I, the virtual object 535 is displaying content (e.g., a presentation including slides, video, images, text, etc.) that is visible to the first user 502 of the first electronic device 101a. In some examples, the virtual object 535 is displayed with a grabber bar affordance (e.g., a handlebar) that is selectable to initiate movement of the virtual object 535 within the three-dimensional environment 550A.

Additionally, in some examples, as illustrated in the overhead view 510 in FIG. 5I, the first user 502 is positioned in a seat of the plurality of audience seats, such that the viewpoint of the first electronic device 101a corresponds to a location within the audience of the presenter spatial template 528A. In some examples, as shown in the overhead view 510 in FIG. 5I, the avatar 505 corresponding to the second user 504 is also positioned in a seat of the plurality of audience seats (e.g., adjacent to the seat occupied by the first user 502) in the presenter spatial template 528A. For example, the viewpoint of the second electronic device 101b corresponds to a location within the audience of the presenter spatial template 528A. In some examples, as previously discussed above with reference to FIG. 4G, the first user 502 and the second user 504 are assigned audience roles in the presenter spatial template 528A by the secondary spatial parameters determiner 472 of the spatial coordinator API 462, which causes the first user 502 and the second user 504 to be positioned in seats of the plurality of audience seats in the presenter spatial template 528A, as illustrated in FIG. 5I. Similarly, in the example of FIG. 5I, the third user (e.g., represented by the avatar 517) is assigned the presenter role in the presenter spatial template 528A by the secondary spatial parameters determiner 472 of the spatial coordinator API 462, which causes the third user (e.g., the avatar 517 corresponding to the third user) to be positioned in the presenter seat in the presenter spatial template 528A. Additionally or alternatively, in some examples, the first user 502 is positioned in one of the audience seats in the presenter spatial template 528A in response to the first electronic device 101a (or the third electronic device discussed above) detecting user input that causes the first user 502 to be assigned an audience role in the presenter spatial template 528A. For example, as previously discussed above with reference to FIG. 5E, because the input detected by the first electronic device 101a for sharing the content (e.g., the presentation content of the virtual object 535) is provided by the first user 502 in FIG. 5D, the first user 502 is (e.g., automatically and/or by default) assigned a presenter role in the presenter spatial template 528A. In some examples, the presenter role (e.g., and/or roles in general) is able to be transitioned to (e.g., passed onto) other participants in the multi-user communication session in response to detecting respective user input, such as user input included in the input data 483 discussed previously above with reference to FIG. 4G. For example, the display of the virtual object 535 in the three-dimensional environment 550A is associated with an option that is selectable to assign the role of presenter to another participant in the multi-user communication session, which, when selected, causes the designated user (e.g., the third user discussed above) to inherit the presenter role, causing the viewpoint of the first electronic device 101a to be updated from the location corresponding to the presenter seat (e.g., occupied by the avatar 517 in the overhead view 510) to the location corresponding to the seat in the audience as shown in FIG. 5I. As another example, the user input that may be included in the input data 483 that is optionally received by the secondary spatial parameters determiner 472 in FIG. 4G for transitioning the presenter role to another user (e.g., the third user) corresponds to and/or includes the first user 502 (or another user who currently is associated with the presenter role) exiting the multi-user communication session. For example, in FIG. 5I, if the first user 502 provides input that is detected by the first electronic device 101a for exiting the multi-user communication session (e.g., the first user 502 selects an option for exiting the multi-user communication session, the first user 502 removes the first electronic device 101a, the first user 502 powers down the first electronic device 101a, etc.), the presenter role that was previously assigned to the first user 502 is (e.g., automatically) assigned to the third user in the multi-user communication session, causing the avatar 517 corresponding to the third user to be repositioned in the presenter seat in the presenter spatial template 528A in the manner illustrated in the overhead view 510 (e.g., with the first user 502 no longer occupying a seat and/or role in the presenter spatial template 528A). Accordingly, as outlined above in FIGS. 5D-5I, user input detected by a respective electronic device (e.g., the first electronic device 101a) for sharing content (e.g., the virtual object 535) with other participants in the multi-user communication session causes the spatial template currently selected for the multi-user communication session (e.g., the system spatial template illustrated in FIGS. 5C-5D) to change (e.g., to the presenter spatial template 528A in FIG. 5I) based on the content being shared (e.g., according to a custom spatial template associated with the content).

In some examples, other events that do not necessarily include user input provided by the first user 502 and/or the second user 504 may trigger the spatial template currently selected for the multi-user communication session to change, thereby causing the spatial arrangement of the participants in the shared three-dimensional environment to change. For example, with reference to FIG. 4G, the communication application 488 updates the particular spatial template that is in use (e.g., the system spatial template of FIG. 5D or the presenter spatial template of FIG. 5I) in response to detecting a change in a number of participants within the multi-user communication session. Particularly, in some examples, the spatial template is updated in response to detecting one or more users join the multi-user communication session and/or one or more users leave the multi-user communication session. For example, as similarly discussed above with reference to FIG. 5I, a decrease in the number of participants within the multi-user communication session (e.g., in response to one or more users leaving the multi-user communication session) optionally causes the particular seats at which users are positioned to be updated (e.g., such as the third user (e.g., represented by the avatar 517) being repositioned in the presenter seat in the presenter spatial template 528A in FIG. 5I in response to the first user 502 leaving the multi-user communication session, as discussed above). In some examples, updating the current spatial template includes adding one or more additional seats to the current spatial template. For example, if the number of participants within the multi-user communication session increases to a number that is greater than the current number of open/available seats in the current spatial template (e.g., in response to one or more users joining the multi-user communication session, the communication application 488 of FIG. 4G adds and/or creates additional seats (e.g., using and/or based on the custom template request data 465) at which to position the new participants. As an illustrative example, when the first electronic device 101a detects the input provided by the first user 502 for sharing content (e.g., presentation content) in the multi-user communication session in FIG. 5D, there are a first number of participants (e.g., two total participants) in the multi-user communication session. Accordingly, as illustrated in FIG. 5E, the current number of seats in the presenter spatial template 528A (e.g., five seats total) is sufficient for the first number of participants in the multi-user communication session. However, in FIG. 5I, the number of participants in the multi-user communication session optionally increases to a second number of participants (e.g., ten total participants) that is greater than the current number of seats in the presenter spatial template 528A of FIG. 5E. Accordingly, as illustrated in the overhead view 510 in FIG. 5I, the presenter spatial template 528A is updated to include a greater number of seats (e.g., five additional seats) to accommodate the second number of participants in the multi-user communication session (e.g., to provide placement locations and/or orientations for the additional participants (e.g., for avatars corresponding to the additional participants)).

Thus, as outlined above, providing an API (e.g., the spatial coordinator API 462 of FIG. 4G) that facilitates communication between the communication application (e.g., communication application 488) and one or more respective applications (e.g., one or more secondary applications 470) enables content (e.g., virtual objects, such as virtual object 535) to be displayed in the shared three-dimensional environment in a multi-user communication session according to a particular spatial arrangement (e.g., a custom spatial template) defined by the one or more respective applications, as an advantage. Additionally, providing the API reduces the cognitive burden of the electronic device in formulating and/or determining spatial arrangements according to which to arrange content and participants in the multi-user communication session, thereby helping preserve computing resources associated with facilitating the multi-user communication session.

It should be understood that the examples shown and described herein are merely exemplary and that additional and/or alternative elements may be provided within the three-dimensional environment for interacting with the illustrative content. It should be understood that the appearance, shape, form and size of each of the various user interface elements and objects shown and described herein are exemplary and that alternative appearances, shapes, forms and/or sizes may be provided. For example, the virtual objects representative of user interfaces and/or application windows (e.g., application window 330 and/or virtual object 535) may be provided in an alternative shape than a rectangular shape, such as a circular shape, triangular shape, etc. In some examples, the various selectable options (e.g., options 521 and 522 and/or option 526), user interface objects, control elements, etc. described herein may be selected and/or interacted with verbally via user verbal commands (e.g., “select option” verbal command). Additionally or alternatively, in some examples, the various options, user interface elements, control elements, etc. described herein may be selected and/or manipulated via user input received via one or more separate input devices in communication with the electronic device(s). For example, selection input may be received via physical input devices, such as a mouse, trackpad, keyboard, etc. in communication with the electronic device(s).

FIG. 6 illustrates a flow diagram illustrating an example process for facilitating a multi-user communication session in response to detecting a request to share content in the multi-user communication session based on data received from a respective application associated with the content according to some examples of the disclosure. In some examples, process 600 begins at a first electronic device in communication with one or more displays and one or more input devices, wherein the first electronic device is collocated with a second electronic device in a first physical environment. In some examples, the first electronic device and the second electronic device are optionally a head-mounted display, respectively, similar or corresponding to device 200 of FIG. 2. As shown in FIG. 6, in some examples, at 602, the first electronic device detects an indication of a request to engage in a shared activity with a second electronic device, different from the first electronic device. For example, as shown in FIG. 5D, first electronic device 101a detects an input provided by hand 503 of a first user 502 corresponding to a request to share content (e.g., from application A) with a second user 504 of a second electronic device 101b.

In some examples, at 604, in response to detecting the indication, the first electronic device enters the communication session with the second electronic device, including operating a communication session framework (e.g., communication application 488 in FIG. 4G) that is configured to, at 606, receive, from a respective application associated with the shared activity, application data. For example, as shown in FIG. 4G, when the first electronic device 101a enters the communication session with the second electronic device 101b, spatial coordinator API 462 of the communication application 488 receives custom template request data 465 from one or more secondary applications 470. In some examples, the application data includes, at 608, first data indicating a first object corresponding to the shared activity that is to be displayed in a respective three-dimensional environment, at 610, second data indicating a plurality of placement locations relative to the first object in the respective three-dimensional environment, and at 612, third data indicating one or more orientations associated with the plurality of placement locations relative to the first object in the respective three-dimensional environment. For example, as described with reference to FIG. 4G, the first data, the second data, and the third data is included in the custom template request data 465, and the first data is received by application spatial parameter determiner 468, and the second data and the third data are received by participant spatial parameter determiner 464.

In some examples, at 614, the communication session application is further configured to output, based on the application data, display data indicating a first spatial arrangement according to which at least a viewpoint of the first electronic device, a representation of a user of the second electronic device, and the first object are presented in a three-dimensional environment of the first electronic device. For example, as described with reference to FIG. 4G, spatial template determiner 460 outputs spatial template display data 467 that includes a designation of a respective spatial template according to which the content that is shared in the multi-user communication session and the participants in the multi-user communication session are arranged.

It is understood that process 600 is an example and that more, fewer, or different operations can be performed in the same or in a different order. Additionally, the operations in process 600 described above are, optionally, implemented by running one or more functional modules in an information processing apparatus such as general-purpose processors (e.g., as described with respect to FIG. 2) or application specific chips, and/or by other components of FIG. 2.

FIG. 7 illustrates a flow diagram illustrating an example process for displaying virtual content in a respective spatial arrangement within a multi-user communication session based on data received from a respective application associated with the content according to some examples of the disclosure. In some examples, process 700 begins at a first electronic device in communication with one or more displays, one or more input devices, and a second electronic device. In some examples, the first electronic device and the second electronic device are optionally a head-mounted display, respectively, similar or corresponding to devices 260/270 of FIG. 2. As shown in FIG. 7, in some examples, at 702, while in a communication session with the second electronic device, the first electronic device presents, via the one or more displays, a representation of a user of the second electronic device in a three-dimensional environment. For example, as shown in FIG. 5C, first electronic device 101a is displaying an avatar 505 corresponding to a second user 504 of a second electronic device 101b in three-dimensional environment 550A while the first electronic device 101a and the second electronic device 101b are in a multi-user communication session.

In some examples, at 704, while presenting the representation of the user of the second electronic device in the three-dimensional environment, the first electronic device detects an indication of a request to present shared content in the three-dimensional environment. For example, as shown in FIG. 5D, the first electronic device 101a detects a selection of option 526 provided by hand 503 of the first user 502 for sharing content (e.g., from application A) with the second electronic device 101b in the multi-user communication session.

In some examples, at 706, in response to detecting the indication, the first electronic device presents, via the one or more displays, a first object corresponding to the shared content in the three-dimensional environment, wherein a viewpoint of the first electronic device, the representation of the user of the second electronic device, and the first object have a first spatial arrangement in the three-dimensional environment based on data provided by a respective framework associated with the communication session. For example, as shown in FIG. 5I, the first electronic device 101a displays virtual object 535 (e.g., including or corresponding to presentation content) in the three-dimensional environment 550A according to a particular spatial template as indicated in overhead view 510. In some examples, the data indicates, at 708, a location of the first object relative to a respective three-dimensional environment, at 710, a location of the representation of the user of the second electronic device relative to the location of the first object in the respective three-dimensional environment, and at 712, an orientation of the representation of the user of the second electronic device relative to the location of the first object in the respective three-dimensional environment. For example, as described with reference to FIG. 4G, when the first electronic device 101a shares the content with the second electronic device 101b in the multi-user communication session, spatial coordinator API 462 of communication application 488 receives custom template request data 465 from one or more secondary applications 470, wherein the custom template request data 465 includes data and/or information according to which a particular spatial template is formulated by the spatial coordinator API 462.

It is understood that process 700 is an example and that more, fewer, or different operations can be performed in the same or in a different order. Additionally, the operations in process 700 described above are, optionally, implemented by running one or more functional modules in an information processing apparatus such as general-purpose processors (e.g., as described with respect to FIG. 2) or application specific chips, and/or by other components of FIG. 2.

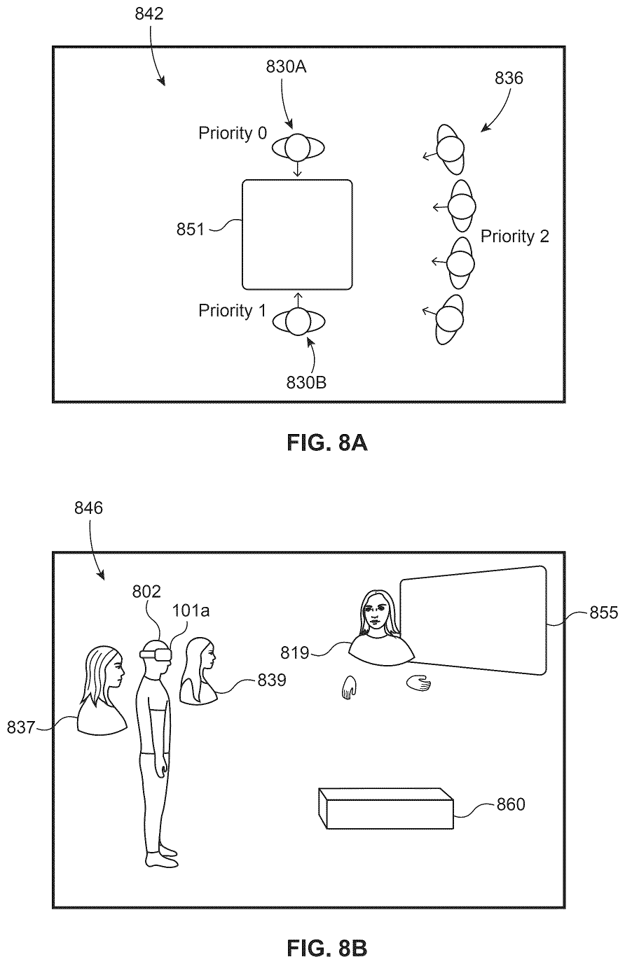

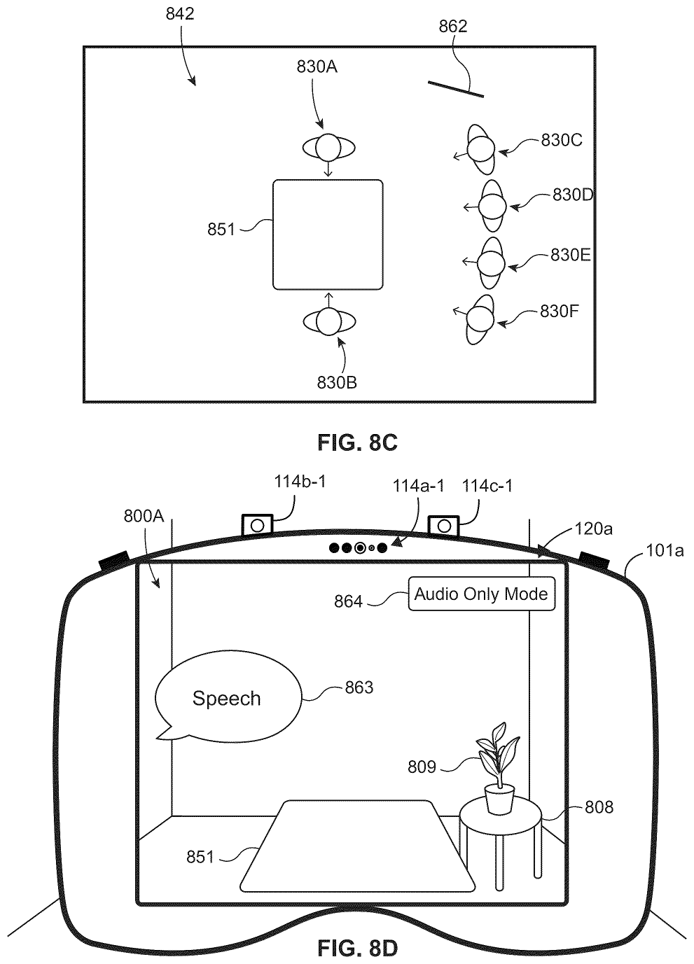

FIGS. 8A-8D illustrate examples of custom spatial templates within a multi-user communication session according to some examples of the disclosure.

FIG. 8A illustrates custom spatial template 842 corresponding to a spectator spatial template according to which participants are arranged in a multi-user communication session. In some examples, the custom spatial template 842 corresponds to first custom spatial template 542 discussed above with reference to FIG. 5H. For example, as similarly described above with reference to FIG. 5H, the custom spatial template 842 includes a plurality of seats (e.g., placement locations and/or regions) associated with virtual object 851 (e.g., a virtual board game that includes two player seats). Particularly, in some examples, as shown in FIG. 8A, the custom spatial template 842 includes first seat 830A, second seat 830B, and seat pattern 836 according to which one or more participants in the multi-user communication session are arranged. In some examples, as similarly discussed above, the seat pattern 836 corresponds to a region or zone having a particular shape, such as the arc shape illustrated in the custom spatial template 842, according to which the participants are positioned and/or oriented in the multi-user communication session, as shown in FIG. 8A.

In some examples, as similarly discussed above with reference to FIG. 4G, the provision of the custom spatial template 842 is associated with a seat priority spatial parameter (e.g., generated and/or provided by the secondary spatial parameters determiner 472 of the spatial coordinator API 462 in FIG. 4G). For example, as described above, the seat priority spatial parameter determines and/or defines an order in which the seats and/or seat patterns of a respective custom spatial template are populated/filled in within a multi-user communication session. In the example of FIG. 8A, the seat priority spatial parameter that is associated with the custom spatial template 842 designates the first seat 830A as having a first priority (e.g., a highest priority), the second seat 830B as having a second priority (e.g., lower than the first priority), and the seat pattern 836 as having a third priority (e.g., the lowest priority) in the multi-user communication session. For example, the seat priority spatial parameter that is associated with the custom spatial template 842 designates that a first participant (e.g., a first user) in the multi-user communication session is positioned in the first seat 830A, a second participant in the multi-user communication session is positioned in the second seat 830B, and subsequent participants (e.g., a third, fourth, fifth, and/or sixth participants) in the multi-user communication session are positioned in the seat pattern 836. In some examples, the particular order defined by the seat priority spatial parameter is based on the particular roles associated with the content being shared/displayed in the multi-user communication session. For example, in FIG. 8A, the first seat 830A and the second seat 830B have higher priorities than the seat pattern 836 due to their particular respective roles, such as the first seat 830A and the second seat 830B being associated with player roles and the seat pattern being associated with spectator roles. Additionally or alternatively, in some examples, the particular order defined by the seat priority spatial parameter is based on an order in which the participants in the multi-user communication session join the multi-user communication session. For example, in FIG. 8A, the first participant is positioned in the first seat 830A because the first participant was the first user to join the multi-user communication session and the second participant is positioned in the second seat 830B because the second participant was the next user following the first user to join the multi-user communication session. Additionally, in some examples, the subsequent participants are positioned in the seat pattern 836 because the subsequent participants joined the multi-user communication session after the first participant and the second participant. It should be understood that the discussion of the seat priority spatial parameter associated with the custom spatial template 842 similarly applies to any and/or all other custom spatial templates described herein, such as the custom spatial templates 542-548 in FIG. 5F and/or the presenter spatial templates 528A/528B in FIG. 5E.

In some examples, as similarly discussed above with reference to FIG. 4G, the provision of the custom spatial template 842 is associated with a seat height spatial parameter (e.g., generated and/or provided by the secondary spatial parameters determiner 472 of the spatial coordinator API 462 in FIG. 4G). For example, as described above, the seat height spatial parameter determines and/or defines a height offset (e.g., an elevation) relative to a surface in the shared three-dimensional environment at which seats and/or seat patterns of a respective custom spatial template are defined in within a multi-user communication session. In some examples, as shown in FIG. 8B, which illustrates a side view of custom spatial template 846 corresponding to a presenter spatial template as similarly discussed above with reference to FIG. 5E and FIG. 5I, in the custom spatial template 846, participants are arranged in the multi-user communication session with respective height offsets (e.g., elevations) relative to a surface (e.g., a bottom surface, such as a ground or floor in the shared three-dimensional environment, which may be physical or virtual). For example, as shown in FIG. 8B, a plurality of participants is arranged according to the custom spatial template 846, including first user 802 (e.g., who is wearing first electronic device 101a), avatar 819 (e.g., corresponding to a second user), avatar 837 (e.g., corresponding to a third user), and avatar 839 (e.g., corresponding to a fourth user). Additionally, in some examples, as shown in FIG. 8B, the shared three-dimensional environment includes virtual objects 855/860. In some examples, as similarly discussed above, the virtual object 855 corresponds to and/or includes virtual presentation content (e.g., virtual images, video, and/or text presented via a slideshow or similar presentation). In some examples, the virtual object 860 corresponds to a virtual stage on which the avatar 819 is positioned within the custom spatial template 846, such that the avatar 819 visually appears (e.g., to the first user 802 via the electronic device 101a) as the presenter of the presentation content in the virtual object 855. In some examples, the virtual object 860 is a part of an immersive environment/experience (e.g., a virtual environment) within which the custom spatial template 846 is arranged. For example, as discussed below, the immersive environment corresponds to a theater or hall environment that includes a virtual stage (e.g., corresponding to the virtual object 860), a virtual screen (e.g., corresponding to the virtual object 855), and a plurality of virtual seats or chairs (e.g., within which the audience participants are positioned).

In some examples, the plurality of participants illustrated in FIG. 8B is associated with one or more height offsets relative to a surface of the shared three-dimensional environment within the custom spatial template 846. In some examples, the particular height offset associated with the plurality of participants is based on the particular seats the participants are positioned in within the custom spatial template 846. For example, in FIG. 8B, the participants assigned to the audience roles in the custom spatial template 846 (e.g., the avatar 839, the first user 802, and the avatar 837) are assigned a first height offset relative to the ground/floor of the shared three-dimensional environment, and the participant assigned the presenter role in the custom spatial template 846 (e.g., the avatar 819) is assigned a second height offset (e.g., greater than the first height offset) relative to the ground/floor of the shared three-dimensional environment. In some examples, the reference (e.g., the surface) according to which the height offset spatial parameter is relative to corresponds to a surface that is different from (e.g., separate from) the ground/floor of a respective three-dimensional environment. For example, in FIG. 8B, rather than the avatar 819 being positioned/displayed at a height relative to the ground/floor, the avatar 819 is positioned/displayed at a height relative to a top surface of the virtual object 860 (e.g., atop the virtual stage) in the custom spatial template 846. It should be understood that, in some examples, in the side view of FIG. 8B, the virtual elements (e.g., the avatars 819/837/839 and/or the virtual objects 855/860) are presented via, and are thus visible to the first user 802 using, the first electronic device 101a. It should also be understood that the discussion of the height offset spatial parameter associated with the custom spatial template 846 similarly applies to any and/or all other custom spatial templates described herein, such as the custom spatial template 842 above, the custom spatial templates 542-548 in FIG. 5F and/or the presenter spatial templates 528A/528B in FIG. 5E.

FIG. 8C illustrates custom spatial template 842 corresponding to a spectator spatial template according to which participants are arranged in a multi-user communication session. In some examples, the custom spatial template 842 corresponds to first custom spatial template 542 discussed above with reference to FIG. 5G. For example, as similarly described above with reference to FIG. 5G, the custom spatial template 842 includes a plurality of seats (e.g., placement locations) associated with virtual object 851 (e.g., a virtual board game that includes two player seats). Particularly, in some examples, as shown in FIG. 8C, the custom spatial template 842 includes seat 830A-830F according to which one or more participants in the multi-user communication session are arranged.

In some examples, as previously described above with reference to FIG. 4G, respective content (e.g., the virtual object 851) that is shared/displayed within a multi-user communication session includes and/or is associated with a plurality of seats defined according to application data provided by an application associated with the respective content (e.g., such as the custom template request data 465 provided by the one or more secondary applications 470). In some examples, the plurality of seats associated with the respective content is reserved for participants who are spatial in the multi-user communication session. For example, a respective participant in the multi-user communication session is determined to be spatial in accordance with a determination that the respective participant is being represented virtually via a three-dimensional representation, such as via an avatar as previously discussed herein. In some examples, the respective participant who is being represented via the three-dimensional representation is thereby positioned and/or oriented within a seat in the custom spatial template 842 in FIG. 8C. In some examples, in accordance with a determination that a respective participant transitions from being spatial to being non-spatial in the multi-user communication session or that a respective participant joins the multi-user communication session as a non-spatial participant, the respective participant is not placed at and/or is removed from a seat within the custom spatial template 842 in FIG. 8C. For example, a non-spatial participant in the multi-user communication session is not represented by a visual representation (e.g., a two-dimensional representation, such as a canvas or image of the non-spatial participant and/or a video conferencing user interface that includes a two-dimensional camera feed or other image of the non-spatial participant). Rather, in some examples, the non-spatial participant is able to communicate with the other participants in the multi-user communication session (e.g., via their respective electronic device) via audio (e.g., speech-based input detected by and/or received by their respective electronic device, such as speech input detected via one or more microphones of the electronic device or input data provided by other electronic devices in the multi-user communication session), as similarly discussed above with reference to FIG. 3.

Alternatively, in some examples, in accordance with a determination that a respective participant transitions from being spatial to being non-spatial in the multi-user communication session or that a respective participant joins the multi-user communication session as a non-spatial participant, the respective participant is positioned at a location and/or in a region in the shared three-dimensional environment that is outside of and/or is separate from (e.g., is not defined by) the custom spatial template 842 that is reserved for non-spatial participants. For example, as shown in FIG. 8C, a non-spatial participant in the multi-user communication session is represented by a two-dimensional representation 862, which optionally corresponds to a two-dimensional canvas or image of the non-spatial participant and/or a video conferencing user interface that includes a two-dimensional camera feed or other image of the non-spatial participant. Additionally, in some examples, as shown in FIG. 8C, the two-dimensional representation 862 of the non-spatial participant is positioned at a location that is separate from the plurality of seats of the custom spatial template 842. In some examples, the location at which the two-dimensional representation 862 is positioned in the shared three-dimensional environment in FIG. 8C is determined by the communication application 488 discussed above in FIG. 4G, optionally based on or independent of the custom template request data 465 provided by the one or more secondary applications 470 (e.g., with which the virtual object 851 is associated).

In some examples, the plurality of seats associated with respective content that is shared/displayed within a multi-user communication session is a finite number of seats, including a maximum number of seats for a respective custom spatial template. For example, in FIG. 8C, the custom spatial template 842 has a maximum number of six seats relative to the virtual object 851. It should be understood that, in some examples, different types of content are associated with different maximum numbers of seats (e.g., based on the particular custom spatial templates being utilized/provided in the multi-user communication session for different types of content). In some examples, as similarly described above with reference to FIG. 5I, in accordance with a determination that one or more additional participants join the multi-user communication session while the maximum number of seats are currently occupied, additional seats are (e.g., automatically) created and/or provided (e.g., by the spatial coordinator API 462 in FIG. 4G) in the multi-user communication session to accommodate the one or more additional participants, such as the additional seats indicated in the overhead view 510 in FIG. 5I. In some examples, as illustrated in FIG. 8C, rather than create and/or provide additional seats in the custom spatial template 842 in accordance with a determination that the maximum number of seats (e.g., six seats) has been reached in the multi-user communication session, the one or more additional participants are added to the multi-user communication session in an audio only mode, as described in more detail below.

FIG. 8D illustrates a first electronic device 101a joining a multi-user communication session while in an audio only mode. In FIG. 8D, the first electronic device 101a is presenting, via display 120a, three-dimensional environment 800A that includes representations of a physical environment of the first electronic device 101a, such as representations of stand 808 and houseplant 809, as similarly described above. In some examples, the first electronic device 101a has joined the multi-user communication session illustrated in FIG. 8C above while the maximum number of seats within the custom spatial template 842 is occupied in the multi-user communication session. Accordingly, as indicated in FIG. 8D, the first electronic device 101a (e.g., and thus a first user of the first electronic device 101a) is added to the multi-user communication session in the audio only mode (e.g., by the communication application 488 in FIG. 4G). For example, as shown in FIG. 8D, when the first electronic device 101a joins the multi-user communication session in the audio only mode, the first electronic device 101 displays an indication 864 that the first user of the first electronic device 101a is participating in the multi-user communication session (e.g., with the other participants in the multi-user communication) via audio only. In some examples, while the first electronic device 101a is in the multi-user communication session in the audio only mode, the first electronic device 101a forgoes displaying visual representations of the other participants in the multi-user communication session, such as the participants described with reference to FIG. 8C. For example, as shown in FIG. 8D, though the three-dimensional environment 800A includes the virtual object 851 discussed above that is shared in the multi-user communication session, the three-dimensional environment 800A does not include representations (e.g., avatars) of the other users in the multi-user communication session. Rather, as indicated by speech bubble 863 in FIG. 8D, the first user of the first electronic device 101a is able to communicate with the other participants in the multi-user communication session via audio (e.g., speech-based input detected by and/or received by the first electronic device 101a, such as speech input detected via one or more microphones of the first electronic device 101a or input data provided by other electronic devices in the multi-user communication session). For example, as similarly described above with reference to FIG. 3, speech input detected by the respective electronic devices of the other users in the multi-user communication session is transferred to the first electronic device 101a (e.g., directly or indirectly, such as via a wireless communications terminal) as data and is output by the first electronic device 101a (e.g., via one or more speakers of the first electronic device 101a) as audio. Alternatively, in some examples, while the first electronic device 101a is in the multi-user communication session in the audio only mode, the first electronic device 101a forgoes displaying a three-dimensional (e.g., volumetric) form of the virtual object 851 when forgoing displaying the spatial representations (e.g., avatars) of the other users in the multi-user communication session. Rather, in some examples, the first electronic device 101a displays a two-dimensional representation of the three-dimensional virtual content, such as a vertical two-dimensional window that includes an overhead view of the content of the virtual object 851 (e.g., an overhead view of the virtual board game) and two-dimensional representations of the other users in the multi-user communication session (e.g., image-based two-dimensional representations of the participants and the spectators in the shared activity).

In some examples, the audio includes and/or corresponds to spatialized audio, as represented by the speech bubble 863, such that the audio output by the first electronic device 101a corresponding to a voice or other speech input provided by a respective participant audibly appears to originate from the location (e.g., the seat) of the respective participant relative to the virtual object 851 in the three-dimensional environment 800A. Similarly, in some examples, because the first electronic device 101a is operating in the audio only mode while in the multi-user communication session of FIG. 8C, the first user of the first electronic device 101a is not represented in the shared three-dimensional environment via a visual representation (e.g., an avatar).

It should be understood that, in some examples, if the number of participants in the multi-user communication session falls to within (e.g., below) the maximum number of seats in the custom spatial template 842 in FIG. 8C, the first electronic device 101a ceases to operate in the audio only mode discussed above. For example, if one or more participants leave the multi-user communication session, the first electronic device 101a ceases display of the indication 864 in the three-dimensional environment 800A and displays representations (e.g., avatars) of the other participants in the multi-user communication session. Additionally, in some examples, the first electronic device 101a positions a viewpoint of the first electronic device 101a at a particular seat (e.g., an open/unoccupied seat) in the custom spatial template 842, as similarly described above, such that the first user is able to view the virtual object 851 and the avatars corresponding to the other participants in the multi-user communication session from that particular seat. Additionally or alternatively, in some examples, rather than causing the first electronic device 101a to operate in the audio only mode in accordance with the determination that the number of participants in the multi-user communication session is greater than the maximum number of seats in the custom spatial template 842, the first user of the first electronic device 101a is represented as a two-dimensional representation (e.g., similar to the two-dimensional representation 862) and is positioned outside of and/or separate from the plurality of seats of the custom spatial template 842, as similarly discussed above with reference to FIG. 8C.

Attention is now directed toward examples of facilitating presentation of virtual objects (e.g., content and/or virtual avatars) within a three-dimensional environment according to a custom spatial template in a multi-user communication session that includes a hybrid spatial group.

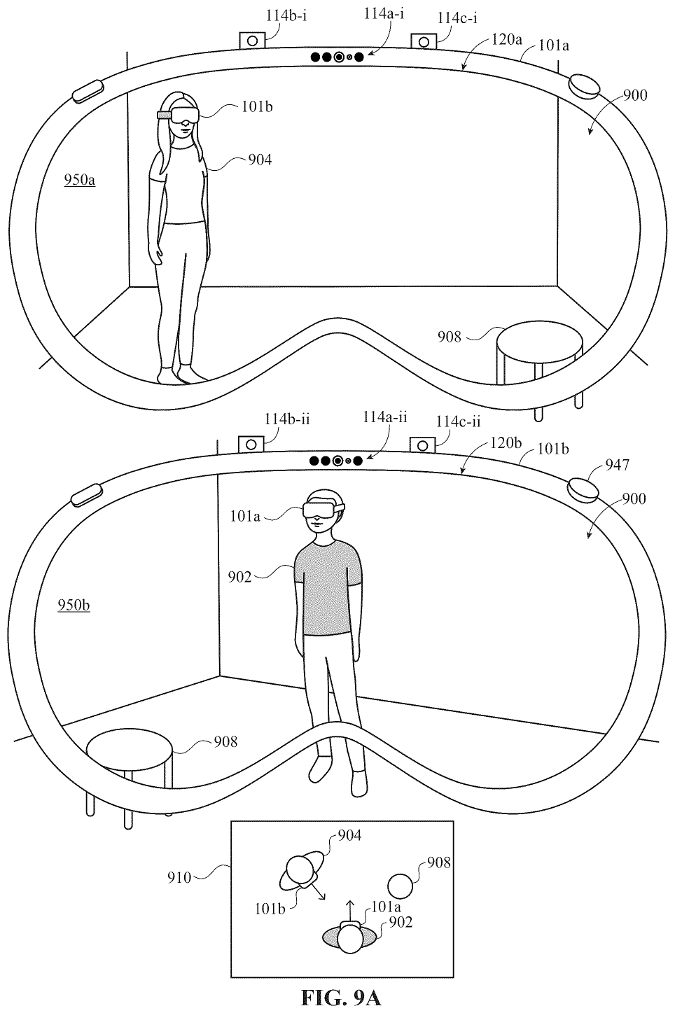

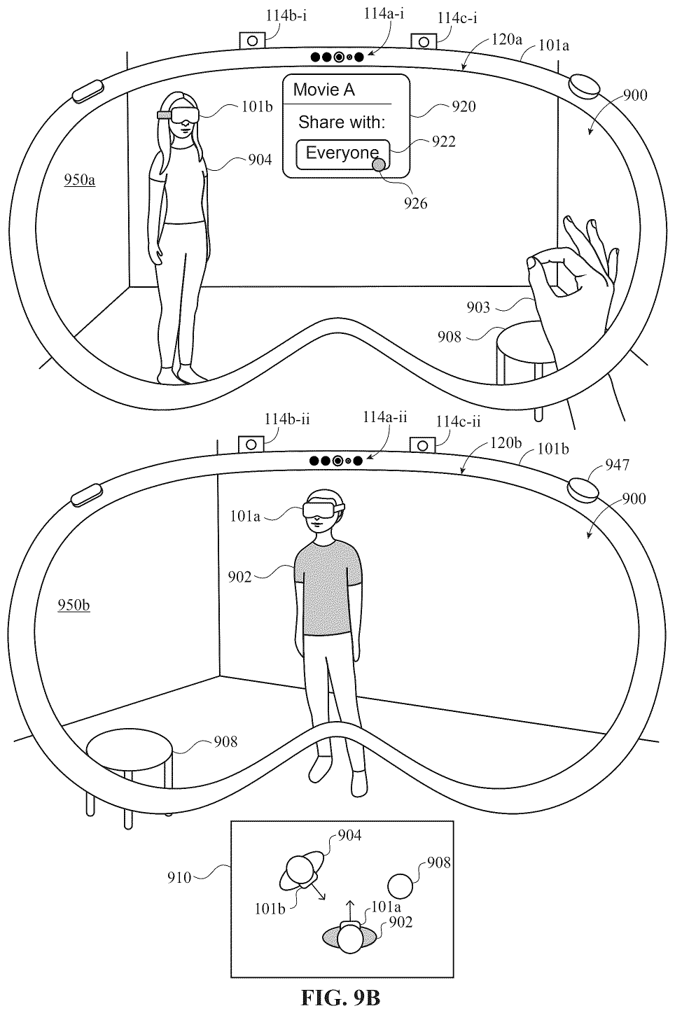

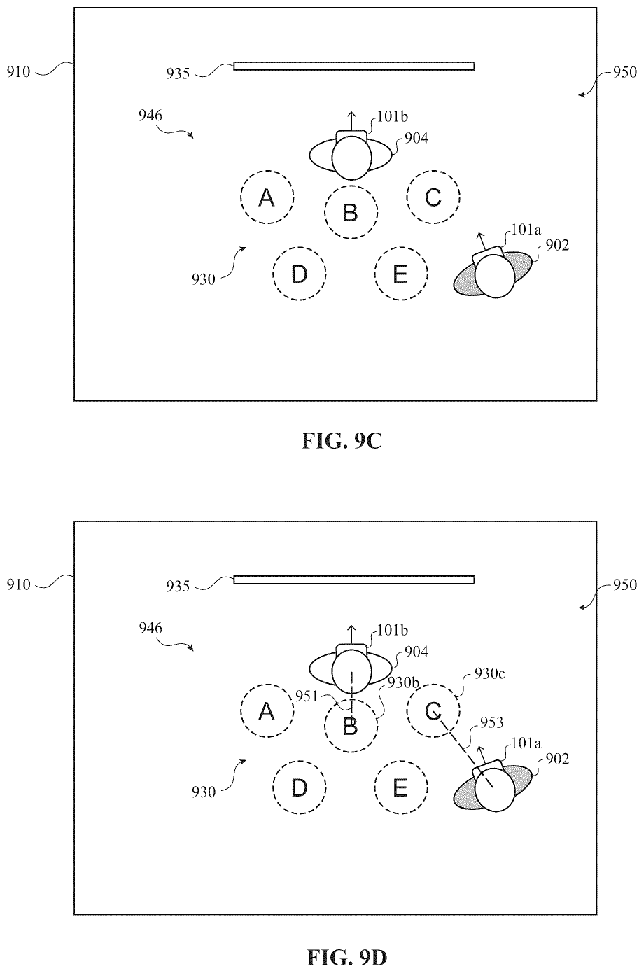

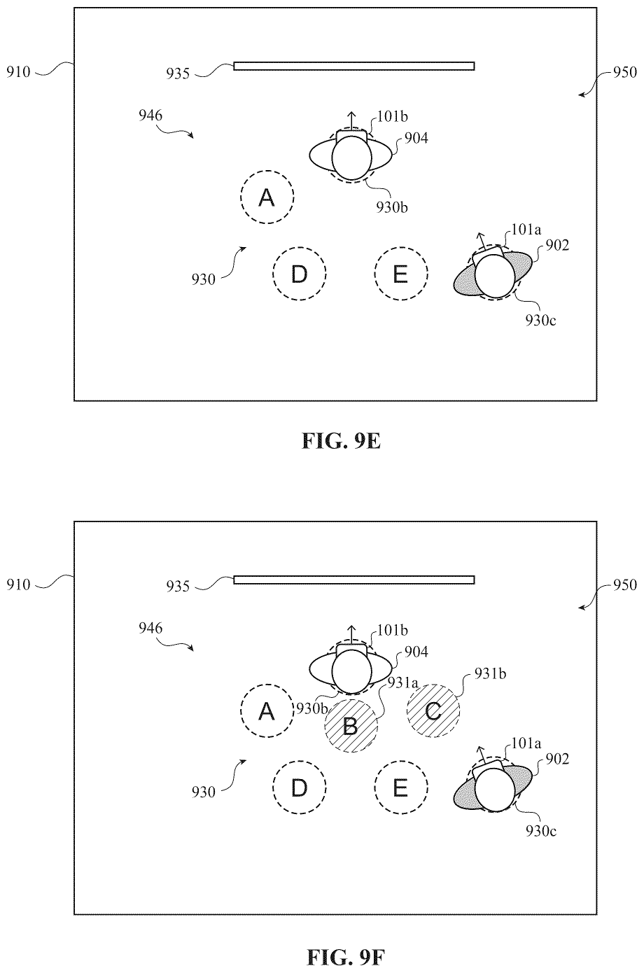

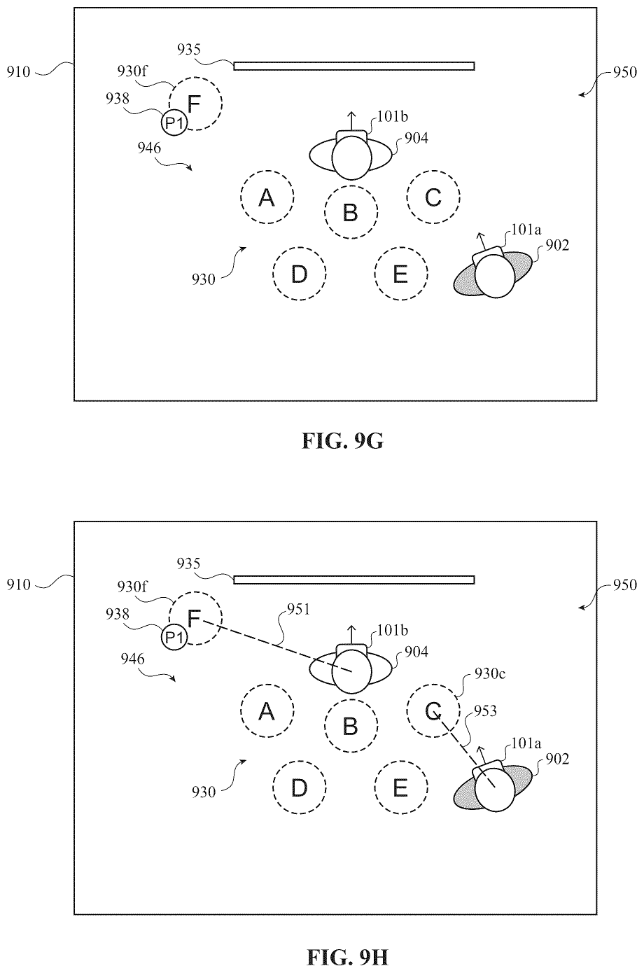

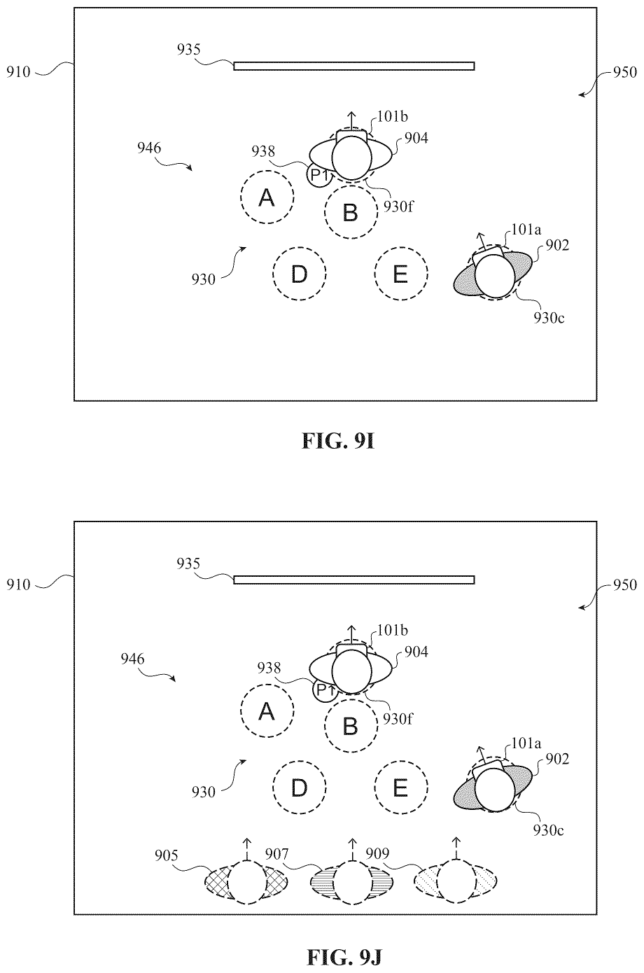

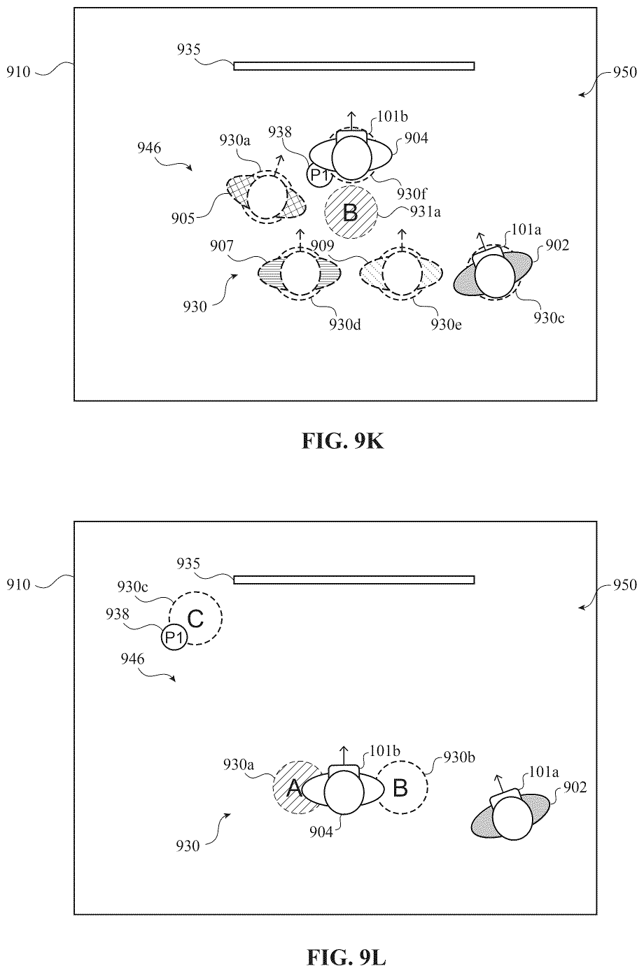

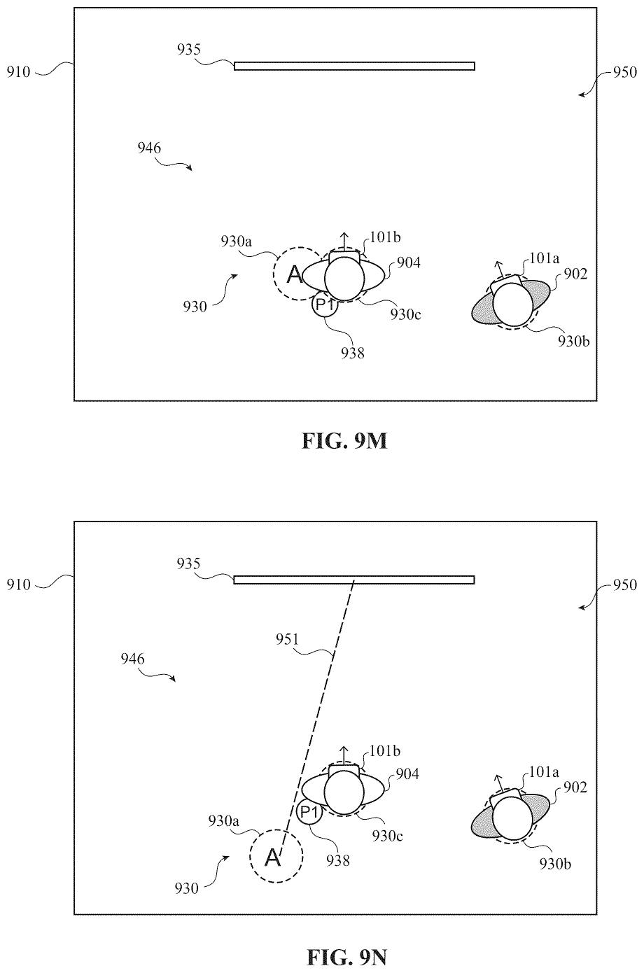

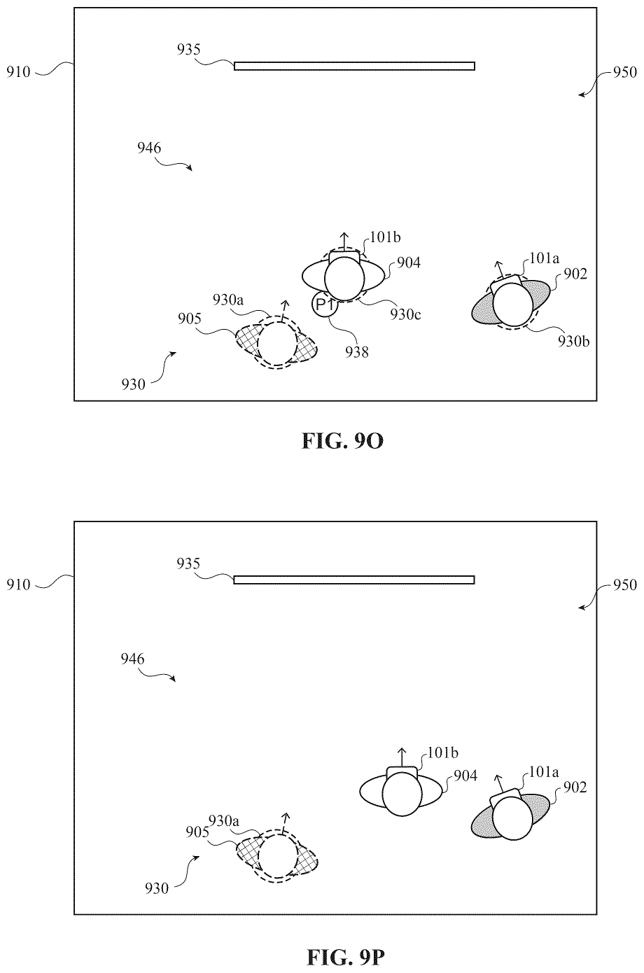

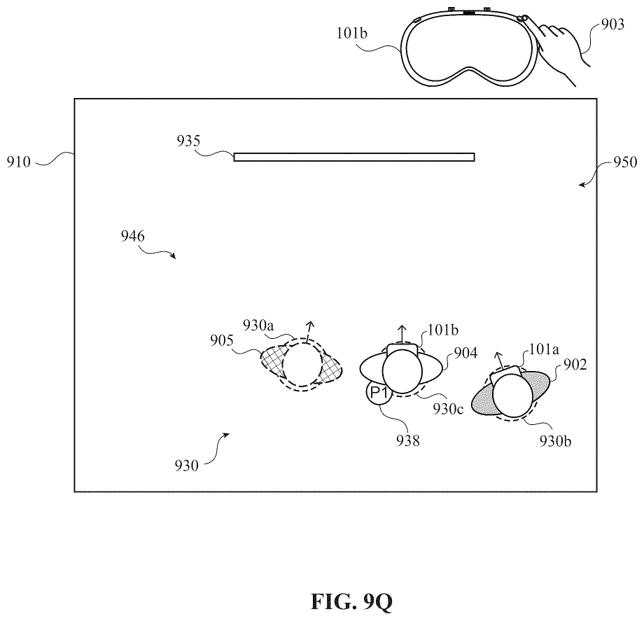

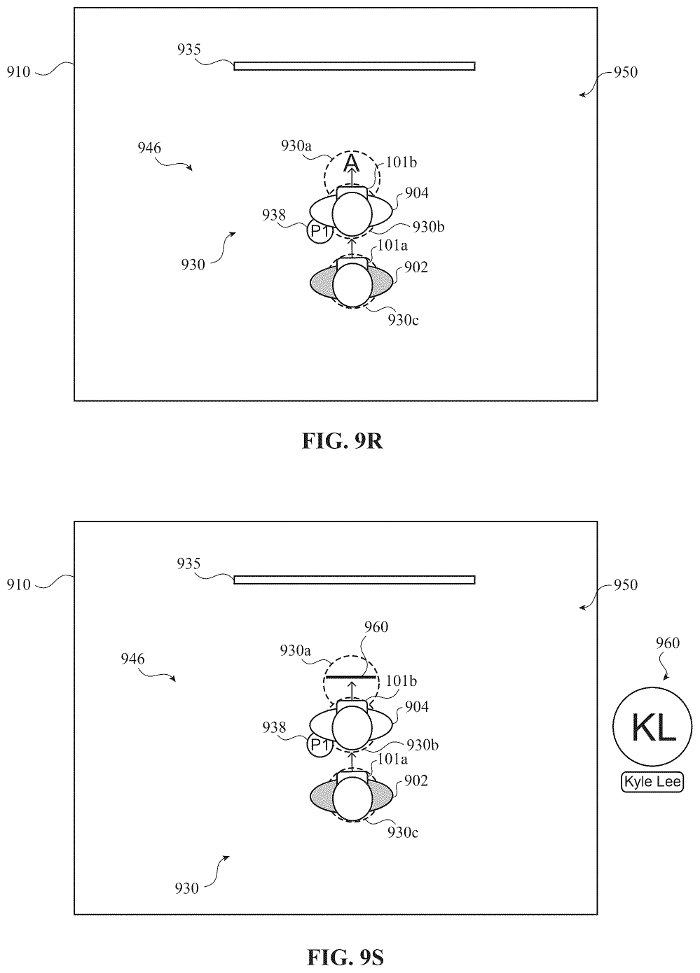

FIGS. 9A-9S illustrate examples of custom spatial templates within hybrid multi-user communication sessions according to some examples of the disclosure. In some examples, as shown in FIG. 9A, three-dimensional environment 950A is presented using a first electronic device 101a (e.g., via display 120a) and three-dimensional environment 950B is presented using a second electronic device 101b (e.g., via display 120b). In some examples, the electronic devices 101a/101b optionally correspond to or are similar to electronic device 401 discussed above, electronic devices 360/370 in FIG. 3, and/or electronic devices 260/270 in FIG. 2. In some examples, as shown in FIG. 9A, the first electronic device 101a is being used by (e.g., worn on a head of) a first user 902 as illustrated in overhead view 910, and the second electronic device 101b is being used by (e.g., worn on a head of) a second user 904 as illustrated in the overhead view 910.

In FIG. 9A, as indicated in the overhead view 910, the first electronic device 101a and the second electronic device 101b are located in a same physical environment, such as physical environment 900. For example, as shown in FIG. 9A, the first electronic device 101a (e.g., and the first user 902) and the second electronic device 101b (e.g., and the second user 904) are located in a room that includes table 908.

In some examples, the three-dimensional environments 950A/950B include captured portions of the physical environment 900 in which the electronic devices 101a/101b are located. For example, as shown in FIG. 9A, the three-dimensional environment 950A and the three-dimensional environment 950B include the table 908 (e.g., a representation of the table) from the unique viewpoints of the first electronic device 101a and the second electronic device 101b, respectively. In some examples, the representations can include portions of the physical environment 900 viewed through a transparent or translucent display of the electronic devices 101a and 101b. In some examples, the three-dimensional environments 950A/950B have one or more characteristics of the three-dimensional environments 550A/550B described above with reference to FIG. 5A and/or three-dimensional environments 350A/350B described above with reference to FIG. 3.

In FIG. 9A, the first electronic device 101a is in a multi-user communication session with the second electronic device 101b (e.g., the first user 902 and the second user 904 are associated with a same spatial group) while the first user 902 and the second user 904 are collocated in the physical environment 900. For example, as discussed above, the first electronic device 101a and the second electronic device 101b are both located in a same physical room that includes the table 908. In some examples, the determination that the first electronic device 101a and the second electronic device 101b are collocated in the physical environment 900 is based on a distance between the first electronic device 101a and the second electronic device 101b. For example, in FIG. 9A, the first electronic device 101a and the second electronic device 101b are collocated in the physical environment 900 because the first electronic device 101a is within a threshold distance (e.g., 0.1, 0.5, 1, 2, 3, 5, 10, 15, 20, etc. meters) of the second electronic device 101b. In some examples, the determination that the first electronic device 101a and the second electronic device 101b are collocated in the physical environment 900 is based on communication between the first electronic device 101a and the second electronic device 101b. For example, in FIG. 9A, the first electronic device 101a and the second electronic device 101b are configured to communicate (e.g., wirelessly, such as via Bluetooth or other peer-to-peer communication networks, Wi-Fi, or a server (e.g., wireless communications terminal)) with each other. In some examples, the first electronic device 101a and the second electronic device 101b are connected to and/or are configured to communicate using a same wireless network in the first physical environment. In some examples, the determination that the first electronic device 101a and the second electronic device 101b are collocated in the physical environment 900 is based on a strength of a wireless signal transmitted between the first electronic device 101a and second electronic device 101b. For example, in FIG. 9A, the first electronic device 101a and the second electronic device 101b are collocated in the physical environment 900 because a strength of a Bluetooth signal (or other wireless signal) transmitted between the first electronic device 101a and second electronic device 101b is greater than a threshold strength. In some examples, the determination that the first electronic device 101a and the second electronic device 101b are collocated in the physical environment 900 is based on visual detection of the first electronic device 101a and second electronic device 101b in the physical environment 900. For example, as shown in FIG. 9A, the second electronic device 101b is positioned in a field of view of the first electronic device 101a (e.g., because the second user 904 is standing in the field of view of the first electronic device 101a), which enables the first electronic device 101a to visually detect (e.g., identify or scan, such as via object detection or other image processing techniques) the second electronic device 101b (e.g., in one or more images captured by the first electronic device 101a, such as via external image sensors 114b-i and 114c-i). Similarly, as shown in the example of FIG. 9A, the first electronic device 101a is optionally positioned in a field of view of the second electronic device 101b (e.g., because the first user 902 is standing in the field of view of the second electronic device 101b from a viewpoint of the second electronic device 101b), which enables the second electronic device 101b to visually detect the first electronic device 101a (e.g., in one or more images captured by the second electronic device 101b, such as via external image sensors 114b-ii and 114c-ii).

Additionally, in FIG. 9A, because the first electronic device 101a and the second electronic device 101b are collocated in the physical environment 900 as discussed above, the users of the first electronic device 101a and second electronic device 101b are represented in the multi-user communication session via their physical personas (e.g., bodies) that are visible directly or in passthrough of the physical environment 900 (e.g., rather than via virtual representations generated and displayed by the electronic devices). For example, as shown in FIG. 9A, the second user 904 is visible in the field of view of the first electronic device 101a and the first user 902 is visible in the field of view of the second electronic device 101b in the physical environment 900 while the first electronic device 101a and the second electronic device 101b are in the multi-user communication session.

As used herein, relative to a first electronic device, a collocated user corresponds to a local user and a non-collocated user corresponds to a remote user. As similarly discussed above, the shared three-dimensional environment optionally includes avatars (e.g., avatars 315/317) corresponding to the remote users of the electronic devices that are non-collocated in the multi-user communication session. In some examples, the avatars corresponding to the remote users are generated and presented in the shared three-dimensional environment based on (e.g., using) skeletal data associated with the remote users. For example, the skeletal data is used to, at least partially, define one or more visual characteristics of the avatars (e.g., a size (e.g., height) and/or relative thickness of portions of the avatar, such as hands and/or limbs) in the three-dimensional environment. Additionally, the skeletal data is optionally used to track movement of the remote users, which, as discussed below, causes their corresponding avatars to be shifted and/or moved in the three-dimensional environment relative to the viewpoint of a first electronic device. In some examples, the skeletal data associated with local users may also be tracked and shared among the collocated electronic devices in the multi-user communication session to help facilitate presentation of and interaction with virtual objects (e.g., avatars and shared virtual content) in the three-dimensional environment.

In FIG. 9B, while the first electronic device 101a and the second electronic device 101b are in the multi-user communication session and are collocated in the physical environment 900, the first electronic device 101a detects a sequence of one or more inputs corresponding to a request to share content in the multi-user communication session. For example, as shown in FIG. 9B, while displaying user interface element 920 that is associated with a media application (e.g., a content player application), the first electronic device 101a detects an input provided by the first user 902 corresponding to a request to share a first content item (e.g., Movie A) in the multi-user communication session, such as via a selection of share option 922 of the user interface element 920. In some examples, as shown in FIG. 9B, detecting the selection of the share option 922 includes detecting an air pinch gesture performed by hand 903 of the first user 902, optionally while gaze 926 of the first user 902 is directed toward the share option 922 in the three-dimensional environment 950A. In some examples, as described in more detail below, sharing the first content item in the multi-user communication session enables the first content item to be viewable by and/or interactive to the participants of the multi-user communication session, including the first user 902 and the second user 904 (e.g., via their respective electronic devices). In some examples, in response to detecting the selection of the share option 922, the first electronic device 101a initiates a process to share the first content item with the second electronic device 101b within the multi-user communication session.

In some examples, sharing the first content item within the multi-user communication session includes displaying a virtual object corresponding to the first content item (e.g., a user interface that includes playback of the first content item) in the three-dimensional environment shared between the first electronic device 101a and the second electronic device 101b (e.g., the three-dimensional environments 950A/950B). For example, as illustrated in the overhead view 910 in FIG. 9C, the first electronic device 101a and the second electronic device 101b initiate display of virtual object 935 (e.g., a virtual window including a user interface) corresponding to the first content item in shared three-dimensional environment 950. In some examples, as similarly described herein above, the virtual object 935 is associated with a custom spatial template 946 according to which the participants in the multi-user communication session are arranged relative to the virtual object 935 in the shared three-dimensional environment 950. For example, the media application discussed above with which the first content item (e.g., Movie A) is associated is in communication with and/or is configured to communicate with the communication application 488 of the electronic device 401 discussed above with reference to FIG. 4G (e.g., such that the media application corresponds to and/or is included in the one or more secondary applications 470 of FIG. 4G). In some examples, as discussed in more detail below, the custom spatial template 946 includes and/or defines a spatial arrangement (e.g., defined by and/or specified by a developer of the media application, as discussed previously herein) relative to the virtual object 935 according to which the first user 902 of the first electronic device 101a and the second user 904 of the second electronic device 101b are arranged in the shared three-dimensional environment 950. Particularly, as shown in the overhead view 910 and as similarly discussed above, the custom spatial template 946 includes a plurality of seats 930 that correspond to and/or define placement locations relative to the virtual object 935 at which to position the (e.g., viewpoints of the) participants in the multi-user communication session.

In some examples, contrary to application of custom spatial templates within multi-user communication sessions that include remote users (e.g., such as in the examples of F IGs. 5A-5I and/or 8A-8D) in which the placement of the participants of the multi-user communication session is based on positioning of their respective avatars (e.g., visual representations), application of custom spatial templates within multi-user communication sessions that include local users (e.g., collocated users, such as the first and second users 902 and 904) is not solely and/or optionally does not involve the positioning of avatars representing the participants of the multi-user communication session. Particularly, as discussed above, in the example of FIG. 9C, because the first user 902 of the first electronic device 101a and the second user 904 of the second electronic device 101b are collocated in the physical environment 900, the first user 902 and the second user 904 are visually represented in the shared three-dimensional environment 950 by their physical bodies while participating in the multi-user communication session, which thus does not require or involve the display of avatars corresponding to the first user 902 and the second user 904 in the shared three-dimensional environment 950. Accordingly, in some examples, as outlined below, when sharing and displaying content (e.g., the first content item) that is associated with a custom spatial template (e.g., custom spatial template 946) in the shared three-dimensional environment 950 while two or more of the participants of the multi-user communication session are collocated in a same physical environment (e.g., physical environment 900), the application of the custom spatial template is based on and/or is adapted to the physical locations of the participants in the physical environment.

In some examples, as shown in the overhead view 910 in FIG. 9C, when the first electronic device 101a initiates the process to share the first content item with the second electronic device 101b, the first electronic device 101a is located at a first location in the physical environment 900 and the second electronic device 101b is located at a second location (e.g., different from the first location) in the physical environment 900. Particularly, as shown in the overhead view 910 in FIG. 9C, the first user 902 of the first electronic device 101a is positioned at the first location relative to the display location of the virtual object 935 that corresponds to the first content item and the second user 904 of the second electronic device 101b is positioned at the second location relative to the display location of the virtual object 935 in the shared three-dimensional environment 950. In some examples, as previously discussed herein, the display location of the virtual object 935 corresponds to a default (e.g., computer-designated) location, such as the location of the user interface element 920, or a user-selected location in the shared three-dimensional environment 950 relative to the viewpoints of the first electronic device 101a and the second electronic device 101b.

In some examples, as indicated in the overhead view 910 in FIG. 9C, when applying the custom spatial template 946 to the shared three-dimensional environment 950 when initiating the sharing and display of the virtual object 935 corresponding to the first content item, the first electronic device 101a and/or the second electronic device 101b associate the physical locations of the first electronic device 101a and the second electronic device 101b with one or more seats of the plurality of seats 930 within the custom spatial template 946. For example, with reference to FIG. 4G above, using the custom template request data 465 received from the one or more secondary applications 470, the communication application 488 operates and/or directs the system templates service 461 to select the custom spatial template 946 according to which to arrange (e.g., to position and/or orient) the first content item (e.g., the virtual object 935) and the participants in the multi-user communication session (e.g., the first user 902 and the second user 904) in the shared three-dimensional environment 950. In some examples, as previously discussed above with reference to FIG. 4G, the scene integration service 466 receives spatial template display data 467 that is encoded with the custom spatial template 946 from the spatial template determiner 460.

However, in some examples, as illustrated in the overhead view 910 in FIG. 9C, the physical locations of the first electronic device 101a and the second electronic device 101b in the physical environment 900 do not correspond to and/or overlap with one or more locations of the plurality of seats 930 of the custom spatial template 946 in the shared three-dimensional environment 950. Further, because the first user 902 of the first electronic device 101a and the second user 904 of the second electronic device 101b are being visually represented in the shared three-dimensional environment 950 via their respective physical bodies (e.g., as opposed to virtual avatars), the first user 902 and the second user 904 are optionally unable to be (e.g., automatically) repositioned within the shared three-dimensional environment 950 by the electronic devices 101a and 101b to respective seats of the plurality of seats 930 in the custom spatial template 946. Accordingly, as indicated in the overhead view 910 in FIG. 9D, the first electronic device 101a and the second electronic device 101b initiate a process to update one or more locations of one or more seats of the plurality of seats 930 of the custom spatial template 946 in the shared three-dimensional environment 950 based on and/or in accordance with the physical locations of the first electronic device 101a and the second electronic device 101b in the physical environment 900. For example, returning to FIG. 4G above, based on input data 483 (e.g., sensor and/or image data indicating the current locations and/or orientations of the first electronic device 101a and/or the second electronic device 101b in the physical environment 900), the communication application 488 identifies one or more seats of the plurality of seats 930 of the custom spatial template 946 with which to associated the first user 902 of the first electronic device 101a and the second user 904 of the second electronic device 101b in the shared three-dimensional environment 950.

In some examples, the first user 902 of the first electronic device 101a and the second user 904 of the second electronic device 101b are assigned and/or become associated with seats in the custom spatial template 946 based on a distance/proximity between the locations of the first user 902 and the second user 904 in the physical environment 900 and corresponding locations of available (e.g., unoccupied and/or unassigned) seats in the custom spatial template 946 in the shared three-dimensional environment 950. For example, as illustrated in the overhead view 910 in FIG. 9D, the first electronic device 101a determines and/or identifies seat 930c of the plurality of seats 930 of the custom spatial template 946 as being an available seat that is proximate to (e.g., within a threshold distance of, such as 0.10, 0.25, 0.5, 0.75, 1, 1.5, 3, etc. meters of) the physical location of the first user 902 in the physical environment 900, as indicated by line 953. Similarly, in some examples, as shown in the overhead view 910 in FIG. 9D, the second electronic device 101b determines and/or identifies seat 930b of the plurality of seats 930 of the custom spatial template 946 as being an available seat that is proximate to (e.g., within the threshold distance of) the physical location of the second user 904 in the physical environment 900, as indicated by line 951.

In some examples, as illustrated in the overhead view 910 in FIG. 9E, following the determination of the seats 930c and 930b that are proximate to the physical locations of the first user 902 and the second user 904, respectively, the first electronic device 101a and the second electronic device 101b associates the seats 930c and 930b with the first user 902 and the second user 904, respectively, in the multi-user communication session. Particularly, in some examples, as illustrated in the overhead view 910 in FIG. 9E, the first electronic device 101a and the second electronic device 101b update the plurality of seats 930 of the custom spatial template 946, such that a location of the seat 930b within the custom spatial template 946 is updated/moved to correspond to the physical location of the second user 904 in the physical environment 900 and a location of the seat 930c within the custom spatial template 946 is updated/moved to correspond to the physical location of the first user 902 in the physical environment 900. Additionally, in some examples, as illustrated in the overhead view 910 in FIG. 9E, when the first electronic device 101a and the second electronic device 101b update the locations of the seats 930b and 930c in the custom spatial template 946, the first electronic device 101a and the second electronic device 101b forgo updating locations of other seats of the plurality of seats 930 in the custom spatial template 946, such as seats A, D and E in FIG. 9E.

In some examples, as illustrated in the overhead view 910 in FIG. 9F, following the updating of the locations of the seats 930b and 930c within the custom spatial template 946 in the shared three-dimensional environment 950, data corresponding to the updated locations of the seats 930b and 930c are communicated/transmitted to the media application that is associated with the virtual object 935. For example, with reference to FIG. 4G, the scene integration service 466 of the communication application 488 transmits the updated locations of the seats 930b and 930c within the custom spatial template 946 in the form of the contextual data 473 to the one or more secondary applications 470, which indicates that the prior locations of the seats 930b and 930c (e.g., represented by prior locations 931a and 931b in FIG. 9F) no longer correspond to available (e.g., valid) placement locations within the shared three-dimensional environment 950 (e.g., for placing one or more avatars corresponding to remote users, as discussed in more detail below).

FIGS. 9G-9K illustrate alternative examples of applying a custom spatial template to the shared three-dimensional environment 950 within a multi-user communication session that includes collocated users. In some examples, as previously discussed herein, one or more seats of the plurality of seats within a respective custom spatial template are assigned and/or are associated with one or more roles that are able to be assigned to one or more participants within the multi-user communication session. For example, as illustrated in the overhead view 910 in FIG. 9G, when the custom spatial template 946 is applied to the shared three-dimensional environment 950 when initiating display of the virtual object 935, seat 930f within the custom spatial template 946 is assigned role 938 (e.g., a presenter role, as previously discussed herein). Accordingly, in some examples, when the first electronic device 101a and the second electronic device 101b identify and/or determine respective seats within the custom spatial template 946 for the first user 902 and the second user 904, one of the first user 902 and the second user 904 within the multi-user communication session may be assigned and/or may become associated with the seat 930f that is assigned the role 938.

In FIG. 9H, as illustrated in the overhead view 910, the second user 904 of the second electronic device 101b is assigned the role 938 (e.g., the presenter role) in the shared three-dimensional environment 950 when initiating display of the virtual object 935 in the shared three-dimensional environment 950. For example, as previously described herein, in FIG. 9H, the second user 904 of the second electronic device 101b is assigned the role 938 by the spatial coordinator API 462 in FIG. 4G according to the custom template request data 465 based on user input. For example, with reference to FIG. 4G, the spatial coordinator API 462 assigns (e.g., using the secondary spatial parameters determiner 472) the presenter role 938 in the custom spatial templates 946 based on the user input data 481 that is optionally received by the one or more secondary applications 470, including the application associated with the first content item (e.g., the virtual object 935). In some examples, in FIG. 9H, because the second user 904 of the second electronic device 101b provides the input for sharing the first content item with the other participants in the multi-user communication session, including the first user 502 of the first electronic device 101a, the second user 904 is assigned the role 938 within the custom spatial template 946. Accordingly, in some examples, as indicated in the overhead view 910 in FIG. 9H, the first electronic device 101a and the second electronic device 101b associate the second user 904 of the second electronic device 101b with the seat 930f within the custom spatial template 946 in the shared three-dimensional environment 950, as indicated by line 951. In some examples, as illustrated in the overhead view 910 in FIG. 9H, the seat 930f is assigned to the second user 904 of the second electronic device 101b despite (e.g., irrespective of) the seat 930f not being proximate to (e.g., within the threshold distance above of) the physical location of the second user 904 in the physical environment 900, such as seat B which is proximate to the physical location of the second user 904 (e.g., because the second user 904 has been assigned the role 938, which is specifically associated with the seat 930f within the custom spatial template 946).

Additionally, in some examples, in FIG. 9H, the first user 902 of the first electronic device 101a is assigned a different role (e.g., a non-presenter role, such as an audience role) or is not assigned a role within the custom spatial template 946 in the shared three-dimensional environment 950 when initiating display of the virtual object 935 in the shared three-dimensional environment 950. For example, as previously described herein, in FIG. 9H, the first user 902 of the first electronic device 101a is assigned an audience role by the spatial coordinator API 462 in FIG. 4G according to the custom template request data 465 based on user input. For example, with reference to FIG. 4G, the spatial coordinator API 462 assigns (e.g., using the secondary spatial parameters determiner 472) the audience role (or no role) in the custom spatial templates 946 based on the user input data 481 that is optionally received by the one or more secondary applications 470, including the application associated with the first content item (e.g., the virtual object 935). In some examples, as discussed above, in FIG. 9H, because the second user 904 of the second electronic device 101b has been assigned the role 938 (e.g., the presenter role) within the custom spatial template 946, the first user 902 of the first electronic device 101a is assigned an audience role or other non-presenter role within the custom spatial template 946. Accordingly, in some examples, as indicated in the overhead view 910 in FIG. 9H, the first electronic device 101a and the second electronic device 101b associate the first user 902 of the first electronic device 101a with a non-presenter role seat or an available seat that is not assigned a role within the custom spatial template 946 and that is proximate to (e.g., within the threshold distance above of) the physical location of the first user 902 in the physical environment 900 in the shared three-dimensional environment 950, as indicated by line 953.

In some examples, as similarly discussed above, as shown in the overhead view 910 in FIG. 9I, following the identification and/or determination of the seats 930c and 930f for the first user 902 and the second user 904 within the multi-user communication session, the first electronic device 101a and the second electronic device 101b update locations of the seats 930c and 930f within the custom spatial template 946. For example, as shown in FIG. 9I, the first electronic device 101a and the second electronic device 101b move the location of the seat 930c within the custom spatial template 946 to correspond to the physical location of the first user 902 in the physical environment 900 and move the location of the seat 930f within the custom spatial template 946 to correspond to the physical location of the second user 904 in the physical environment 900. Additionally, as previously described above, following the updating of the locations of the seats 930c and 930f within the custom spatial template 946 in the shared three-dimensional environment 950, data corresponding to the updated locations of the seats 930c and 930f are communicated/transmitted to the media application that is associated with the virtual object 935. For example, with reference to FIG. 4G, the scene integration service 466 of the communication application 488 transmits the updated locations of the seats 930c and 930f within the custom spatial template 946 in the form of the contextual data 473 to the one or more secondary applications 470, which indicates that the prior locations of the seats 930c and 930f no longer correspond to available (e.g., valid) placement locations within the shared three-dimensional environment 950 (e.g., for placing one or more avatars corresponding to remote users, as discussed in more detail below).

In FIG. 9J, after the virtual object 935 is displayed in the shared three-dimensional environment 950 and while the first user 902 of the first electronic device 101a and the second user 904 of the second electronic device 101b are collocated in the physical environment 900, the first electronic device 101a and the second electronic device 101b detect one or more indications of one or more requests to add one or more remote users (e.g., non-collocated users) to the multi-user communication session. For example, as similarly described herein above, after the custom spatial template 946 has been applied to the shared three-dimensional environment 950, the first electronic device 101a and the second electronic device 101b receive invitations to add at least a third user of a third electronic device 101c that is non-collocated with the first user 902 and the second user 904 in the physical environment 900 to the multi-user communication session.

In some examples, in response to receiving the one or more indications, the first electronic device 101a and/or the second electronic device 101b initiate a process to add the at least the third user of the third electronic device to the multi-user communication session, which includes identifying a placement location for a visual representation (e.g., virtual avatar) of the third user within the shared three-dimensional environment 950. In some examples, as previously discussed herein, because the custom spatial template 946 that is associated with the virtual object 935 has been applied to the shared three-dimensional environment 950 prior to the one or more indications being detected, the placement locations at which to display visual representations of the remote users, including the visual representation of the third user of the third electronic device, are determined according to the plurality of seats 930 of the custom spatial template 946 in the shared three-dimensional environment 950. Particularly, as described herein above with reference to FIGS. 5A-5I, the first electronic device 101a and the second electronic device 101b identify one or more placement locations in the shared three-dimensional environment 950 that correspond to the available seats within the plurality of seats 930 of the custom spatial template 946 at which to display one or more virtual avatars of the remote users in the multi-user communication session.

As alluded to above, in some examples, identifying one or more placement locations in the shared three-dimensional environment 950 at which to display one or more visual representations of one or more remote users includes identifying one or more available seats within the custom spatial template 946 relative to the virtual object 935 in the shared three-dimensional environment 950. As an example, in the overhead view 910 in FIG. 9J, the determination of whether a seat of the plurality of seats 930 is available is at least partially based on the physical locations of the local users (e.g., the first user 902 and the second user 904) and the particular seats that are assigned to the local users within the custom spatial template 946. For example, in FIG. 9J, the first user 902 of the first electronic device 101a is assigned and is therefore occupying the seat 930c and the second user 904 of the second electronic device 101b is assigned and is therefore occupying the seat 930f within the custom spatial template 946. In some examples, because the seats 930c and 930f that have been assigned to the first user 902 and the second user 904 in the multi-user communication session are based on (e.g., moved to) the physical locations of the first user 902 and the second user 904 in the physical environment 900, one or more seats that are not currently occupied may still be invalidated as a placement location for a visual representation of a remote user based on the current locations of the seats 930c and 930f. For example, in the overhead view 910 in FIG. 9J, though seat B of the plurality of seats 930 in the custom spatial template 946 is not currently occupied by a user (e.g., the first user 902 or the second user 904), the updated location of the seat 930f within the custom spatial template 946 causes the seat B to be an invalid placement location for a visual representation of a remote user, as the seat B is too close (e.g., less than a threshold distance from, such as within 0.1, 0.2, 0.3, 0.5, 0.75, etc. meters) to the location of the second user 904 and/or is spatially located behind the location of the second user 904 relative to the virtual object 935 in the shared three-dimensional environment 950. Accordingly, in the example of FIG. 9J, the first electronic device 101a and the second electronic device 101b identify three valid placement locations within the shared three-dimensional environment 950 corresponding to seats A, D, and E within the custom spatial template 946 (e.g., excluding seat B as discussed above).

In some examples, as illustrated in the overhead view 910 in FIG. 9K, following the identification and/or determination of the one or more placement locations in the shared three-dimensional environment 950 based on the available seats within the custom spatial template 946, the first electronic device 101a and the second electronic device 101b display one or more visual representations of the one or more remote users at the one or more placement locations in the shared three-dimensional environment 950. For example, as similarly described herein above, in FIG. 9K, the first electronic device 101a and the second electronic device 101b display avatar 905 corresponding to the third user of the third electronic device (e.g., a remote user) at a first placement location in the shared three-dimensional environment 950 corresponding to seat 930a of the custom spatial template 946. Additionally, in some examples, as illustrated in the overhead view 910 in FIG. 9K, as additional remote users join the multi-user communication session, visual representations of the additional remote users are displayed at placement locations in the shared three-dimensional environment 950 corresponding to available (e.g., unoccupied) seats in the custom spatial template 946 as discussed above. For example, as shown in the overhead view 910 in FIG. 9K, avatar 907 corresponding to a fourth user of a fourth electronic device is displayed at a second placement location corresponding to seat 930d and avatar 909 corresponding to a fifth user of a fifth electronic device is displayed at a third placement location corresponding to seat 930e in the shared three-dimensional environment 950 (e.g., and excluding location 931a in the shared three-dimensional environment 950 corresponding to seat B as described above).

FIGS. 9L-9Q illustrate additional examples of applying a custom spatial template to the shared three-dimensional environment 950 within a multi-user communication session that includes collocated users. In the overhead view 910 in FIG. 9L, while the first electronic device 101a and the second electronic device 101b are in the multi-user communication session, the first electronic device 101a and the second electronic device 101b have initiated a process to display shared content (e.g., the first content item discussed above) corresponding to the virtual object 935 in the shared three-dimensional environment 950. In some examples, as previously discussed above, the virtual object 935 is associated with custom spatial template 946 that includes a plurality of seats 930, including seats 930a-930c, as illustrated in FIG. 9L. As described above, in some examples, applying the custom spatial template 946 that is associated with the virtual object 935 to the shared three-dimensional environment 950 includes associating and/or assigning seats within the custom spatial template 946 to the first user 902 of the first electronic device 101a and the second user 904 of the second electronic device 101b, which includes evaluating the physical locations of the first user 902 and the second user 904 in the physical environment 900.

In the example of FIG. 9L, as similarly discussed above, one or more seats within the custom spatial template 946 are associated with one or more roles corresponding to the display of the virtual object 935 in the shared three-dimensional environment 950. For example, when the first electronic device 101a and the second electronic device 101b apply the custom spatial template 946 to the shared three-dimensional environment 950, as illustrated in the overhead view 910 in FIG. 9L, seat 930c is associated with role 938 (e.g., a presenter role) within the custom spatial template 946. In some examples, though the physical location of the first user 902 in the physical environment is most proximate to a location of seat 930a in the custom spatial template 946, the second user 904 of the second electronic device 101b is assigned to the role 938 that is currently associated with the seat 930c Accordingly, in some examples, the first electronic device 101a and the second electronic device 101b associate the second user 904 with the seat 930c that is assigned to the role 938 in FIG. 9L, rather than associating the second user 904 with the seat 930a within the custom spatial template 946. Additionally, as similarly discussed above, the first user 902 is assigned a different role (e.g., an audience role) or is not assigned a role within the custom spatial template 946, which causes the first user 902 of the first electronic device 101a to be associated with a corresponding proximate seat, notably seat 930b within the custom spatial template 946.

In some examples, as previously discussed above and as illustrated in the overhead view 910 in FIG. 9M, following the association of the seats 930b and 930c with the first user 902 and the second user 904 in the multi-user communication session, respectively, the first electronic device 101a and the second electronic device 101b update locations of the seats 930b and 930c within the custom spatial template 946 to correspond to the physical locations of the first user 902 and the second user 904 within the physical environment 900. For example, as illustrated in the overhead view 910 in FIG. 9M, the first electronic device 101 and the second electronic device 101b update the location of the seat 930c within the custom spatial template 946 to correspond to the location of the second user 904 in the physical environment 900 and update the location of the seat 930b within the custom spatial template 946 to correspond to the location of the first user 902 in the physical environment 900. Further, in some examples, following the updating of the locations of the seats 930b and 930c within the custom spatial template 946 in the shared three-dimensional environment 950, data corresponding to the updated locations of the seats 930b and 930c are communicated/transmitted to the media application that is associated with the virtual object 935. For example, with reference to FIG. 4G, the scene integration service 466 of the communication application 488 transmits the updated locations of the seats 930b and 930c within the custom spatial template 946 in the form of the contextual data 473 to the one or more secondary applications 470, which indicates that the prior locations of the seats 930b and 930c no longer correspond to available (e.g., valid) placement locations within the shared three-dimensional environment 950 (e.g., for placing one or more avatars corresponding to remote users, as discussed in more detail below).

In some examples, following the display of the virtual object 935 in the shared three-dimensional environment 950, the first electronic device 101a and the second electronic device 101b detect an indication of a request to add a third user of a third electronic device to the multi-user communication session, as similarly discussed above. Particularly, in some examples, the first electronic device 101a and the second electronic device 101b receive an invitation to add a remote user to the multi-user communication session (e.g., the third user of the third electronic device is non-collocated with the first user 902 and the second user 904 in the physical environment 900). In some examples, as previously discussed herein, in response to detecting the indication, the first electronic device 101a and the second electronic device 101b initiate a process to add the third electronic device to the multi-user communication session, including identifying a placement location in the shared three-dimensional environment 950 at which to display a visual representation (e.g., avatar) of the third user of the third electronic device relative to the virtual object 935.

In some examples, as similarly discussed herein, identifying the placement location in the shared three-dimensional environment 950 at which to display the visual representation of the third user of the third electronic device relative to the virtual object 935 includes identifying an available (e.g., unoccupied) seat of the plurality of seats 930 within the custom spatial template 946. As mentioned above, in the example of FIG. 9M, the seat 930c is associated with the second user 904 of the second electronic device 101b and the seat 930b is associated with the first user 902 of the first electronic device 101a within the custom spatial template 946, rendering the seat 930a the (e.g., last) available seat within the custom spatial template 946. However, in some examples, as indicated in the overhead view 910 in FIG. 9M, the second user 904 of the second electronic device 101b is physically located at a location in the physical environment 900 that at least partially overlaps with and/or is proximate to (e.g., is within a threshold distance of, such as 0.1, 0.2, 0.3, 0.4, 0.5, 1, etc. meters of) a location in the shared three-dimensional environment 950 corresponding to the available seat 930a within the custom spatial template 946. Accordingly, though the seat 930a is the available seat within the custom spatial template 946, because of the physical location of the second user 904 of the second electronic device 101b relative to the virtual object 935, the location corresponding to the seat 930a within the shared three-dimensional environment 950 is optionally not a valid placement location for the visual representation of the third user of the third electronic device. For example, the display of the visual representation of the third user at the location in the shared three-dimensional environment 950 corresponding to the seat 930a within the custom spatial template 946 would create a spatial conflict between the visual representation of the third user and the viewpoint of the second electronic device 101b in the shared three-dimensional environment 950.

In an instance where the last available seat within a custom spatial template (e.g., such as the seat 930a discussed above) corresponds to an invalid placement location for a visual representation of a remote user within the shared three-dimensional environment 950 due to proximity to and/or overlap with the physical location of a local user in the multi-user communication session (e.g., which would create a spatial conflict in the shared three-dimensional environment 950 as discussed above), a location of the seat within the custom spatial template may be updated (e.g., moved) to prevent and/or avoid spatial conflict within the shared three-dimensional environment 950 (e.g., thereby rendering the seat a valid placement location for the visual representation of the remote user). In the example of FIG. 9M, when updating the location of the seat 930a within the custom spatial template 946 to render the seat 930a a valid placement location for the visual representation of the third user of the third electronic device, the first electronic device 101a and the second electronic device 101b update the location relative to the virtual object 935 in the shared three-dimensional environment 950. Particularly, in some examples, as illustrated in the overhead view 910 in FIG. 9N, the seat 930a is moved relative to a center (e.g., a geometric center point or portion) of the virtual object 935 in the shared three-dimensional environment 950, such as along a line through the center of the virtual object 935, as illustrated via line 951. In some examples, a direction in which the location of the seat 930a is moved within the custom spatial template 946 relative to the virtual object 935 is based on a spatial arrangement of the location of the seat 930a and the location of the second user 904 relative to the virtual object 935 in the shared three-dimensional environment 950. For example, if the location of the seat 930a within the custom spatial template 946 is closer to the virtual object 935 than the physical location of the second user 904 in the shared three-dimensional environment 950, the seat 930a is moved along the line 951 in a first direction that is toward the virtual object 935. Alternatively, if the location of the seat 930a within the custom spatial template 946 is equidistant to or farther from the virtual object 935 than the physical location of the second user 904 in the shared three-dimensional environment 950, the seat 930a is moved along the line 951 in a second direction that is away from the virtual object 935. In the example of FIGS. 9M and 9N, because the location of the seat 930a is equidistant to or farther from the virtual object 935 than the physical location of the second user 904 in the shared three-dimensional environment 950, the seat 930a is moved along the line 951 in the second direction that is away from the virtual object 935, as illustrated in the overhead view 910.

Additionally, in some examples, a distance that the location of the seat 930a is moved within the custom spatial template 946 relative to the virtual object 935 is based on the spatial arrangement of the location of the seat 930a and the location of the second user 904 relative to the virtual object 935 in the shared three-dimensional environment 950. Particularly, in some examples, the distance that the location of the seat 930a is moved within the custom spatial template 946 relative to the virtual object 935 (e.g., along the line through the center of the virtual object 935 as discussed above) corresponds to a distance required to resolve the spatial conflict between the seat 930a and the physical location of the second user 904 in the shared three-dimensional environment 950. For example, as illustrated in the overhead view 910 in FIG. 9N, the first electronic device 101a and the second electronic device 101b move the location of the seat 930a within the custom spatial template 946 a distance that causes the location of the seat 930a (e.g., and thus a region that would be occupied by the visual representation of the third user) to no longer overlap with the physical location of the second user 904, which is optionally outside of and/or more than a threshold distance (e.g., 0.5, 0.75, 1, 1.5, 2, 3, 5, etc. meters) from the physical location of the second user 904 in the shared three-dimensional environment 950. In some examples, when updating the location of the seat 930a within the custom spatial template 946 in the manner(s) discussed above, the distance the seat 930a is moved relative to the virtual object 935 in the shared three-dimensional environment 950 is limited by the location of the virtual object 935 in the shared three-dimensional environment 950. For example, the first electronic device 101a and the second electronic device 101b limit the movement of the location of the seat 930a within the custom spatial template 946 between a minimum distance from the front-facing surface of the virtual object 935 (e.g., such as no less than 0.75, 0.9, 1, 1.5, 2, 3, 5, etc. meters from the virtual object 935) and a maximum distance from the front-facing surface of the virtual object 935 (e.g., such as no greater than 9, 10, 15, 20, 25, etc. meters from the virtual object 935) in the shared three-dimensional environment 950. In some examples, as similarly discussed above, when the location of the seat 930a within the custom spatial template 946 is updated in the shared three-dimensional environment 950, data corresponding to the updated location of the seat 930a is communicated/transmitted to the media application that is associated with the virtual object 935.

In some examples, in FIG. 9O, following the updating of the location of the seat 930a within the custom spatial template 946, the first electronic device 101a and the second electronic device 101b determine that a location within the shared three-dimensional environment 950 corresponding to the updated location of the seat 930a corresponds to a valid placement location for the visual representation of the third user of the third electronic device (e.g., according to the factors discussed previously above). Accordingly, in some examples, as illustrated in the overhead view 910 in FIG. 9O, when the third electronic device is added to the multi-user communication session that includes the first electronic device 101a and the second electronic device 101b, the first electronic device 101a and the second electronic device 101b display the visual representation of the third user (e.g., avatar 905) at the placement location in the shared three-dimensional environment 950 that corresponds to the updated location of the seat 930a within the custom spatial template 946.

In some examples, the first electronic device 101a and the second electronic device 101b update (e.g., restore) the location of the seat 930a to its initial (e.g., original) location within the custom spatial template 946 after determining that the spatial arrangement of the avatar 905, the viewpoint of the first electronic device 101a, and the viewpoint of the second electronic device 101b in the shared three-dimensional environment 950 relative to the virtual object 935 has been changed/updated such that the original location of the seat 930a in the custom spatial template 946 (e.g., such as the location of the seat 930a in FIG. 9M) no longer causes a spatial conflict with the physical locations of the first user 902 and/or the second user 904. For example, as illustrated in the overhead view 910 from FIG. 9O to FIG. 9P, the physical location of the second user 904 of the second electronic device 101b has changed relative to the virtual object 935 in the shared three-dimensional environment 950, which causes the spatial arrangement of the avatar 905, the viewpoint of the first electronic device 101a, and the viewpoint of the second electronic device 101b relative to the virtual object 935 to change accordingly in the shared three-dimensional environment 950. In some examples, in FIG. 9P, when the spatial arrangement of the avatar 905, the viewpoint of the first electronic device 101a, and the viewpoint of the second electronic device 101b is updated relative to the virtual object 935 in the shared three-dimensional environment 950 due to the movement of the second user 904, the original location of the seat 930a (e.g., the location of the seat 930a in FIG. 9M) within the custom spatial template 946 is no longer overlapping with (e.g., and/or is no longer causing a spatial conflict with) the physical location of the second user 904 in the shared three-dimensional environment 950.

In some examples, the first electronic device 101a and the second electronic device 101b update and/or reset the location of the seat 930a (e.g., which was previously updated as discussed above to account for the physical location of the second user 904 when displaying the avatar 905 in the shared three-dimensional environment 950) within the custom spatial template 946 in response to detecting an indication of input corresponding to a request to reset the spatial arrangement of the avatar 905, the viewpoint of the first electronic device 101a and the viewpoint of the second electronic device 101b relative to the viewpoint of the virtual object 935. For example, as illustrated in FIG. 9Q, after detecting the movement of the viewpoint of the second electronic device 101b as discussed above (e.g., due to the movement of the second user 904 in the physical environment 900), the second electronic device 101b detects an input provided by hand 903 of the second user 904 corresponding to a request to reset the spatial arrangement of the avatar 905, the viewpoint of the first electronic device 101a, and the viewpoint of the second electronic device 101b relative to the virtual object 935 in the shared three-dimensional environment 950, such as via a press of button 947 illustrated in FIGS. 9A-9B.

In some examples, as illustrated in the overhead view 910 in FIG. 9Q, in response to detecting the indication of the input corresponding to the request to reset the spatial arrangement of the avatar 905, the viewpoint of the first electronic device 101a, and the viewpoint of the second electronic device 101b relative to the virtual object 935 in the shared three-dimensional environment 950, the first electronic device 101a and the second electronic device 101b reset the location of the seat 930a within the custom spatial template 946 to its original (e.g., previous) location, such as the location of the seat 930a illustrated in FIG. 9M (e.g., the original seat location designated by the media application associated with the first content item corresponding to the virtual object 935, as similarly discussed above with reference to FIG. 4G). Additionally, in some examples, as shown in FIG. 9Q, resetting the location of the seat 930a within the custom spatial template 946 includes updating a display location of the avatar 905 corresponding to the third user in the shared three-dimensional environment 950. For example, as illustrated in the overhead view 910 in FIG. 9Q, the first electronic device 101a and the second electronic device 101b move and/or redisplay the avatar 905 at an updated placement location in the shared three-dimensional environment 950 corresponding to the reset location of the seat 930a within the custom spatial template 946.

FIGS. 9R-9S illustrate additional examples of applying a custom spatial template to the shared three-dimensional environment 950 within a multi-user communication session that includes collocated users. In the overhead view 910 in FIG. 9R, while the first electronic device 101a and the second electronic device 101b are in the multi-user communication session, the first electronic device 101a and the second electronic device 101b have initiated a process to display shared content (e.g., the first content item discussed above) corresponding to the virtual object 935 in the shared three-dimensional environment 950. In some examples, as previously discussed above, the virtual object 935 is associated with custom spatial template 946 that includes a plurality of seats 930, including seats 930a-930c, as illustrated in FIG. 9R. As described above, in some examples, applying the custom spatial template 946 that is associated with the virtual object 935 to the shared three-dimensional environment 950 includes associating and/or assigning seats within the custom spatial template 946 to the first user 902 of the first electronic device 101a and the second user 904 of the second electronic device 101b, which includes evaluating the physical locations of the first user 902 and the second user 904 in the physical environment 900.

In the example of FIG. 9R, as similarly discussed above, one or more seats within the custom spatial template 946 are associated with one or more roles corresponding to the display of the virtual object 935 in the shared three-dimensional environment 950. For example, when the first electronic device 101a and the second electronic device 101b apply the custom spatial template 946 to the shared three-dimensional environment 950, as illustrated in the overhead view 910 in FIG. 9R, seat 930b is associated with role 938 (e.g., a presenter role) within the custom spatial template 946. In some examples, the second user 904 of the second electronic device 101b is assigned to the role 938 that is currently associated with the seat 930b within the custom spatial template 946. Accordingly, in some examples, the first electronic device 101a and the second electronic device 101b associate the second user 904 with the seat 930b that is assigned to the role 938 in FIG. 9R. Additionally, as similarly discussed above, the first user 902 is assigned a different role (e.g., an audience role) or is not assigned a role within the custom spatial template 946, which causes the first user 902 of the first electronic device 101a to be associated with a corresponding proximate seat, notably seat 930c within the custom spatial template 946.

In some examples, as previously discussed above and as illustrated in the overhead view 910 in FIG. 9R, following the association of the seats 930c and 930b with the first user 902 and the second user 904 in the multi-user communication session, respectively, the first electronic device 101a and the second electronic device 101b update locations of the seats 930c and 930b within the custom spatial template 946 to correspond to the physical locations of the first user 902 and the second user 904 within the physical environment 900. For example, as illustrated in the overhead view 910 in FIG. 9R, the first electronic device 101 and the second electronic device 101b update the location of the seat 930b within the custom spatial template 946 to correspond to the location of the second user 904 in the physical environment 900 and update the location of the seat 930c within the custom spatial template 946 to correspond to the location of the first user 902 in the physical environment 900. Further, in some examples, following the updating of the locations of the seats 930b and 930c within the custom spatial template 946 in the shared three-dimensional environment 950, data corresponding to the updated locations of the seats 930b and 930c are communicated/transmitted to the media application that is associated with the virtual object 935, as previously discussed herein.

In some examples, following the display of the virtual object 935 in the shared three-dimensional environment 950, the first electronic device 101a and the second electronic device 101b detect an indication of a request to add a third user of a third electronic device to the multi-user communication session, as similarly discussed above. Particularly, in some examples, the first electronic device 101a and the second electronic device 101b receive an invitation to add a remote user to the multi-user communication session (e.g., the third user of the third electronic device is non-collocated with the first user 902 and the second user 904 in the physical environment 900). In some examples, as previously discussed herein, in response to detecting the indication, the first electronic device 101a and the second electronic device 101b initiate a process to add the third electronic device to the multi-user communication session, including identifying a placement location in the shared three-dimensional environment 950 at which to display a visual representation (e.g., avatar) of the third user of the third electronic device relative to the virtual object 935.

In some examples, as similarly discussed herein, identifying the placement location in the shared three-dimensional environment 950 at which to display the visual representation of the third user of the third electronic device relative to the virtual object 935 includes identifying an available (e.g., unoccupied) seat of the plurality of seats 930 within the custom spatial template 946. As mentioned above, in the example of FIG. 9R, the seat 930b is associated with the second user 904 of the second electronic device 101b and the seat 930c is associated with the first user 902 of the first electronic device 101a within the custom spatial template 946, rendering the seat 930a the (e.g., last) available seat within the custom spatial template 946. However, in some examples, as similarly discussed above and as indicated in the overhead view 910 in FIG. 9R, the second user 904 of the second electronic device 101b is physically located at a location in the physical environment 900 that at least partially overlaps with and/or is proximate to (e.g., is within a threshold distance of, such as 0.1, 0.2, 0.3, 0.4, 0.5, 1, etc. meters of) a location in the shared three-dimensional environment 950 corresponding to the available seat 930a within the custom spatial template 946. Accordingly, though the seat 930a is the available seat within the custom spatial template 946, because of the physical location of the second user 904 of the second electronic device 101b relative to the virtual object 935, the location corresponding to the seat 930a within the shared three-dimensional environment 950 is optionally not a valid placement location for the visual representation of the third user of the third electronic device, as similarly discussed above.

Accordingly, in some examples, as similarly discussed above, the first electronic device 101a and the second electronic device 101b initiate updating (e.g., moving) a location of the seat 930a within the custom spatial template 946 (e.g., along a line through a center of the virtual object 935) to prevent and/or avoid spatial conflict within the shared three-dimensional environment 950 (e.g., thereby rendering the seat 930a a valid placement location for the visual representation of the remote user). In the example of FIG. 9R, when updating the location of the seat 930a within the custom spatial template 946 to render the seat 930a a valid placement location for the visual representation of the third user of the third electronic device relative to the virtual object 935 in the shared three-dimensional environment 950, the first electronic device 101a and the second electronic device 101b determine that a valid placement location is unable to be identified based on the current spatial arrangement of the first user 902 and the second user 904 relative to the virtual object 935 in the shared three-dimensional environment 950. For example, as illustrated in the overhead view 910 in FIG. 9R, because the physical location of the second user 904 of the second electronic device 101b and the physical location of the first user 902 of the first electronic device 101a are both located behind the location in the shared three-dimensional environment 950 corresponding to the seat 930a within the custom spatial template 946, movement of the location of the seat 930a relative to the virtual object 935 (e.g., along a line through the center of the virtual object 935) is limited to being in a direction that is toward the virtual object 935 in the shared three-dimensional environment 950. Moreover, as previously discussed above, in the example of FIG. 9R, the distance that the location of the seat 930a within the custom spatial template 946 is able to be moved relative to the virtual object 935 is limited by a maximum distance and a minimum distance relative to the virtual object 935 (e.g., when moving the location of the seat 930a along the line through the center of the virtual object 935, such as the line 951 in FIG. 9N). As discussed above, the movement of the location of the seat 930a relative to the virtual object 935 is limited to being in the direction that is toward the virtual object 935 in the shared three-dimensional environment 950, but based on the current spatial arrangement of the second user 904 and the first user 902 in the shared three-dimensional environment 950 relative to the virtual object 935, the movement of the location of the seat 930a toward the virtual object 935 a distance that is sufficient to prevent and/or avoid spatial conflict with the physical locations of the first user 902 and the second user 904 causes the movement to exceed the minimum distance discussed above relative to the virtual object 935. Further, in some examples, the movement of the location of the seat 930a toward the virtual object 935 (e.g., along the line through the center of the virtual object 935) would cause the subsequent display of the visual representation (e.g., avatar) of the third user of the third electronic device to block or otherwise at least partially obstruct a view of the content of the virtual object 935 from the viewpoint of the second electronic device 101b in the shared three-dimensional environment 950. Accordingly, in the example of FIG. 9R, the first electronic device 101a and the second electronic device 101b are unable to move the location of the seat 930a within the custom spatial template 946 relative to the virtual object 935 to identify an updated placement location within the shared three-dimensional environment 950 that is sufficient for the display of the visual representation of the third user and that does not adversely affect the other users' visibility of and/or interactivity with the content of the virtual object 935 (e.g., by being too close to the virtual object 935 from the viewpoints of the first electronic device 101a and/or the second electronic device 101b and/or directly in front of the viewpoints of the first electronic device 101a and/or the second electronic device 101b).

As such, as illustrated in the overhead view 910 in FIG. 9S, in accordance with the determination above that an updated placement location for the visual representation of the third user of the third electronic device is unable to be identified within the shared three-dimensional environment 950 when adding the third electronic device to the multi-user communication session, the first electronic device 101a and the second electronic device 101b display a two-dimensional representation (e.g., a placeholder representation) of the third user in the shared three-dimensional environment 950. For example, as shown in the overhead view 910 in FIG. 95, the first electronic device 101a and the second electronic device 101b display spatial coin 960 corresponding to the third user at a location in the shared three-dimensional environment 950 corresponding to the (e.g., original) location of the seat 930a within the custom spatial template 946 (e.g., that is in front of the second user 904 relative to the virtual object 935). In some examples, as shown in FIG. 9S, the spatial coin 960 corresponds to a simplified, non-intrusive representation of the third user (optionally including an indication of a name of the third user (e.g., “Kyle Lee”) and/or a two-dimensional image or other identifier (e.g., initials “KL”) for the third user). For example, due to one or more visual properties of the spatial coin 960 (e.g., translucency of the spatial coin, dimensionality of the spatial coin, size of the spatial coin, height and/or elevation of the spatial coin relative to the floor/ground or gravity, and/or brightness of the spatial coin) in the shared three-dimensional environment 950, blockage or other obscuring of the view of the second user 904 of the content of the virtual object 935 is mitigated relative to the viewpoint of the second electronic device 101b.

Thus, as outlined above, providing an API (e.g., the spatial coordinator API 462 of FIG. 4G) that facilitates communication between the communication application (e.g., communication application 488) and one or more respective applications (e.g., one or more secondary applications 470) enables content (e.g., virtual objects, such as virtual object 935) to be displayed in the shared three-dimensional environment in a hybrid multi-user communication session according to a spatial arrangement (e.g., a custom spatial template) defined by the one or more respective applications and accommodating the physical locations of the collocated users within the hybrid multi-user communication session, as an advantage. Additionally, providing the API reduces the cognitive burden of the electronic device in formulating and/or determining spatial arrangements according to which to arrange content and participants in the hybrid multi-user communication session, thereby helping preserve computing resources associated with facilitating the hybrid multi-user communication session.

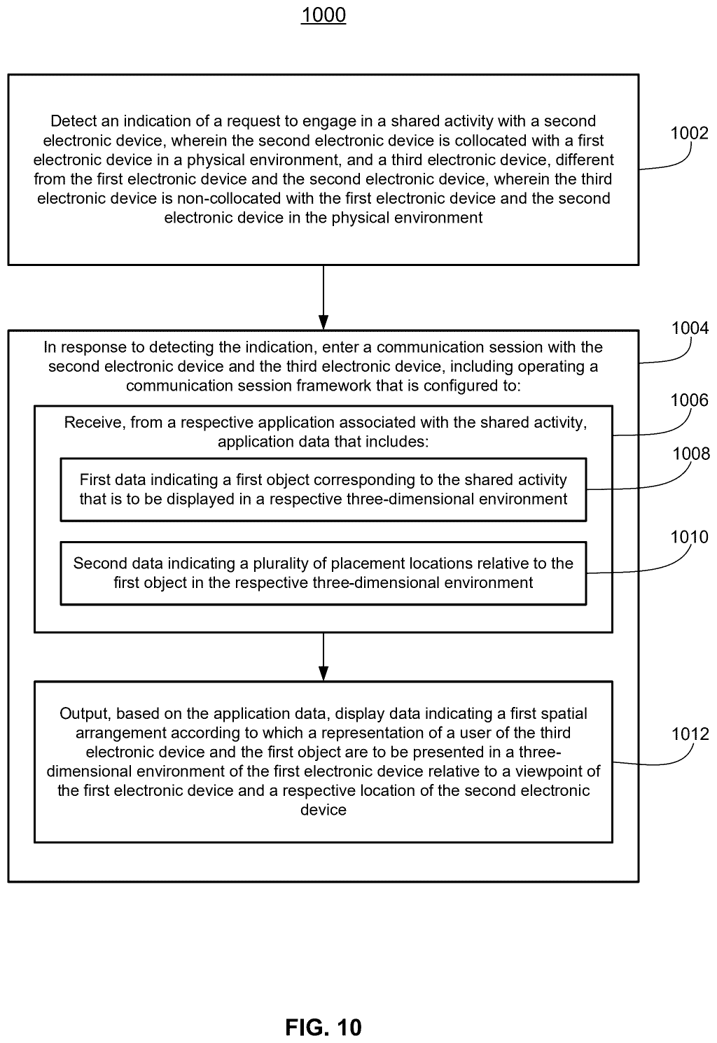

FIG. 10 illustrates a flow diagram illustrating an example process for displaying virtual content in a respective spatial arrangement within a hybrid multi-user communication session based on data received from a respective application associated with the content according to some examples of the disclosure. In some examples, process 1000 begins at a first electronic device in communication with one or more displays and one or more input devices, wherein the first electronic device is collocated with the second electronic device in a physical environment. In some examples, the first electronic device and the second electronic device are optionally a head-mounted display, respectively, similar or corresponding to devices 260/270 of FIG. 2. As shown in FIG. 10, in some examples, at 1002, the first electronic device detects an indication of a request to engage in a shared activity with the second electronic device and a third electronic device, different from the first electronic device and the second electronic device, wherein the third electronic device is non-collocated with the first electronic device and the second electronic device in the physical environment. For example, as shown in FIG. 9B, first electronic device 101a detects an input provided by hand 903 of a first user 902 corresponding to a request to share content (e.g., Movie A) with a second user 904 of a second electronic device 101b.

In some examples, at 1004, in response to detecting the indication, the first electronic device enters a communication session with the second electronic device and the third electronic device, including operating a communication session framework that is configured to, at 1006, receive, from a respective application associated with the shared activity, application data. For example, as shown in FIG. 4G, when the first electronic device 101a enters the communication session with the second electronic device 101b, spatial coordinator API 462 of the communication application 488 receives custom template request data 465 from one or more secondary applications 470. In some examples, the application data includes, at 1008, first data indicating a first object corresponding to the shared activity that is to be displayed in a respective three-dimensional environment, and, at 1010, second data indicating a plurality of placement locations relative to the first object in the respective three-dimensional environment. For example, as described with reference to FIG. 4G, the first data and the second data are included in the custom template request data 465, and the first data is received by application spatial parameter determiner 468, and the second data is received by participant spatial parameter determiner 464.

In some examples, the communication session framework is further configured to, at 1012, output, based on the application data, display data indicating a first spatial arrangement according to which a representation of a user of the third electronic device and the first object are to be presented in a three-dimensional environment of the first electronic device relative to a viewpoint of the first electronic device and a respective location of the second electronic device. For example, as described with reference to FIG. 4G, spatial template determiner 460 outputs spatial template display data 467 that includes a designation of a respective spatial template according to which the content that is shared in the multi-user communication session is arranged and based on the physical locations of the collocated users in the multi-user communication session, such as the physical locations of the first user 902 and the second user 904 in the physical environment 900 as described with reference to FIG. 9D.

It is understood that process 1000 is an example and that more, fewer, or different operations can be performed in the same or in a different order. Additionally, the operations in process 1000 described above are, optionally, implemented by running one or more functional modules in an information processing apparatus such as general-purpose processors (e.g., as described with respect to FIG. 2) or application specific chips, and/orby other components of FIG. 2.

Therefore, according to the above, some examples of the disclosure are directed to a method comprising, at a first electronic device in communication with one or more displays and one or more input devices: detecting an indication of a request to engage in a shared activity with a second electronic device, different from the first electronic device; and in response to detecting the indication, entering the communication session with the second electronic device, including operating a communication session framework that is configured to: receive, from a respective application associated with the shared activity, application data that includes first data indicating a first object corresponding to the shared activity that is to be displayed in a respective three-dimensional environment, second data indicating a plurality of placement locations relative to the first object in the respective three-dimensional environment, and third data indicating one or more orientations associated with the plurality of placement locations relative to the first object in the respective three-dimensional environment; and output, based on the application data, display data indicating a first spatial arrangement according to which at least a viewpoint of the first electronic device, a representation of a user of the second electronic device, and the first object are presented in a three-dimensional environment of the first electronic device.

Additionally or alternatively, in some examples, the second data indicating the plurality of placement locations relative to the first object in the respective three-dimensional environment includes, for a respective placement location of the plurality of placement locations, an indication of a placement distance relative to the first object in the respective three-dimensional environment. Additionally or alternatively, in some examples, the third data indicating the one or more orientations associated with the plurality of placement locations relative to the first object in the respective three-dimensional environment includes, for a respective placement location of the plurality of placement locations, an indication of a forward placement direction relative to a reference point in the respective three-dimensional environment. Additionally or alternatively, in some examples, when the viewpoint of the first electronic device, the representation of the user of the second electronic device, and the first object are presented in the first spatial arrangement in the three-dimensional environment, the representation of the user of the second electronic device is located at a first location in the three-dimensional environment and the first object is located at a second location, different from the first location, in the three-dimensional environment relative to the viewpoint of the first electronic device. Additionally or alternatively, in some examples, the plurality of placement locations indicated in the second data are defined according to a center of the first object in the respective three-dimensional environment, such that the viewpoint of the first electronic device and the first location of the representation of the user of the second electronic device are positioned relative to the center of the first object in the three-dimensional environment. Additionally or alternatively, in some examples, the plurality of placement locations indicated in the second data are defined according to an edge of the first object in the respective three-dimensional environment, such that the viewpoint of the first electronic device and the first location of the representation of the user of the second electronic device are positioned relative to the edge of the first object in the three-dimensional environment.

Additionally or alternatively, in some examples, the method further comprises: while presenting the three-dimensional environment in which the viewpoint of the first electronic device, the representation of the user of the second electronic device, and the first object are arranged in the first spatial arrangement, detecting an event that causes the communication session framework to update the display data indicating the first spatial arrangement to indicate a second spatial arrangement, different from the first spatial arrangement; and in response to detecting the event, updating presentation, via the one or more displays, of the three-dimensional environment to arrange at least the viewpoint of the first electronic device, the representation of the user of the second electronic device, and the first object according to the second spatial arrangement based on the updated display data, wherein the representation of the user of the second electronic device is located at a third location, different from the first location, and the first object is located at a fourth location, different from the second location, in the three-dimensional environment relative to the viewpoint of the first electronic device. Additionally or alternatively, in some examples, when the viewpoint of the first electronic device, the representation of the user of the second electronic device, and the first object are presented in the first spatial arrangement in the three-dimensional environment, the representation of the user of the second electronic device has a first orientation in the three-dimensional environment and the first object has a second orientation, different from the first orientation, in the three-dimensional environment relative to the viewpoint of the first electronic device. Additionally or alternatively, in some examples, the method further comprises: while presenting the three-dimensional environment in which the viewpoint of the first electronic device, the representation of the user of the second electronic device, and the first object are arranged in the first spatial arrangement, detecting an event that causes the communication session framework to update the display data indicating the first spatial arrangement to indicate a second spatial arrangement, different from the first spatial arrangement; and in response to detecting the event, updating presentation, via the one or more displays, of the three-dimensional environment to arrange at least the viewpoint of the first electronic device, the representation of the user of the second electronic device, and the first object according to the second spatial arrangement based on the updated display data, wherein the representation of the user of the second electronic device has a third orientation, different from the first orientation, and the first object has a fourth orientation, different from the second orientation, in the three-dimensional environment relative to the viewpoint of the first electronic device.

Additionally or alternatively, in some examples, when the first electronic device enters the communication session with the second electronic device, the communication session has a first number of participants, including a user of the first electronic device and the user of the second electronic device. In some examples, the method further comprises: while presenting the three-dimensional environment in which the viewpoint of the first electronic device, the representation of the user of the second electronic device, and the first object are arranged in the first spatial arrangement, detecting an event that causes a number of participants in the communication session to change from the first number of participants to a second number of participants, different from the first number of participants; and in response to detecting the event, causing the communication session framework to update the display data indicating the first spatial arrangement to indicate a second spatial arrangement, different from the first spatial arrangement, based on the second number of participants, and updating presentation, via the one or more displays, of the three-dimensional environment to arrange at least the viewpoint of the first electronic device, the representation of the user of the second electronic device, and the first object according to the second spatial arrangement based on the updated display data. Additionally or alternatively, in some examples, the second number of participants exceeds a threshold number of participants associated with the communication session. Additionally or alternatively, in some examples, the method further comprises: while presenting the three-dimensional environment in which the viewpoint of the first electronic device, the representation of the user of the second electronic device, and the first object are arranged in the first spatial arrangement, detecting an indication of a request to engage in a second shared activity, different from the shared activity, with the second electronic device; and in response to detecting the indication, operating the communication session framework that is configured to: receive, from a respective application associated with the second shared activity, second application data that includes first respective data indicating a second object corresponding to the second shared activity that is to be displayed in a respective three-dimensional environment, second respective data indicating a plurality of placement locations relative to the second object in the respective three-dimensional environment, and third respective data indicating one or more orientations associated with the plurality of placement locations relative to the second object in the respective three-dimensional environment; and output, based on the second application data, updated display data indicating a second spatial arrangement, different from the first spatial arrangement, according to which at least the viewpoint of the first electronic device, the representation of the user of the second electronic device, and the second object are presented in the three-dimensional environment.

Additionally or alternatively, in some examples, the application data further includes fourth data indicating one or more roles within the shared activity and that are associated with the plurality of placement locations, and a respective participant in the communication session is positioned at a respective placement location of the plurality of placement locations based on a respective role associated with the respective participant. Additionally or alternatively, in some examples, in the first spatial arrangement, the representation of the user of the second electronic device is positioned at a first placement location of the plurality of placement locations that is associated with a first role, and the representation of the user of the second electronic device has a first orientation in the three-dimensional environment relative to the view point of the user, wherein the first orientation is based on the first role. Additionally or alternatively, in some examples, in the first spatial arrangement, the user of the first electronic device is assigned a first role within the shared activity. In some examples, the method further comprises: while presenting the three-dimensional environment in which the viewpoint of the first electronic device, the representation of the user of the second electronic device, and the first object are arranged in the first spatial arrangement, detecting an event that causes a role assigned to the user of the first electronic device to change from the first role to a second role, different from the first role, in the shared activity; and in response to detecting the event, causing the communication session framework to update the display data indicating the first spatial arrangement to indicate a second spatial arrangement, different from the first spatial arrangement, based on the second role of the user of the first electronic device, and updating presentation, via the one or more displays, of the three-dimensional environment to arrange at least the viewpoint of the first electronic device, the representation of the user of the second electronic device, and the first object according to the second spatial arrangement based on the updated display data.

Additionally or alternatively, in some examples, the shared activity is a first type of shared activity, and in the first spatial arrangement: in accordance with a determination that the indication of the request to engage in the shared activity with the second electronic device corresponds to user input provided by the user of the first electronic device, the user of the first electronic device is assigned a first role within the shared activity; and in accordance with a determination that the indication of the request to engage in the shared activity with the second electronic device corresponds to user input provided by a respective user other than the user of the first electronic device, the user of the first electronic device is assigned a second role, different from the first role, within the shared activity. Additionally or alternatively, in some examples, the method further comprises: while presenting the three-dimensional environment in which the viewpoint of the first electronic device, the representation of the user of the second electronic device, and the first object are arranged in the first spatial arrangement, detecting an indication of a request to engage in a second shared activity, different from the shared activity, of a second type, different from the first type, with the second electronic device; and in response to detecting the indication, operating the communication session framework that is configured to: receive, from a respective application associated with the second shared activity, second application data that includes first respective data indicating a second object corresponding to the second shared activity that is to be displayed in a respective three-dimensional environment, second respective data indicating a plurality of placement locations relative to the second object in the respective three-dimensional environment, third respective data indicating one or more orientations associated with the plurality of placement locations relative to the second object in the respective three-dimensional environment, and fourth respective data indicating one or more roles within the second shared activity and that are associated with the plurality of placement locations; and output, based on the second application data, updated display data indicating a second spatial arrangement, different from the first spatial arrangement, according to which at least the viewpoint of the first electronic device, the representation of the user of the second electronic device, and the second object are presented in the three-dimensional environment, wherein the user of the first electronic device and the user of the second electronic device are assigned a same role within the second shared activity.

Additionally or alternatively, in some examples, in the first spatial arrangement, a first placement location of the plurality of placement locations is associated with a first role within the shared activity, and the first placement location is occupied by a respective participant in the communication session. In some examples, the method further comprises: while presenting the three-dimensional environment in which the viewpoint of the first electronic device, the representation of the user of the second electronic device, and the first object are arranged in the first spatial arrangement, detecting an event that causes the first placement location to no longer by occupied by a respective participant in the communication session; and in response to detecting the event, causing the communication session framework to update the display data indicating the first spatial arrangement to indicate a second spatial arrangement, different from the first spatial arrangement, based on the first placement location no longer being occupied by the respective participant, and updating presentation, via the one or more displays, of the three-dimensional environment to arrange at least the viewpoint of the first electronic device, the representation of the user of the second electronic device, and the first object according to the second spatial arrangement based on the updated display data. Additionally or alternatively, in some examples, the shared activity is associated with one or more teams, and, while participating in the shared activity, a user of the first electronic device and the user of the second electronic device are associated with one or more of the one or more teams. Additionally or alternatively, in some examples, in the first spatial arrangement: in accordance with a determination that the user of the first electronic device and the user of the second electronic device are associated with a same team associated with the shared activity, the representation of the user of the second electronic device is positioned at a first location in the three-dimensional environment relative to the viewpoint of the first electronic device; and in accordance with a determination that the user of the first electronic device and the user of the second electronic device are associated with different teams associated with the shared activity, the representation of the user of the second electronic device is positioned at a second location, different from the first location, in the three-dimensional environment relative to the viewpoint of the first electronic device.

Additionally or alternatively, in some examples, the application data further includes fourth data indicating one or more placement heights that are associated with the plurality of placement locations, and a respective participant in the communication session that is positioned at a respective placement location of the plurality of placement locations has a first height relative to a surface in the respective three-dimensional environment. Additionally or alternatively, in some examples, in accordance with a determination that the shared activity is associated with an immersive environment, in the first spatial arrangement, the view point of the first electronic device is positioned at a first height relative to a surface of the three-dimensional environment, and in accordance with a determination that the shared activity is not associated with an immersive environment, in the first spatial arrangement, the viewpoint of the first electronic device is positioned at a second height, different from the first height, relative to the surface of the three-dimensional environment. Additionally or alternatively, in some examples, the plurality of placement locations is associated with a maximum number of placement locations in the respective three-dimensional environment. In some examples, the method further comprises: while presenting the three-dimensional environment in which the viewpoint of the first electronic device, the representation of the user of the second electronic device, and the first object are arranged in the first spatial arrangement, detecting an indication of an increase in a number of participants in the communication session, including a respective participant; and in response to detecting the indication, in accordance with a determination that the increase in the number of participants causes the number of participants to exceed the maximum number of placement locations, operating the communication session framework that is configured to receive, from a respective application associated with the second shared activity, updated application data that is based on the indication, and output, based on the updated application data, updated display data for maintaining the first spatial arrangement according to which at least the viewpoint of the first electronic device, the representation of the user of the second electronic device, and the second object are presented in the three-dimensional environment, including forgoing presenting a respective representation of the respective participant according to the first spatial arrangement in the three-dimensional environment. Additionally or alternatively, in some examples, the second data indicating the plurality of placement locations further indicates one or more placement regions relative to the first object in the respective three-dimensional environment, and a first participant and a second participant, different from the first participant, in the communication session are positioned within a respective placement region of the one or more placement regions in the respective three-dimensional environment independent of the plurality of placement locations. Additionally or alternatively, in some examples, the application data further includes fourth data indicating a placement order associated with the plurality of placement locations, and a first participant in the communication session is positioned at a first placement location of the plurality of placement locations in the respective three-dimensional environment and a second participant, different from the first participant, in the communication session is subsequently positioned at a second placement location, different from the first placement location, of the plurality of placement locations in the respective three-dimensional environment based on the placement order.

Some examples of the disclosure are directed to a method comprising, at a first electronic device in communication with one or more displays, one or more input devices, and a second electronic device: while in a communication session with the second electronic device, presenting, via the one or more displays, a representation of a user of the second electronic device in a three-dimensional environment; while presenting the representation of the user of the second electronic device in the three-dimensional environment, detecting an indication of a request to present shared content in the three-dimensional environment; and in response to detecting the indication, presenting, via the one or more displays, a first object corresponding to the shared content in the three-dimensional environment, wherein a viewpoint of the first electronic device, the representation of the user of the second electronic device, and the first object have a first spatial arrangement in the three-dimensional environment based on data provided by a respective framework associated with the communication session, the data indicating a location of the first object relative to a respective three-dimensional environment, a location of the representation of the user of the second electronic device relative to the location of the first object in the respective three-dimensional environment, and an orientation of the representation of the user of the second electronic device relative to the location of the first object in the respective three-dimensional environment.

Some examples of the disclosure are directed to a computer readable medium storing instructions of an application for controlling an electronic device to perform a method, the method comprising: obtaining first information based on user input corresponding to a request to display content in a three-dimensional environment; and in response to obtaining the first information, providing second information to an operating system, wherein the second information indicates a first object corresponding to the content that is to be displayed in the three-dimensional environment, a plurality of placement positions relative to the first object in the three-dimensional environment, and one or more orientations associated with the plurality of placement locations relative to the first object in the three-dimensional environment.

Some examples of the disclosure are directed to a method comprising, at a first electronic device in communication with one or more displays and one or more input devices, wherein the first electronic device is collocated with a second electronic device in a physical environment: detecting an indication of a request to engage in a shared activity with the second electronic device and a third electronic device, different from the first electronic device and the second electronic device, wherein the third electronic device is non-collocated with the first electronic device and the second electronic device in the physical environment; and in response to detecting the indication, entering a communication session with the second electronic device and the third electronic device, including operating a communication session framework that is configured to: receive, from a respective application associated with the shared activity, application data that includes first data indicating a first object corresponding to the shared activity that is to be displayed in a respective three-dimensional environment, and second data indicating a plurality of placement locations relative to the first object in the respective three-dimensional environment; and output, based on the application data, display data indicating a first spatial arrangement according to which a representation of a user of the third electronic device and the first object are to be presented in a three-dimensional environment of the first electronic device relative to a viewpoint of the first electronic device and a respective location of the second electronic device.

Additionally or alternatively, in some examples, the application data further includes third data indicating one or more orientations associated with the plurality of placement locations relative to the first object in the respective three-dimensional environment. Additionally or alternatively, in some examples, when the representation of the user of the third electronic device and the first object are presented in the first spatial arrangement in the three-dimensional environment relative to the viewpoint of the first electronic device and the respective location of the second electronic device, the first electronic device is associated with a first placement location of the plurality of placement locations and the second electronic device is associated with a second placement location of the plurality of placement locations, and the first placement location is based on a first location of the first electronic device in the physical environment and the second placement location is based on a second location of the second electronic device in the physical environment. Additionally or alternatively, in some examples, the first placement location relative to the first object in the three-dimensional environment is within a threshold distance of the first location of the first electronic device in the physical environment, and the second placement location relative to the first object in the three-dimensional environment is within the threshold distance of the second location of the second electronic device in the physical environment. Additionally or alternatively, in some examples, when the representation of the user of the third electronic device and the first object are presented in the first spatial arrangement in the three-dimensional environment relative to the viewpoint of the first electronic device and the respective location of the second electronic device, the representation of the user of the third electronic device is associated with a third placement location, different from the first placement location and the second placement location, of the plurality of placement locations. Additionally or alternatively, in some examples, the plurality of placement locations relative to the first object has a predefined spatial arrangement in the respective three-dimensional environment, and the first placement location is updated within the plurality of placement locations to correspond to the first location of the first electronic device in the physical environment and the second placement location is updated within the plurality of placement locations to correspond to the second location of the second electronic device in the physical environment, such that the plurality of placement locations relative to the first object has an updated spatial arrangement, different from the predefined spatial arrangement, in the respective three-dimensional environment.

Additionally or alternatively, in some examples, the communication session framework is further configured to after outputting, based on the application data, the display data indicating the first spatial arrangement, output, to the respective application associated with the shared activity, session data indicating the updated spatial arrangement of the plurality of placement locations relative to the first object. Additionally or alternatively, in some examples, the method further comprises: while presenting the three-dimensional environment in which the representation of the user of the third electronic device and the first object are arranged in the first spatial arrangement relative to the viewpoint of the first electronic device and the respective location of the second electronic device, detecting an indication of a request to engage in a second shared activity, different from the shared activity, with the second electronic device and the third electronic device; and in response to detecting the indication, operating the communication session framework that is configured to: receive, from a respective application associated with the second shared activity, second application data that includes first respective data indicating a location at which to display a second object corresponding to the second shared activity in a respective three-dimensional environment, and second respective data indicating a plurality of placement locations relative to the second object in the respective three-dimensional environment; and output, based on the second application data, updated display data indicating a second spatial arrangement, different from the first spatial arrangement, according to which the representation of the user of the third electronic device and the second object are to be presented in the three-dimensional environment relative to the viewpoint of the first electronic device and the respective location of the second electronic device. Additionally or alternatively, in some examples, the application data further includes third data indicating one or more roles within the shared activity and that are associated with the plurality of placement locations; and a respective participant in the communication session is positioned at a respective placement location of the plurality of placement locations based on a respective role associated with the respective participant.

Additionally or alternatively, in some examples, a user of the first electronic device is assigned a first role of the one or more roles within the shared activity and a user of the second electronic device is assigned a second role, different from the first role, of the one or more roles within the shared activity, and in the first spatial arrangement: the first electronic device is associated with a first placement location of the plurality of placement locations and that is associated with the first role and the second electronic device is associated with a second placement location of the plurality of placement locations and that is associated with the second role; and the first placement location is based on a first location of the first electronic device in the physical environment and the second placement location is based on a second location of the second electronic device in the physical environment. Additionally or alternatively, in some examples, the user of the third electronic device is not assigned a role of the one or more roles within the spatial activity, and when the representation of the user of the third electronic device and the first object are presented in the first spatial arrangement in the three-dimensional environment relative to the viewpoint of the first electronic device and the respective location of the second electronic device, the representation of the user of the third electronic device is associated with a third placement location, different from the first placement location and the second placement location, of the plurality of placement locations and that is not associated with a role within the spatial activity. Additionally or alternatively, in some examples, the application data indicates that the representation of the user of the third electronic device is associated with a first placement location of the plurality of placement locations in the respective three-dimensional environment, and outputting, based on the application data, the display data indicating the first spatial arrangement includes, in accordance with a determination that displaying the representation of the user of the third electronic device in the three-dimensional environment of the first electronic device according to the first placement location relative to the first object creates a spatial conflict with a user of the first electronic device or a user of the second electronic device in the three-dimensional environment, determining an updated placement location for the representation of the user of the third electronic device in the first spatial arrangement in the three-dimensional environment, wherein the updated placement location resolves the spatial conflict with the user of the first electronic device or the user of the second electronic device.

Additionally or alternatively, in some examples, determining the updated placement location for the representation of the user of the third electronic device in the first spatial arrangement in the three-dimensional environment includes moving the first placement location relative to others of the plurality of placement locations in a respective direction in the three-dimensional environment relative to the first object based on a first location of the user of the first electronic device in the physical environment and a second location of the user of the second electronic device in the physical environment. Additionally or alternatively, in some examples, displaying the representation of the user of the third electronic device in the three-dimensional environment of the first electronic device according to the first placement location relative to the first object creates a spatial conflict with the user of the first electronic device, in accordance with a determination that the first placement location is farther from the first object than the first location of the user of the first electronic device relative to the first object, the respective direction is a first direction which is away from the first object in the three-dimensional environment, and in accordance with a determination that the first placement location is closer to the first object than the first location of the user of the first electronic device relative to the first object, the respective direction is a second direction, different from the first direction, which is toward the first object in the three-dimensional environment. Additionally or alternatively, in some examples, moving the first placement location relative to the others of the plurality of placement locations in the respective direction in the three-dimensional environment relative to the first object includes moving the first placement location along a line that extends through the first placement location and a center point of the first object in the three-dimensional environment. Additionally or alternatively, in some examples, the method further comprises: while presenting the three-dimensional environment in which the representation of the user of the third electronic device and the first object are arranged in the first spatial arrangement relative to the viewpoint of the first electronic device and the respective location of the second electronic device, wherein the representation of the user of the third electronic device is displayed at a first location in the three-dimensional environment corresponding to the updated placement location, detecting an indication of input corresponding to a request to recenter a display location of the first object relative to the viewpoint of the first electronic device; and in response to detecting the indication of the input, operating the communication session framework that is configured to generate updated display data based on a reconfiguration of the plurality of placement locations relative to the first object in the three-dimensional environment, including a restoration of the updated placement location that is associated with the representation of the user of the third electronic device to the first placement location of the plurality of placement locations, and output the updated display data indicating a second spatial arrangement according to which the representation of the user of the third electronic device and the first object are to be presented in the three-dimensional environment of the first electronic device relative to the viewpoint of the first electronic device and the respective location of the second electronic device. Additionally or alternatively, in some examples, the application data indicates that the representation of the user of the third electronic device is associated with a first placement location of the plurality of placement locations in the respective three-dimensional environment, and outputting, based on the application data, the display data indicating the first spatial arrangement includes, in accordance with a determination that displaying the representation of the user of the third electronic device in the three-dimensional environment of the first electronic device according to the first placement location relative to the first object creates a spatial conflict with a user of the first electronic device or a user of the second electronic device in the three-dimensional environment, adjusting a display parameter for the representation of the user of the third electronic device to correspond to a two-dimensional visual representation that is to be presented in the three-dimensional environment.

Some examples of the disclosure are directed to an electronic device comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising: one or more processors; memory; and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. M any modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at a first electronic device in communication with one or more displays and one or more input devices:
detecting an indication of a request to engage in a shared activity with a second electronic device, different from the first electronic device; and
in response to detecting the indication, entering a communication session with the second electronic device, including operating a communication session framework that is configured to:
receive, from a respective application associated with the shared activity, application data that includes:
first data indicating a first object corresponding to the shared activity that is to be displayed in a respective three-dimensional environment;
second data indicating a plurality of placement locations relative to the first object in the respective three-dimensional environment; and
third data indicating one or more orientations associated with the plurality of placement locations relative to the first object in the respective three-dimensional environment; and
output, based on the application data, display data indicating a first spatial arrangement according to which at least a viewpoint of the first electronic device, a representation of a user of the second electronic device, and the first object are to be presented in a three-dimensional environment of the first electronic device.

2. The method of claim 1, wherein, when the first electronic device enters the communication session with the second electronic device, the communication session has a first number of participants, including a user of the first electronic device and the user of the second electronic device, the method further comprising:
while presenting the three-dimensional environment in which the viewpoint of the first electronic device, the representation of the user of the second electronic device, and the first object are arranged in the first spatial arrangement, detecting an event that causes a number of participants in the communication session to change from the first number of participants to a second number of participants, different from the first number of participants; and
in response to detecting the event:
causing the communication session framework to update the display data indicating the first spatial arrangement to indicate a second spatial arrangement, different from the first spatial arrangement, based on the second number of participants; and
updating presentation, via the one or more displays, of the three-dimensional environment to arrange at least the viewpoint of the first electronic device, the representation of the user of the second electronic device, and the first object according to the second spatial arrangement based on the updated display data.

3. The method of claim 1, further comprising:
while presenting the three-dimensional environment in which the viewpoint of the first electronic device, the representation of the user of the second electronic device, and the first object are arranged in the first spatial arrangement, detecting an indication of a request to engage in a second shared activity, different from the shared activity, with the second electronic device; and
in response to detecting the indication, operating the communication session framework that is configured to:
receive, from a respective application associated with the second shared activity, second application data that includes:
first respective data indicating a second object corresponding to the second shared activity that is to be displayed in a respective three-dimensional environment;
second respective data indicating a plurality of placement locations relative to the second object in the respective three-dimensional environment; and
third respective data indicating one or more orientations associated with the plurality of placement locations relative to the second object in the respective three-dimensional environment; and
output, based on the second application data, updated display data indicating a second spatial arrangement, different from the first spatial arrangement, according to which at least the viewpoint of the first electronic device, the representation of the user of the second electronic device, and the second object are presented in the three-dimensional environment.

4. The method of claim 1, wherein:
the application data further includes fourth data indicating one or more roles within the shared activity and that are associated with the plurality of placement locations; and
a respective participant in the communication session is positioned at a respective placement location of the plurality of placement locations based on a respective role associated with the respective participant.

5. The method of claim 4, wherein, in the first spatial arrangement, the user of the first electronic device is assigned a first role within the shared activity, the method further comprising:
while presenting the three-dimensional environment in which the viewpoint of the first electronic device, the representation of the user of the second electronic device, and the first object are arranged in the first spatial arrangement, detecting an event that causes a role assigned to the user of the first electronic device to change from the first role to a second role, different from the first role, in the shared activity; and
in response to detecting the event:
causing the communication session framework to update the display data indicating the first spatial arrangement to indicate a second spatial arrangement, different from the first spatial arrangement, based on the second role of the user of the first electronic device; and
updating presentation, via the one or more displays, of the three-dimensional environment to arrange at least the viewpoint of the first electronic device, the representation of the user of the second electronic device, and the first object according to the second spatial arrangement based on the updated display data.

6. The method of claim 4, wherein, in the first spatial arrangement, a first placement location of the plurality of placement locations is associated with a first role within the shared activity, and the first placement location is occupied by a respective participant in the communication session, the method further comprising:
while presenting the three-dimensional environment in which the viewpoint of the first electronic device, the representation of the user of the second electronic device, and the first object are arranged in the first spatial arrangement, detecting an event that causes the first placement location to no longer by occupied by a respective participant in the communication session; and
in response to detecting the event:
causing the communication session framework to update the display data indicating the first spatial arrangement to indicate a second spatial arrangement, different from the first spatial arrangement, based on the first placement location no longer being occupied by the respective participant; and
updating presentation, via the one or more displays, of the three-dimensional environment to arrange at least the viewpoint of the first electronic device, the representation of the user of the second electronic device, and the first object according to the second spatial arrangement based on the updated display data.

7. The method of claim 1, wherein:
the application data further includes fourth data indicating one or more placement heights that are associated with the plurality of placement locations; and
a respective participant in the communication session that is positioned at a respective placement location of the plurality of placement locations has a first height relative to a surface in the respective three-dimensional environment.

8. The method of claim 1, wherein the plurality of placement locations is associated with a maximum number of placement locations in the respective three-dimensional environment, the method further comprising:
while presenting the three-dimensional environment in which the viewpoint of the first electronic device, the representation of the user of the second electronic device, and the first object are arranged in the first spatial arrangement, detecting an indication of an increase in a number of participants in the communication session, including a respective participant; and
in response to detecting the indication, in accordance with a determination that the increase in the number of participants causes the number of participants to exceed the maximum number of placement locations, operating the communication session framework that is configured to:
receive, from a respective application associated with the shared activity, updated application data that is based on the indication; and
output, based on the updated application data, updated display data for maintaining the first spatial arrangement according to which at least the viewpoint of the first electronic device, the representation of the user of the second electronic device, and the first object are presented in the three-dimensional environment, including forgoing presenting a respective representation of the respective participant according to the first spatial arrangement in the three-dimensional environment.

9. A first electronic device comprising:
one or more processors;
memory; and
one or more programs stored in the memory and configured to be executed by the one or more processors, the one or more programs including instructions for performing a method comprising:
detecting an indication of a request to engage in a shared activity with a second electronic device, different from the first electronic device; and
in response to detecting the indication, entering a communication session with the second electronic device, including operating a communication session framework that is configured to:
receive, from a respective application associated with the shared activity, application data that includes:
first data indicating a first object corresponding to the shared activity that is to be displayed in a respective three-dimensional environment;
second data indicating a plurality of placement locations relative to the first object in the respective three-dimensional environment; and
third data indicating one or more orientations associated with the plurality of placement locations relative to the first object in the respective three-dimensional environment; and
output, based on the application data, display data indicating a first spatial arrangement according to which at least a viewpoint of the first electronic device, a representation of a user of the second electronic device, and the first object are to be presented in a three-dimensional environment of the first electronic device.

10. The first electronic device of claim 9, wherein, when the first electronic device enters the communication session with the second electronic device, the communication session has a first number of participants, including a user of the first electronic device and the user of the second electronic device, the method further comprising:
while presenting the three-dimensional environment in which the viewpoint of the first electronic device, the representation of the user of the second electronic device, and the first object are arranged in the first spatial arrangement, detecting an event that causes a number of participants in the communication session to change from the first number of participants to a second number of participants, different from the first number of participants; and
in response to detecting the event:
causing the communication session framework to update the display data indicating the first spatial arrangement to indicate a second spatial arrangement, different from the first spatial arrangement, based on the second number of participants; and
updating presentation, via the one or more displays, of the three-dimensional environment to arrange at least the viewpoint of the first electronic device, the representation of the user of the second electronic device, and the first object according to the second spatial arrangement based on the updated display data.

11. The first electronic device of claim 9, wherein the method further comprises:
while presenting the three-dimensional environment in which the viewpoint of the first electronic device, the representation of the user of the second electronic device, and the first object are arranged in the first spatial arrangement, detecting an indication of a request to engage in a second shared activity, different from the shared activity, with the second electronic device; and
in response to detecting the indication, operating the communication session framework that is configured to:
receive, from a respective application associated with the second shared activity, second application data that includes:
first respective data indicating a second object corresponding to the second shared activity that is to be displayed in a respective three-dimensional environment;
second respective data indicating a plurality of placement locations relative to the second object in the respective three-dimensional environment; and
third respective data indicating one or more orientations associated with the plurality of placement locations relative to the second object in the respective three-dimensional environment; and
output, based on the second application data, updated display data indicating a second spatial arrangement, different from the first spatial arrangement, according to which at least the viewpoint of the first electronic device, the representation of the user of the second electronic device, and the second object are presented in the three-dimensional environment.

12. The first electronic device of claim 9, wherein:
the application data further includes fourth data indicating one or more roles within the shared activity and that are associated with the plurality of placement locations; and
a respective participant in the communication session is positioned at a respective placement location of the plurality of placement locations based on a respective role associated with the respective participant.

13. The first electronic device of claim 12, wherein, in the first spatial arrangement, the user of the first electronic device is assigned a first role within the shared activity, the method further comprising:
while presenting the three-dimensional environment in which the viewpoint of the first electronic device, the representation of the user of the second electronic device, and the first object are arranged in the first spatial arrangement, detecting an event that causes a role assigned to the user of the first electronic device to change from the first role to a second role, different from the first role, in the shared activity; and
in response to detecting the event:
causing the communication session framework to update the display data indicating the first spatial arrangement to indicate a second spatial arrangement, different from the first spatial arrangement, based on the second role of the user of the first electronic device; and
updating presentation, via the one or more displays, of the three-dimensional environment to arrange at least the viewpoint of the first electronic device, the representation of the user of the second electronic device, and the first object according to the second spatial arrangement based on the updated display data.

14. The method of claim 12, wherein, in the first spatial arrangement, a first placement location of the plurality of placement locations is associated with a first role within the shared activity, and the first placement location is occupied by a respective participant in the communication session, the method further comprising:
while presenting the three-dimensional environment in which the viewpoint of the first electronic device, the representation of the user of the second electronic device, and the first object are arranged in the first spatial arrangement, detecting an event that causes the first placement location to no longer by occupied by a respective participant in the communication session; and
in response to detecting the event:
causing the communication session framework to update the display data indicating the first spatial arrangement to indicate a second spatial arrangement, different from the first spatial arrangement, based on the first placement location no longer being occupied by the respective participant; and
updating presentation, via the one or more displays, of the three-dimensional environment to arrange at least the viewpoint of the first electronic device, the representation of the user of the second electronic device, and the first object according to the second spatial arrangement based on the updated display data.

15. The first electronic device of claim 9, wherein:
the application data further includes fourth data indicating one or more placement heights that are associated with the plurality of placement locations; and
a respective participant in the communication session that is positioned at a respective placement location of the plurality of placement locations has a first height relative to a surface in the respective three-dimensional environment.

16. The first electronic device of claim 9, wherein the plurality of placement locations is associated with a maximum number of placement locations in the respective three-dimensional environment, the method further comprising:
while presenting the three-dimensional environment in which the viewpoint of the first electronic device, the representation of the user of the second electronic device, and the first object are arranged in the first spatial arrangement, detecting an indication of an increase in a number of participants in the communication session, including a respective participant; and
in response to detecting the indication, in accordance with a determination that the increase in the number of participants causes the number of participants to exceed the maximum number of placement locations, operating the communication session framework that is configured to:
receive, from a respective application associated with the shared activity, updated application data that is based on the indication; and
output, based on the updated application data, updated display data for maintaining the first spatial arrangement according to which at least the viewpoint of the first electronic device, the representation of the user of the second electronic device, and the first object are presented in the three-dimensional environment, including forgoing presenting a respective representation of the respective participant according to the first spatial arrangement in the three-dimensional environment.

17. A non-transitory computer readable storage medium storing one or more programs, the one or more programs comprising instructions, which when executed by one or more processors of a first electronic device, cause the first electronic device to perform a method comprising:
detecting an indication of a request to engage in a shared activity with a second electronic device, different from the first electronic device; and
in response to detecting the indication, entering a communication session with the second electronic device, including operating a communication session framework that is configured to:
receive, from a respective application associated with the shared activity, application data that includes:
first data indicating a first object corresponding to the shared activity that is to be displayed in a respective three-dimensional environment;
second data indicating a plurality of placement locations relative to the first object in the respective three-dimensional environment; and
third data indicating one or more orientations associated with the plurality of placement locations relative to the first object in the respective three-dimensional environment; and
output, based on the application data, display data indicating a first spatial arrangement according to which at least a viewpoint of the first electronic device, a representation of a user of the second electronic device, and the first object are to be presented in a three-dimensional environment of the first electronic device.

18. The non-transitory computer readable storage medium of claim 17, wherein, when the first electronic device enters the communication session with the second electronic device, the communication session has a first number of participants, including a user of the first electronic device and the user of the second electronic device, the method further comprising:
while presenting the three-dimensional environment in which the viewpoint of the first electronic device, the representation of the user of the second electronic device, and the first object are arranged in the first spatial arrangement, detecting an event that causes a number of participants in the communication session to change from the first number of participants to a second number of participants, different from the first number of participants; and
in response to detecting the event:
causing the communication session framework to update the display data indicating the first spatial arrangement to indicate a second spatial arrangement, different from the first spatial arrangement, based on the second number of participants; and
updating presentation, via the one or more displays, of the three-dimensional environment to arrange at least the viewpoint of the first electronic device, the representation of the user of the second electronic device, and the first object according to the second spatial arrangement based on the updated display data.

19. The non-transitory computer readable storage medium of claim 17, wherein the method further comprises:
while presenting the three-dimensional environment in which the viewpoint of the first electronic device, the representation of the user of the second electronic device, and the first object are arranged in the first spatial arrangement, detecting an indication of a request to engage in a second shared activity, different from the shared activity, with the second electronic device; and
in response to detecting the indication, operating the communication session framework that is configured to:
receive, from a respective application associated with the second shared activity, second application data that includes:
first respective data indicating a second object corresponding to the second shared activity that is to be displayed in a respective three-dimensional environment;
second respective data indicating a plurality of placement locations relative to the second object in the respective three-dimensional environment; and
third respective data indicating one or more orientations associated with the plurality of placement locations relative to the second object in the respective three-dimensional environment; and
output, based on the second application data, updated display data indicating a second spatial arrangement, different from the first spatial arrangement, according to which at least the viewpoint of the first electronic device, the representation of the user of the second electronic device, and the second object are presented in the three-dimensional environment.

20. The non-transitory computer readable storage medium of claim 17, wherein:
the application data further includes fourth data indicating one or more roles within the shared activity and that are associated with the plurality of placement locations; and
a respective participant in the communication session is positioned at a respective placement location of the plurality of placement locations based on a respective role associated with the respective participant.

21. The non-transitory computer readable storage medium of claim 20, wherein, in the first spatial arrangement, the user of the first electronic device is assigned a first role within the shared activity, the method further comprising:
while presenting the three-dimensional environment in which the viewpoint of the first electronic device, the representation of the user of the second electronic device, and the first object are arranged in the first spatial arrangement, detecting an event that causes a role assigned to the user of the first electronic device to change from the first role to a second role, different from the first role, in the shared activity; and
in response to detecting the event:
causing the communication session framework to update the display data indicating the first spatial arrangement to indicate a second spatial arrangement, different from the first spatial arrangement, based on the second role of the user of the first electronic device; and
updating presentation, via the one or more displays, of the three-dimensional environment to arrange at least the viewpoint of the first electronic device, the representation of the user of the second electronic device, and the first object according to the second spatial arrangement based on the updated display data.

22. The non-transitory computer readable storage medium of claim 20, wherein, in the first spatial arrangement, a first placement location of the plurality of placement locations is associated with a first role within the shared activity, and the first placement location is occupied by a respective participant in the communication session, the method further comprising:
while presenting the three-dimensional environment in which the viewpoint of the first electronic device, the representation of the user of the second electronic device, and the first object are arranged in the first spatial arrangement, detecting an event that causes the first placement location to no longer by occupied by a respective participant in the communication session; and
in response to detecting the event:
causing the communication session framework to update the display data indicating the first spatial arrangement to indicate a second spatial arrangement, different from the first spatial arrangement, based on the first placement location no longer being occupied by the respective participant; and
updating presentation, via the one or more displays, of the three-dimensional environment to arrange at least the viewpoint of the first electronic device, the representation of the user of the second electronic device, and the first object according to the second spatial arrangement based on the updated display data.

23. The non-transitory computer readable storage medium of claim 17, wherein:
the application data further includes fourth data indicating one or more placement heights that are associated with the plurality of placement locations; and
a respective participant in the communication session that is positioned at a respective placement location of the plurality of placement locations has a first height relative to a surface in the respective three-dimensional environment.

24. The non-transitory computer readable storage medium of claim 17, wherein the plurality of placement locations is associated with a maximum number of placement locations in the respective three-dimensional environment, the method further comprising:
while presenting the three-dimensional environment in which the viewpoint of the first electronic device, the representation of the user of the second electronic device, and the first object are arranged in the first spatial arrangement, detecting an indication of an increase in a number of participants in the communication session, including a respective participant; and
in response to detecting the indication, in accordance with a determination that the increase in the number of participants causes the number of participants to exceed the maximum number of placement locations, operating the communication session framework that is configured to:
receive, from a respective application associated with the shared activity, updated application data that is based on the indication; and
output, based on the updated application data, updated display data for maintaining the first spatial arrangement according to which at least the viewpoint of the first electronic device, the representation of the user of the second electronic device, and the first object are presented in the three-dimensional environment, including forgoing presenting a respective representation of the respective participant according to the first spatial arrangement in the three-dimensional environment.
